(19) United States
(12) Patent Application Publication
(10) Pub. No.: US 2016/0366048 A1
(43) Pub. Date: Dec. 15, 2016

(54) COMMUNICATION SYSTEM, NODE AND SIGNAL PATH CONTROL METHOD IN COMMUNICATION SYSTEM

(71) Applicant: FUJITSU LIMITED, Kawasaki-shi (JP)

(72) Inventors: Jiro TAKEZAWA, Kawasaki (JP); Ryohei Yaginiwa, Fuchu (JP); Tomoyuki Kanzaki, Kawasaki (JP); Eiji Sugawara, Yokohama (JP); Shinobu ISHIZUKA, Yokosuka (JP); Akiko Murakami, Yokohama (JP)

(73) Assignee: FUJITSU LIMITED, Kawasaki-shi (JP)

(21) Appl. No.: 15/172,318

(22) Filed: Jun. 3, 2016

(30) Foreign Application Priority Data
Jun. 11, 2015 (JP) 2015-118443

(51) Int. Cl. H04L 12/707; H04L 12/24; H04L 12/725; H04J 3/16; H04L 12/26

(52) U.S. Cl. CPC H04L 45/22; H04J 3/1694; H04L 43/0811; H04L 45/30; H04L 41/0668

(57) ABSTRACT

A communication system includes: a plurality of active paths on which a plurality of signals set with priorities are transmitted by a plurality of time-division slots; a backup path shared by the plurality of active paths; and a controller configured to control, based on the priorities, allocation of any of the plurality of signals which are allocated to any of the plurality of time-division slots and transmitted on any of the plurality of active paths, to a plurality of time-division slots on the backup path.

### CROSS-REFERENCE TO RELATED APPLICATIONS

This application is based upon and claims the benefit of priority from the prior Japanese Patent Application No. 2015-118443 filed on Jun. 11, 2015, the entire contents of which are incorporated herein by reference.

### FIELD

The embodiments discussed herein are related to a communication system, a node, and a signal path control method in the communication system.

### BACKGROUND

The communication traffic of a network has recently been increased according to the technological improvements of Ethernet (registered trademark) or Internet Protocol (IP).

Meanwhile, with the spread of smartphones or tablet terminals, the usage types of a multimedia communication including information such as sounds or images are diversified.

Therefore, the information of various services is allowed to be transmitted in the network, so that the communication traffic volume of the network tends to increase more and more.

In such a situation, an occurrence of a network failure may have a great influence on not only the end users but also the entire society. Therefore, the network is required to have a high reliability and a high availability so that the communication is not interrupted.

As one of techniques for improving the reliability and availability of the network, there is a technique for a network redundancy. As a network redundancy technique, a “1+1 protection” technique and a “1:N protection” technique may be exemplified.

In the “1+1 protection” technique, one backup path is set for one active path. In the “1:N Protection” technique, one backup path is set for N active paths (N is an integer of 2 or more).

In the “1:N Protection” technique, one backup path is shared by a plurality of active paths. Thus, the “1:N Protection” technique is economically advantageous as compared to the “1+1 protection” technique, and may efficiently utilize a communication band as well.

Related techniques are disclosed in, for example, Japanese Laid-Open Patent Publication No. 2003-078553.

### SUMMARY

According to an aspect of the invention, a communication system includes: a plurality of active paths on which a plurality of signals set with priorities are transmitted by a plurality of time-division slots; a backup path shared by the plurality of active paths; and a controller configured to control, based on the priorities, allocation of any of the plurality of signals which are allocated to any of the plurality of time-division slots and transmitted on any of the plurality of active paths, to a plurality of time-division slots on the backup path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary configuration of a communication system according to an embodiment;

FIG. 2 is a view illustrating an exemplary format of an optical transport network (OTN) frame overhead (OTN OH) according to an embodiment;

FIG. 3 is a view illustrating an example of a simplified configuration of FIG. 1 in order to explain an operation example (at the time of a normal operation) of a communication system according to a first embodiment;

FIG. 4 is a view illustrating an example of a simplified configuration of FIG. 1 in order to explain an operation example (at the time of one system failure) of the communication system according to the first embodiment;

FIG. 5 is a view illustrating an example of a simplified configuration of FIG. 1 in order to explain an operation example (at the time of both system failure) of the communication system according to the first embodiment;

FIG. 6 is a view illustrating a configuration example of a tributary slot (TS) conversion table in a backup path start node exemplified in FIGS. 3 to 5;

FIG. 7 is a view illustrating a configuration example of a TS conversion table in a backup path end node exemplified in FIGS. 3 to 5;

FIG. 8 is a flow chart illustrating an operation example of an operation system (OPS) exemplified in FIG. 1;

FIG. 9 is a flow chart illustrating an operation example of a transmission node of an active path as exemplified in FIGS. 3 to 5;

FIG. 10 is a flow chart illustrating an operation example of a backup path start node as exemplified in FIGS. 3 to 5;

FIG. 11 is a flow chart illustrating an operation example of a backup path end node as exemplified in FIGS. 3 to 5;

FIG. 12 is a flow chart illustrating an operation example of a terminal node of the active path as exemplified in FIGS. 3 to 5;

FIG. 13 is a block diagram illustrating a functional configuration example of the transmission node exemplified in FIGS. 3 to 5;

FIG. 14 is a block diagram illustrating a functional configuration example of the backup path start node exemplified in FIGS. 3 to 5;

FIG. 15 is a block diagram illustrating a functional configuration example of the backup path end node exemplified in FIGS. 3 to 5;

FIG. 16 is a block diagram illustrating a functional configuration example of the terminal node exemplified in FIGS. 3 to 5;

FIG. 17 is a view illustrating an example of a simplified configuration of FIG. 1 in order to explain an operation example (at the time of one system failure) of a communication system according to a second embodiment;

FIG. 18 is a block diagram illustrating an exemplary configuration of a communication system according to a third embodiment;

FIG. 19 is a view illustrating a configuration example (a first aspect) of a TS conversion table in a backup path start node of the third embodiment;

FIG. 20 is a view illustrating a configuration example (a second aspect) of a TS conversion table in the backup path start node of the third embodiment;

FIG. 21 is a flow chart illustrating an operation example of a backup path start node that dynamically updates a TS conversion table in the third embodiment;

FIG. 22 is a flow chart illustrating an operation example of a backup path end node that dynamically updates a TS conversion table in the third embodiment;

FIG. 23 is a view illustrating an operation example at the time of a normal operation of the communication system of FIG. 18, which uses the TS conversion table of the first aspect exemplified in FIG. 19;

FIG. 24 is a view illustrating a configuration example of a TS conversion table in a backup path start node, which corresponds to the operation example of FIG. 23;

FIG. 25 is a view illustrating an operation example in a case where one active path is failed in the communication system exemplified in FIG. 18;

FIG. 26 is a view illustrating a configuration example of a TS conversion table in the backup path start node, which corresponds to the operation example of FIG. 25;

FIG. 27 is a view illustrating an operation example in a case where two active paths are failed in the communication system exemplified in FIG. 18;

FIG. 28 is a view illustrating a configuration example of a TS conversion table in the backup path start node, which corresponds to the operation example of FIG. 27;

FIG. 29 is a view illustrating an operation example in a case where three active paths are failed in the communication system exemplified in FIG. 18;

FIG. 30 is a view illustrating a configuration example of a TS conversion table in the backup path start node, which corresponds to the operation example of FIG. 29;

FIG. 31 is a view illustrating an operation example in a case where four active paths are failed in the communication system exemplified in FIG. 18;

FIG. 32 is a view illustrating a configuration example of a TS conversion table in the backup path start node, which corresponds to the operation example of FIG. 31;

FIG. 33 is a view illustrating a configuration example (a third aspect) of a TS conversion table in the backup path start node of the third embodiment;

FIG. 34 is a view illustrating an operation example at the time of a normal operation of the communication system of FIG. 18, which uses the TS conversion table of the third aspect exemplified in FIG. 33;

FIG. 35 is a view illustrating a configuration example of a TS conversion table in the backup path start node, which corresponds to the operation example of FIG. 34;

FIG. 36 is a view illustrating an operation example in a case where one active path is failed in the communication system exemplified in FIG. 34;

FIG. 37 is a view illustrating a configuration example of a TS conversion table in the backup path start node, which corresponds to the operation example of FIG. 36;

FIG. 38 is a view illustrating an operation example in a case where two active paths are failed in the communication system exemplified in FIG. 34; and

FIG. 39 is a view illustrating a configuration example of a TS conversion table in the backup path start node, which corresponds to the operation example of FIG. 38.

### DESCRIPTION OF EMBODIMENTS

In the “1:N protection” technique, one backup path is shared by a plurality of active paths. Thus, when multiple failures occur in the plurality of active paths, not all signals may be rescued by the backup path.

For example, a signal considered to have a higher priority than a normal communication signal such as, for example, an emergency notification signal, may not be rescued, and then a high-priority communication may be interrupted.

Hereinafter, descriptions will be made on embodiments of a technology capable of improving a rescue rate of high priority communications in a communication system with reference to drawings. However, embodiments described below are merely illustrative and are not intended to exclude various modifications and applications of techniques not specified below. Further, various exemplary embodiments to be described below may also be implemented in combination as appropriate. In the drawings used in the following embodiments, portions denoted by the same reference numerals, unless otherwise specified, represent the same or like parts.

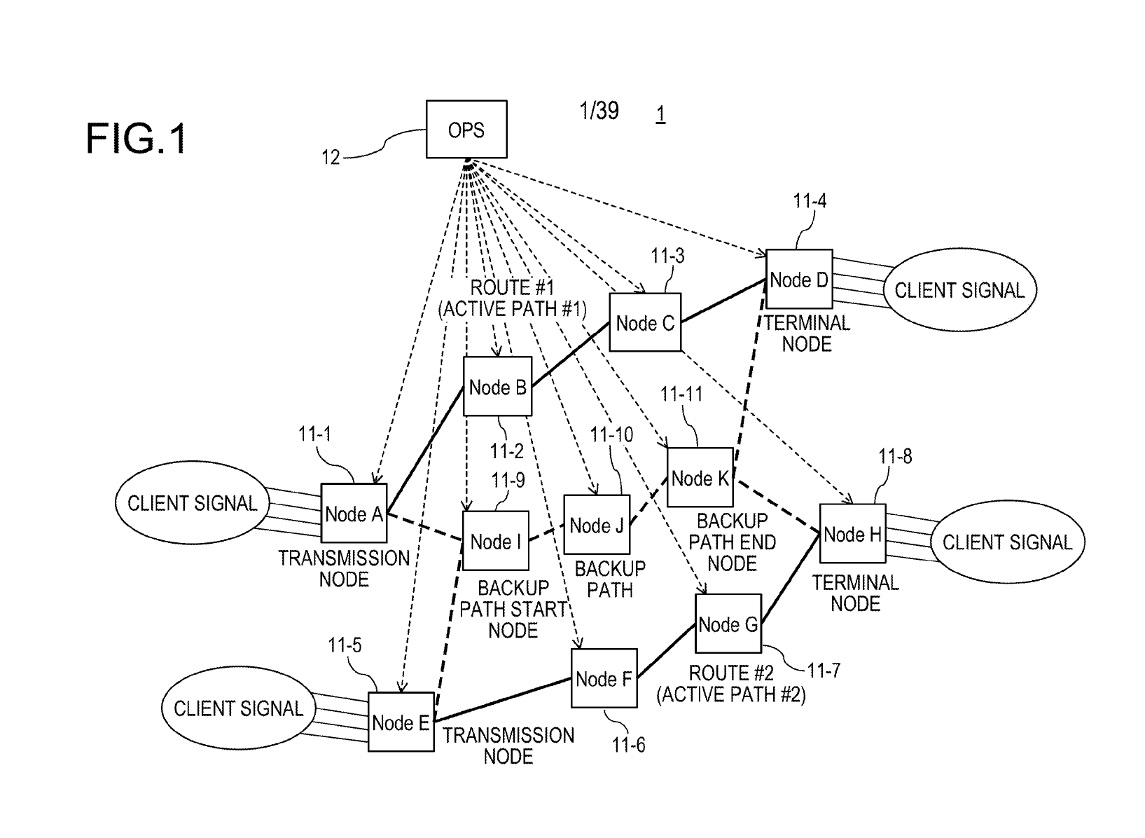

FIG. 1 is a block diagram illustrating an exemplary configuration of a communication system according to an embodiment. A communication system 1 illustrated in FIG. 1 may include, for example, n communication devices 11-1 to 11-n (n is an integer of 2 or more), and an operation system (OPS) 12. In the example of FIG. 1, n=11. The communication system 1 may be referred to as a “network 1.”

The network 1 may be, for example, an optical transport network (OTN), or a multi-protocol label switching (MPLS) network that supports MPLS or MPLS-transport profile (TP).

The “communication device” may correspond to an optical transmission device of the OTN or a router of the MPLS network. The “communication device” may be referred to as a “node,” a “station,” or a “network element (NE).”

In the example of FIG. 1, eleven communication devices 11-1 to 11-11 are denoted by “nodes A to K,” respectively. When the nodes 11-1 to 11-11 do not need to be distinguished, each may be denoted by a “node 11.”

The nodes 11 may be interconnected by a communication path. In the OTN 1, the “communication path” may be an optical transmission line, and the optical transmission line may be an optical fiber transmission line using optical fibers. The plurality of nodes 11 may be connected in, for example, a mesh form.

As exemplified in FIG. 1, in the network 1, a first route #1 which reaches a node D from a node A through nodes B and C, and a second route #2 which reaches a node H from a node E through nodes F and G may be set.

Both the first route #1 and the second route #2 may be set as “working” routes. A path (also, referred to as a “connection”) may be set for each of the routes #1 and #2.

A path set for the working route #1 (or #2) may be referred to as an “active path.” Meanwhile, in the following descriptions, for convenience, a path set for the first route #1 may be denoted by a “path #1” and a path set for the second route #2 may be denoted by a “path #2.”

In the network 1, one backup path may be set for a plurality of active paths. When the number of active paths is expressed as “N” (N is an integer of 2 or more), “1:N protection” may be implemented in the network 1.

The “1:N protection” is an example of a path redundant configuration. When any of active paths becomes unavailable by, for example, a failure occurrence. The communication of the unavailable active path may be rescued by a backup path. Meanwhile, “active” and “backup” may be referred to as “working” and “protection,” respectively.

A backup path may be shared by a plurality of active paths. A method of sharing one backup path with a plurality of active paths may be referred to as a shared restoration (SR) method.

In the network 1 in which the plurality of nodes 11 are connected in a mesh form, the “shared restoration method” may be referred to as a “shared mesh restoration (SMP) method.” The SR method or the SMP method is an example of the “1:N protection” method.

For example, in FIG. 1, for a route via the nodes I-J-K, a backup path shared by the plurality of active paths #1 and #2 may be set. Meanwhile, in the “shared restoration” method, the “backup path” may be referred to as a “shared path.”

When the active path #1 is failed, a communication from a transmission node A of the active path #1 to a terminal node D (also, referred to as a “reception node”) may be rescued by the backup path via the nodes I-J-K.

Also, when the active path #2 is failed, a communication from a transmission node E of the active path #2 to a terminal node H may be rescued by the backup path via the nodes I-J-K.

Meanwhile, the node located at the start point of the backup path may be referred to as a “backup path start node,” for convenience, and the node located at the end point of the backup path may be referred to as a “backup path end node,” for convenience.

In the example of FIG. 1, the “node I” corresponds to the “backup path start node” and the “node K” corresponds to the “backup path end node.” The “backup path start node” may be paraphrased as a “backup path transmission node,” and the “backup path end node” may be paraphrased as a “backup path reception node.”

That is, the backup path start node I corresponds to a node capable of receiving a signal from any of the transmission nodes A and E of the plurality of active paths #1 and #2. Also, the backup path end node K corresponds to a node capable of transmitting a signal to any of the terminal nodes D and H of the plurality of active paths #1 and #2.

The OPS 12 may control the overall behavior of the network 1. For example, an operator may control each node 11 in the network 1 as a management target using, for example, a terminal. Meanwhile, the terminal operated by the operator may be referred to as an “operator terminal.” The “operator” may be referred to as a “network manager.”

The setting of the active paths #1 and #2, and the setting of the backup path may be carried out by, for example, the OPS 12. For example, the OPS 12 may individually perform a physical connection setting such as, for example, a cross connect setting or a switch setting, on the nodes 11 through which the active paths #1 and #2 pass. The OPS 12 may individually perform, for example, a reservation setting of a band on the nodes 11 through which the backup path passes.

Meanwhile, in the example of FIG. 1, one intermediate node J is located between the backup path start node I and the backup path end node K, but no intermediate node or two or more intermediate nodes of the backup path may be located.

Also, in the example of FIG. 1, two intermediates nodes B and C are located between the transmission node A and the terminal node D of the active path #1, but no intermediate node or one intermediate node of the active path #1 may be located. Also, three or more intermediate nodes may be located. This also applies to the number of intermediate nodes of the active path #2.

The signal transmitted through the active paths #1 and #2 or the backup path may be an OTN signal as a non-limiting example. Signals having different transmission rates (also, referred to as “signal rates”) may be hierarchically multiplexed (also, referred to as “mapped”) with the OTN signal (also, referred to as an “OTN frame”).

The signal mapped into the OTN frame is referred to as an optical channel data unit (ODUk) signal. The “k” in the ODUk signal represents a level (also, referred to as an “order” or a “layer”) according to a difference between signal rates, and k is 1, 2, 3, 4, 5 or 6.

When the values of “k” do not need to be distinguished, the ODUk signal may be simply denoted by an “ODU signal” excluding the “k.” When one ODU signal is mapped with another ODU signal, the latter “another ODU signal” may be referred to as a “low-order (or slow) ODU signal (LO-ODU signal).” Meanwhile, the former ODU signal to which the LO-ODU signal is mapped may be referred to as a “high-order (or fast) ODU signal (HO-ODU signal).”

A client signal may be mapped to the ODU signal. The “client signal” may be referred to as a “tributary signal” or “user traffic.” The client signal may be, for example, a frame signal of Ethernet (registered trademark), or a frame signal of SDH or SONET.

The “SDH” is an abbreviation of “synchronous digital hierarchy,” and the “SONET” is an abbreviation of “synchronous optical network.” The SDH and SONET are compatible synchronous digital transmission systems.

In the OTN, client signals with a wide variety of protocols and signal rates of Ethernet, SDH/SONET or the like may be hierarchically mapped (also, referred to as “encapsulated”) to a faster signal to be transmitted.

Accordingly, various client signals may be transmitted transparently by the OTN frame between different networks without being conscious of the difference of protocols or signal rates of the client signals. Meanwhile, in the following description, the “client signal” may be simply referred to as a “signal.”

In the example of FIG. 1, in the transmission nodes A and E of the active paths #1 and #2, the mapping (also, referred to as “framing”) of the client signal into the OTN frame may be carried out. Also, in the terminal nodes D and H of the active paths #1 and #2, demapping (also, referred to as “deframing”) may be carried out on the client signal mapped into the OTN frame.

Meanwhile, the client signal may be mapped into a time-division slot called a “tributary slot (TS)” in the OTN frame. The “mapping” of the client signal into the TS may be paraphrased as “allocation.”

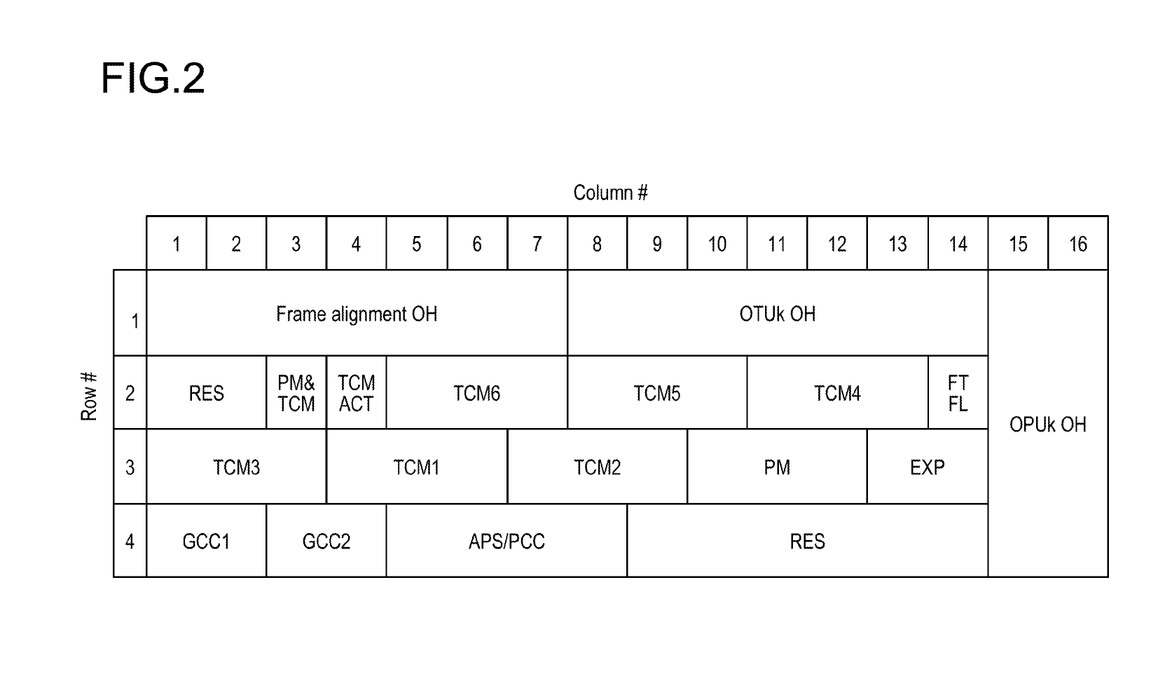

FIG. 2 illustrates an exemplary format of an OTN frame overhead (OTN OH). The OH of the OTN frame may have, for example, a size of 4 rows×16 columns. Meanwhile, the size of one “column” may be, for example, one byte (8 bits). The information set in the OH may be called “OH information.”

In the 1^{st} to 7^{th} columns of the first row, a frame alignment (FA) OH may be set, and in the 8^{th} to 14^{th} columns of the first row, an OH of an optical channel transfer unit (OTUk) signal (OTUk OH) may be set.

In the 1^{st} to 14^{th} columns of the second to fourth rows, an OH of an ODUk signal (ODUk OH) may be set, and in the 15^{th} to 16^{th} columns of the first to fourth rows, an OH of an optical channel payload unit (OPUk) signal (OPUk OH) may be set.

In the FAOH, for example, a frame alignment signal (FAS) used for frame synchronization of the OTN frame, or a multi-frame alignment signal (MFAS) used for identifying a position of a signal in a multi-frame may be set.

In the OH of the OTUk signal or the ODUk signal, information related to monitoring, management or operation of an optical channel according to each signal level may be set. In the OH of the OPUk signal, for example, information indicating a mapping position (e.g., a TS) of a client signal in a payload of the OPUk signal may be set.

In the OH of the ODUk signal, respective fields of “PM&TCM,” “TCM ACT,” “TCM,” “PM,” “EXP,” “GCC,” “APS/PCC,” and “RES” may be defined.

The “PM” is an abbreviation of “path monitoring,” and the “TCM” is an abbreviation of “tandem connection monitoring.” The 1^{st} to 6^{th} bits of the “PM&TCM” field (1 byte) are referred to as “ODUk TCM delay measurements (DMts) 1 to 6,” respectively.

The “DMts 1 to 6” correspond to a plurality (up to 6) of divided intervals (also, referred to as “sections” or a “segments”) of a path (also, referred to as an “ODUk path” or an “ODUk connection”), respectively, through which the ODUk signal is transmitted. The ODUk path may be considered to correspond to the path #1 or #2 exemplified in FIG. 1.

Using the “DMts 1 to 6,” a transmission delay measurement may be performed on a maximum of every six segments in the ODUk path. That is, in each of the “DMts 1 to 6,” information related to a delay measurement of a segment unit of the ODUk path may be set.

The 7^{th} bit of the “PM&TCM” field is called “ODUk PM delay measurement (DMp),” and may be used for a transmission delay measurement of any ODUk path set in the optical network 1. The 8^{th} bit of the “PM&TCM” field is a reserve (RES) bit reserved in preparation for future standardization.

The reserve (RES) fields described in the 1^{st} to 2^{nd} columns (2 bytes) of the second row, and the 9^{th} to 14^{th} columns (6 bytes) of the fourth row in the “ODUk OH” as exemplified in FIG. 2 are also reserved in preparation for future standardization. All reserve fields (or reserve bits) are generally set to “0” (all “0”).

The “TCM” of the “TCM ACT” field (1 byte) is an abbreviation of “tandem connection monitoring,” and the “ACT” is an abbreviation of “activation/deactivation control channel.”

The each field (3 bytes) of the “TCM 1 to 6” fields may be used to monitor a failure occurrence situation or a line quality of the ODUk path for each segment. That is, in the “TCM 1 to 6” fields, monitoring information may be set for each segment of the ODUk path.

The “PM” field (3 bytes) may be used to monitor the ODUk path. For example, in the “PM” field, for example, a trail trace identifier (TTI), a bit-interleaved parity (BIP-8), a backward defect indication (BDI), and a backward error indication (BEI) may be set.

The “EXP” field (2 bytes) may be a field defined for an experimental use.

The “GCC” is an abbreviation of a general communication channel, and may be used to make a communication of, for example, control information, monitoring information, or management information, with a node 11 which is in compliance with an OTN (also, referred to as an “OTN node”).

As for the “GCC” field, three kinds of “GCC0,” “GCC1,” and “GCC2” (2 bytes each) are prepared. The “GCC0” may be arranged in the 12^{th} and 13^{th} columns in the “OTUk OH” located at the 8^{th} to 14^{th} columns of the first row in FIG. 2. The “GCC1” and the “GCC2” may be arranged in the 1^{st} to 2^{nd} columns and the 3^{rd} and 4^{th} columns of the fourth row in the “OTN OH,” respectively.

The “APS” of the “APS/PCC” field (4 bytes) is an abbreviation of “automatic protection switching,” and the “PCC” is an abbreviation of “protection communication control.” In the “APS/PCC” field, switching control information between an active path and a backup path may be set.

For example, the terminal node D (or H) may switch between the active path #1 (or #2) and the backup path from which a signal is to be received, based on the switching control information.

Meanwhile, as a protection method in the OTN, in addition to the “1:N protection” method, a “1+1 protection” method may be exemplified. As the “1+1 protection” method, a “1+1 APS” method may be exemplified.

In the “1+1 APS” method, the same signal is transmitted to both an active path and a backup path, and any of the paths from which a signal is to be received is determined at the reception node. Meanwhile, other protection methods may include a “uni-directional path switch ring (UPSR) protection” method and a “bi-directional line switch ring (BLSR) protection” method.

In the “1+1 protection” method, since a backup path having the same transmission conditions as an active path is prepared, a cost for the transmission line is simply doubled, thereby causing economical disadvantages. Also, in the “1+1 protection” method, a transmission band is secured for the backup path in advance, which is disadvantageous from the viewpoint of the utilization efficiency of the transmission band.

In contrast, in the “1:N protection” method, one backup path is shared by a plurality of active paths, which is economically advantageous. Also, since a transmission band does not need to be secured in advance for a plurality of backup paths, the utilization efficiency of the transmission band may be improved.

Here, in the network 1 as exemplified in FIG. 1, when one of the plurality of active paths #1 and #2 becomes unavailable due to an occurrence of failure or the like, the unavailable active path may be switched to the backup path.

However, when a plurality of active paths become unavailable, because one backup path is present and a transmission band that may be used by the backup path has an upper limit, not all signals (e.g., client signals) transmitted through the plurality of unavailable active paths may be rescued.

As an example of a policy for determining which signal is to be rescued by the backup path, among the signals transmitted through the plurality of active paths, a policy may be considered in which priorities are given to the signals, and a high priority signal is preferentially rescued by the backup path.

However, when signals are time-division multiplexed (TDM) into TSs as in the OTN, a high priority signal may not be satisfactorily rescued by simply giving priorities to the signals because a TS conflict may occur in a switched backup path.

Also, at a backup path end node, when a TS of each of signals received from the backup path is transmitted to a terminal node of an active path, it is difficult to determine which active path is to be used.

Thus, in the present embodiment, for example, priorities are set for client signals, and according to detection of a failure of an active path, at a backup path start node, TSs of client signals received from transmission nodes of a plurality of active paths are rearranged according to the priorities and are transmitted.

Also, at a backup path end node, the TSs of signals received from the backup path are rearranged again and transmitted toward a terminal node of a proper active path. This makes it possible to improve the rescue rate of high priority client signals by the backup path.

It may be considered that the backup path start node and the backup path end node constitute an example of a controller configured to control an allocation of a signal allocated to a TS of an active path, to a TS of a backup path, based on a priority of the signal. The controller may be called a “signal path controller” for convenience.

For example, according to a detection of a failure occurrence in any of a plurality of active paths, the signal path controller may preferentially allocate a high priority signal, among a plurality of signals allocated to a plurality of TSs of the failed active path, to a TS of a backup path.

### First Embodiment

### Operation Example

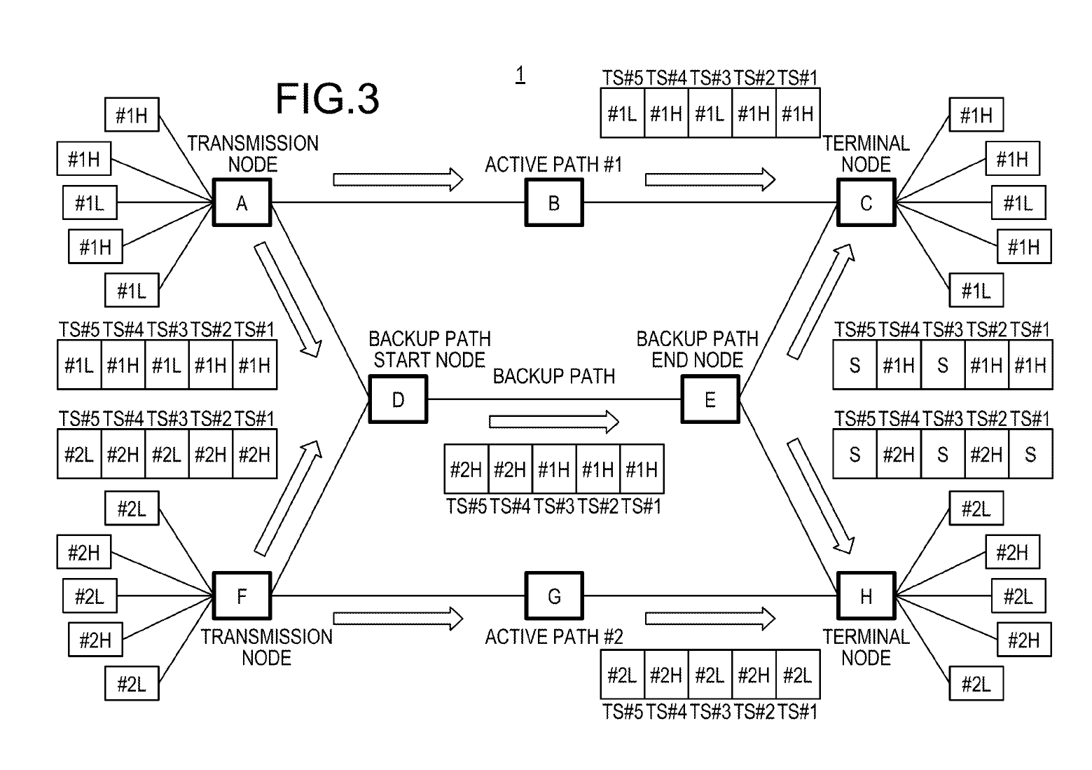

Hereinafter, descriptions will be made on an operation example of a network 1 of the present embodiment, focusing on a rearrangement of TSs, with reference to FIGS. 3 to 12.

Meanwhile, FIGS. 3 to 5 correspond to drawings which simply illustrate the configuration of FIG. 1, for convenience of explanation. For example, FIGS. 3 to 5 illustrate an example in which a first active path #1 is set for a route which reaches a terminal node C from a node A through a node B, and a second active path #2 is set for a route which reaches a terminal node H from a transmission node F through a node G.

In the example of FIGS. 3 to 5, with respect to the first active path #1 (nodes A-B-C), a backup path is set for a route which reaches a terminal node C from the node A through nodes D and E. With respect to the second active path #2 (nodes F-G-H), a backup path is set for a route which reaches the terminal node H from the node F through the nodes D and E.

Accordingly, the backup path between the nodes D and E is shared by the two active paths #1 and #2. For example, the node D corresponds to a backup path start node and the node E corresponds to a backup path end node.

[At the Time of Normal Operation: FIG. 3]

As exemplified in FIG. 3, at the time of a normal operation, the transmission node A of the first active path #1 receives, for example, five client signals. Each client signal is set with a priority. The “priority” may be called a “signal priority” for convenience.

For example, in FIG. 3, a client signal denoted by “#1H,” in the active path #1, is set with a higher priority than a client signal denoted by “#1L.”

In the example of FIG. 3, the transmission node A of the active path #1 receives three high priority client signals “#1H” and two low priority client signals “#1L.”

Likewise, the transmission node F of the second active path #2 receives, for example, five client signals set with priorities.

For example, in FIG. 3, a client signal denoted by “#2H,” in the active path #2, is set with a higher priority than a client signal denoted by “#2L.”

In the example of FIG. 3, the transmission node F of the active path #2 receives two high priority client signals “#2H” and three low priority client signals “#2L.”

At the time of normal operation, the transmission node A of the active path #1 maps the received client signals into, for example, TSs #1 to #5 of an OTN frame, and then transmits the signals to the downstream node B of the active path #1.

In the example of FIG. 3, the three high priority client signals “#1H” are mapped into the TSs #1, #2, and #4, and the two low priority client signals “#1L” are mapped into the TSs #3, and #5.

Meanwhile, the “downstream” may be, for example, a direction directed to the terminal node C from the transmission node A, and may be called a “forward direction.” The direction directed to the terminal node H from the transmission node F is also a “forward direction.” A reverse direction of the “forward direction” may be called a “backward direction” (or an “upstream”).

The node B transmits the OTN frame received from the transmission node A, which is an upstream node of the active path #1, to the downstream node C of the active path #1. The node C is a “terminal node,” and thus may demap the client signals mapped into the TSs #1 to #5 of the received OTN frame, respectively. The demapped client signals may be transmitted to tributary networks according to reception destinations.

The flow of signals in the second active path #2 may be similar to that in the first active path #1. For example, the transmission node F of the active path #2 maps the received client signals into TSs #1 to #5 of an OTN frame, and then transmits the signals to the downstream node G of the active path #2.

In the example of FIG. 3, the two high priority client signals “#2H” are mapped into the TSs #2, and #4, and the three low priority client signals “#2L” are mapped into the TSs #1, #3, and #5.

The node G transmits the OTN frame received from the transmission node F, which is an upstream node of the active path #2, to the downstream node H of the active path #2. The node H is a “terminal node,”, and thus may demap the client signals mapped into the TSs #1 to #5 of the received OTN frame, respectively. The demapped client signals may be transmitted to tributary networks according to reception destinations.

Here, the transmission node A of the active path #1 may transmit the same OTN frame as the OTN frame transmitted to the downstream node B of the active path #1, to the backup path start node D. Likewise, the transmission node F of the active path #2 may transmit the same OTN frame as the OTN frame transmitted to the downstream node G of the active path #2, to the backup path start node D.

The backup path start node D may rearrange the client signals mapped into the TSs of the OTN frames received from the transmission nodes A and F according to the priorities, and transmit the rearranged client signals to the downstream node E of the backup path.

For example, at the time of normal operation, the backup path start node D may preferentially map high priority client signals into empty TSs, in the OTN frame to be transmitted to the downstream node E of the backup path, and then transmit the OTN frame to the downstream node E.

In the example of FIG. 3, in the backup path start node D, the three high priority client signals “#1H” of the active path #1, which are received by the TSs #1, #2 and #4, are mapped into empty TSs #1 to #3 of the OTN frame to be transmitted to the backup path, respectively.

Also, in the backup path start node D, the two high priority client signals “#2H” of the active path #2, which are received by the TSs #2 and #4, are mapped into empty TSs #4 and #5, respectively.

Meanwhile, in the example of FIG. 3, empty TSs of the OTN frame to be transmitted to the backup path are assumed to be five TSs of TSs #1 to #5. Therefore, the two low priority client signals “#1L” in the active path #1, and the three low priority client signals “#2L” in the active path #2 are not allocated empty TSs, and are not transmitted to the downstream node E. That is, the empty TSs of the OTN frame to be transmitted to the backup path are consumed in order by high priority client signals.

When surplus empty TSs are still present even after all high priority client signals are mapped into empty TSs, low priority client signals may be mapped into the empty TSs, and then transmitted to the downstream node E.

In this manner, the backup path start node D may convert the TSs of the OTN frames received from the transmission nodes A and F, into TSs of the OTN frame to be transmitted to the downstream node E of the backup path, according to the priorities of the client signals mapped into the TSs.

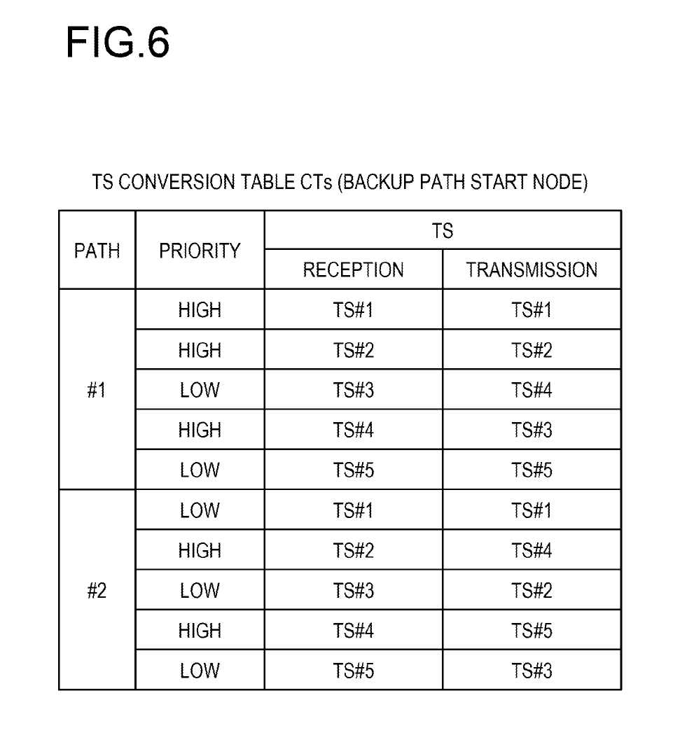

A conversion rule for TSs may be specified by a TS conversion table CTs as exemplified in FIG. 6. The “TS conversion table” CTs may be paraphrased as a “slot allocation table” CTs.

The TS conversion table CTs is an example of a first slot allocation table in which, for each of priorities of signals allocated to TSs of the active paths #1 and #2, information of a TS of the backup path to be allocated to the corresponding signal is set.

The TS conversion table CTs may be stored in the backup path start node D. The setting of the TS conversion table CTs may be performed by, for example, the OPS 12.

In the TS conversion table CTs exemplified in FIG. 6, the “H” priority client signal of the active path #1 received by the TS #1 is allocated to the TS #1 to be transmitted to the downstream node E of the backup path. Likewise, the “H” priority client signal of the active path #1 received by the TS #2 is allocated to the TS #2 to be transmitted to the downstream node E of the backup path.

Also, the “L” priority client signal of the active path #1 received by the TS #3 is allocated to the TS #4 to be transmitted to the downstream node E of the backup path. The “H” priority client signal of the active path #1 received by the TS #4 is allocated to the TS #3 to be transmitted to the downstream node E of the backup path. The “L” priority client signal of the active path #1 received by the TS #5 is allocated to the TS #5 to be transmitted to the downstream node E of the backup path.

This also applies to the client signals of the active path #2. For example, in the TS conversion table CTs of FIG. 6, the “L” priority client signal of the active path #2 received by the TS #1 is allocated to the TS #1 to be transmitted to the downstream node E of the backup path. The “H” priority client signal of the active path #2 received by the TS #2 is allocated to the TS #4 to be transmitted to the downstream node E of the backup path.

The “L” priority client signal of the active path #2 received by the TS #3 is allocated to the TS #2 to be transmitted to the downstream node E of the backup path. The “H” priority client signal of the active path #2 received by the TS #4 is allocated to the TS #5 to be transmitted to the downstream node E of the backup path. The “L” priority client signal of the active path #2 received by the TS #5 is allocated to the TS #3 to be transmitted to the downstream node E of the backup path.

Meanwhile, on the OTN frame received from the node D which is an upstream node of the backup path, the backup path end node E performs a processing of returning the TSs rearranged by the TS conversion in the backup path start node D back to their original TS arrangement. This processing may be called a “TS inversion” for convenience.

In the example of FIG. 3, the backup path end node E receives three high priority client signals “#1H” of the active path #1 by the TSs #1 to #3 of the OTN frame of the backup path, respectively. Also, the backup path end node E receives two high priority client signals “#2H” of the active path #2 by the TSs #4 and #5 of the OTN frame, respectively.

Then, the backup path end node E maps the three client signals “#1H” of the active path #1 received by the TSs #1 to #3 of the backup path, into TSs #1, #2, and #4 of an OTN frame to be transmitted to the terminal node C of the active path #1, respectively.

Accordingly, the terminal node C of the active path #1 may receive the three high priority client signals “#1H” of the active path #1 by the same TSs #1, #2, and #4 from both the active path #1 and the backup path.

Then, the backup path end node E maps the two client signals “#2H” of the active path #2 received by the TSs #4 and #5 of the backup path, into TSs #2 and #4 of an OTN frame to be transmitted to the terminal node H of the active path #2, respectively.

Accordingly, the terminal node H of the active path #2 may receive the two high priority client signals “#2H” of the active path #2 by the same TSs #2 and #4 from both the active path #2 and the backup path.

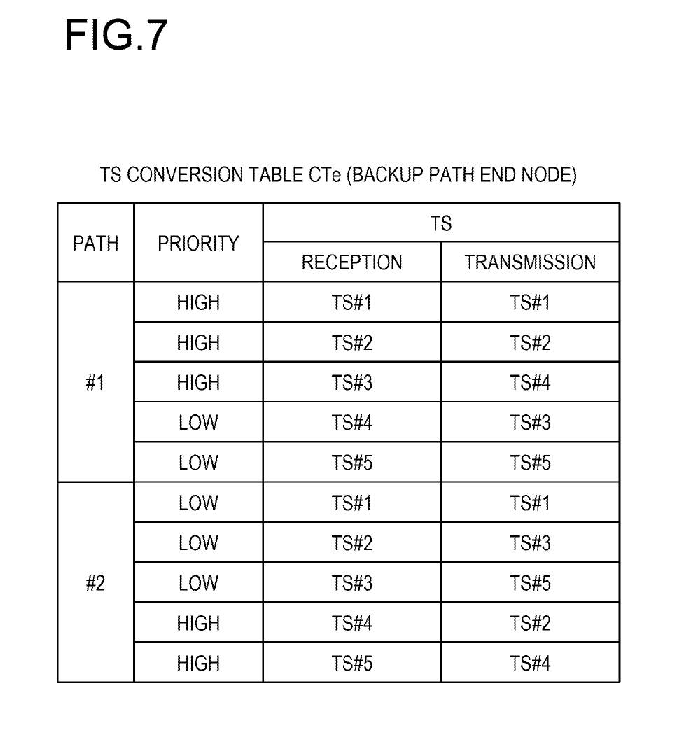

The TS inversion rule as described above may be specified by a TS conversion table CTe as exemplified in FIG. 7. The TS conversion table CTe is an example of a second slot allocation table.

In the TS conversion table CTe, for each of priorities of signals allocated to the TSs of the backup path by the TS conversion table CTs in a backup path start node 11PS, information on the original TS of the active path #x may be set.

The TS conversion table CTe of FIG. 7 may be stored in, for example, the backup path end node E. The setting of the TS conversion table CTe may also be performed by, for example, the OPS 12 as in the TS conversion table CTs of the backup path start node D.

In the TS conversion table CTe exemplified in FIG. 7, the “H” priority client signal of the active path #1 received by the TS #1 is allocated to the TS #1 to be transmitted to the terminal node C of the active path #1. The “H” priority client signal of the active path #1 received by the TS #2 is allocated to the TS #2 to be transmitted to the terminal node C of the active path #1.

The “H” priority client signal of the active path #1 received by the TS #3 is allocated to the TS #4 to be transmitted to the terminal node C of the active path #1. The “L” priority client signal of the active path #1 received by the TS #4 is allocated to the TS #3 to be transmitted to the terminal node C of the active path #1. The “L” priority client signal of the active path #1 received by the TS #5 is allocated to the TS #5 to be transmitted to the terminal node C of the active path #1.

This also applies to the client signals of the active path #2. For example, in the TS conversion table CTe of FIG. 7, the “L” priority client signal of the active path #2 received by the TS #1 is allocated to the TS #1 to be transmitted to the terminal node H of the active path #2. The “L” priority client signal of the active path #2 received by the TS #2 is allocated to the TS #3 to be transmitted to the terminal node H of the active path #2.

The “L” priority client signal of the active path #2 received by the TS #3 is allocated to the TS #5 to be transmitted to the terminal node H of the active path #2. The “H” priority client signal of the active path #2 received by the TS #4 is allocated to the TS #2 to be transmitted to the terminal node H of the active path #2. The “H” priority client signal of the active path #2 received by the TS #5 is allocated to the TS #4 to be transmitted to the terminal node H of the active path #2.

Meanwhile, in the example of FIG. 3, since all low priority client signals of the active paths #1 and #2 are not transmitted from the backup path start node D to the backup path end node E, empty TSs are present in the OTN frames to be transmitted to the terminal nodes C and H from the backup path end node E.

The backup path end node E may map a signal indicating that it was not able to rescue a low priority client signal, into the empty TS. The signal indicating that it was not able to rescue the low priority client signal may be called a “squelch” for convenience. An alarm indication signal (AIS) may be applied to the “squelch.” The AIS is an example of alarm information. The “squelch” is represented by “S” in FIG. 3.

In the example of FIG. 3, in the backup path end node E, the squelch S may be set for each of the TSs #3 and #5 of the OTN frame to be transmitted to the terminal node C of the active path #1. The squelches S indicate that it was not able to rescue the two low priority client signals “#1L” of the active path #1.

Likewise, in the backup path end node E, the squelch S may be set for each of the TSs #1, #3 and #5 of the OTN frame to be transmitted to the terminal node H of the active path #2. The squelches S indicate that it was not able to rescue the three low priority client signals “#2L” of the active path #2.

At the time of normal operation, the terminal node C of the active path #1 is able to normally receive the OTN frame of the active path #1, and thus, may discard the OTN frame received from the backup path end node E even if the client signals are mapped into the OTN frame.

Likewise, at the time of normal operation, the terminal node H of the active path #2 is able to normally receive the OTN frame of the active path #2, and thus, may discard the OTN frame received from the backup path end node E even if the client signals are mapped into the OTN frame.

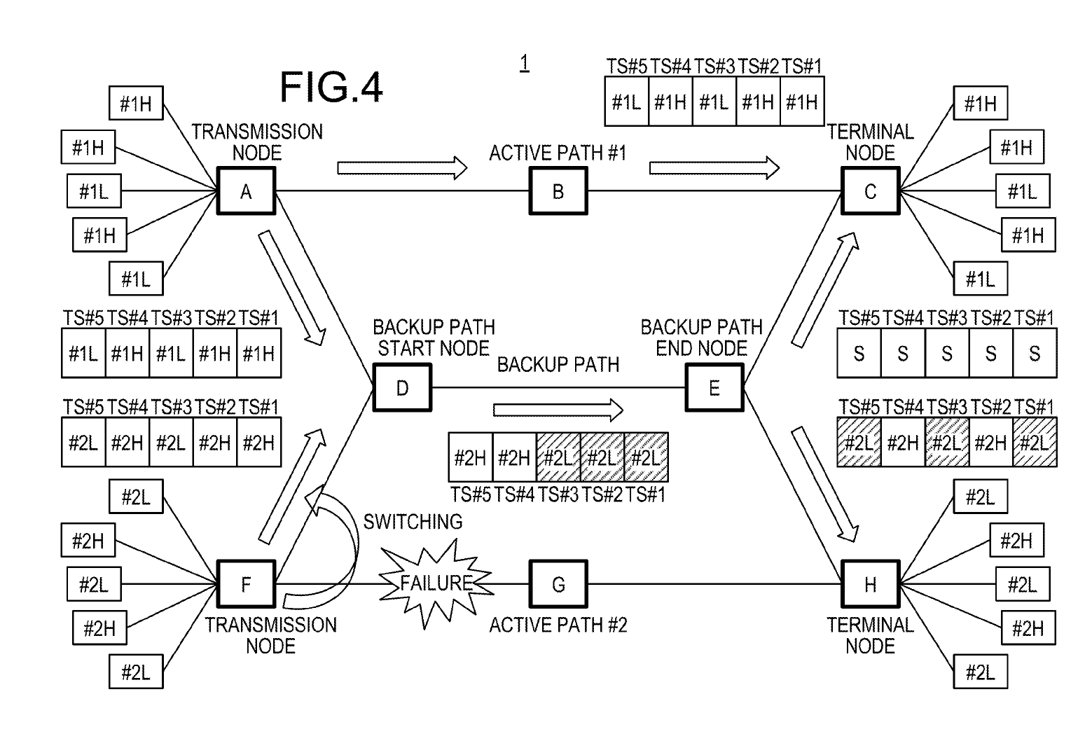

When the squelches S are set in the TSs of each of the OTN frames received from the backup path end node E, the terminal nodes C and H of the active paths #1 and #2 may recognize that it was not able to rescue the low priority client signals by the TSs of the squelches S.

[At the Time of One System Failure Occurrence: FIG. 4]

Hereinafter, descriptions will be made on an operation example when one (e.g., the active path #2) of the active paths #1 and #2 is failed and the failed active path #2 becomes unavailable, with reference to FIG. 4. Meanwhile, in the following description, it may be considered that the operation example in a case where the active path #1 of the active paths #1 and #2 is failed corresponds to the operation example in a case where the active path #1 is replaced with the active path #2.

When the transmission node F detects that the active path #2 is failed, the transmission node F switches the transmission destination of an OTN frame from the active path #2 to the backup path. When the transmission node F is set to transmit the same OTN frames to both the active path #2 and the backup path at the time of normal operation, the transmission node F may stop the transmission of the OTN frame to the active path #2.

Meanwhile, when the active path is failed, an AIS is transmitted in the forward direction from the node that has detected the failure occurrence, and a backward defect indication (BDI) is transmitted in the backward direction.

For example, in the example of FIG. 4, when the OTN frame of the active path #2 is not received at the node G due to a failure occurrence on the optical transmission line in the forward direction between the transmission node F and the node G, the failure occurrence of the active path #2 is detected.

According to the detection of the failure occurrence, the node G may transmit an AIS in the forward direction toward the node H, and transmit a BDI in the backward direction toward the transmission node F of the active path #2. By receiving the BDI, the transmission node F of the active path #2 may detect that the active path #2 is failed.

The transmission node F may notify the backup path start node D that the active path #2 is failed. For this notification, the reserve RES field in the OH of the ODUk signal as exemplified in FIG. 2 may be used.

For example, one bit of the reserve field may be used as a “decision bit” that indicates whether or not the active path is failed. As a non-limiting example, a decision bit of “0” may indicate “no failure” and a decision bit of “1” may indicate a “failure.”

When detecting a “failure” of the active path #2 by the decision bit, the backup path start node D performs a rearrangement of TSs according to the TS conversion table CTs as exemplified in FIG. 6 in order to rescue the client signals of the active path #2 by the backup path.

In the example of FIG. 4, in the backup path start node D, the three low priority client signals “#2L” mapped into TSs #1, #3 and #5 received from the transmission node F are mapped into TSs #1 to #3 of the backup path, respectively.

Also, in the backup path start node D, the two high priority client signals “#2H” mapped into TSs #2 and #4 received from the transmission node F are mapped into TSs #4 and #5 of the backup path, respectively.

Here, as exemplified in FIG. 3, at the time of normal operation: it is assumed that the backup path start node D maps the high priority client signals into the TSs #1 to #5 of the backup path, respectively, and transmits the client signals.

In this case, the backup path start node D may reallocate the TSs #1 to #3 of the backup path, which have been allocated for transmission of the high priority client signals “#1H” of the non-failed active path #1, to the low priority client signals “#2L” of the active path #2.

In the examples of FIGS. 3 and 4, on the images, the TSs #1 to #3 of the backup path are replaced with the low priority client signals “#2L” of the active path #2 on which a failure occurrence has been detected.

Meanwhile, according to the TS conversion table CTe exemplified in FIG. 7, the backup path end node E may perform a rearrangement of the TSs #1 to #5 received by the backup path. For example, the backup path end node E may map the three client signals “#2L” received by the TSs #1 to #3 of the backup path, into TSs #1, #3, and #5 of an OTN frame to be transmitted to the terminal node H of the active path #2, respectively.

Also, the backup path end node E may map the two client signals “#2H” received by the TSs #4 and #5 of the backup path, into TSs #2 and #4 of the OTN frame to be transmitted to the terminal node H of the active path #2, respectively.

Accordingly, the terminal node H of the active path #2 may precisely receive both the high priority client signals “#2H” and the low priority client signals “#2L” of the active path #2 in the same arrangement as that of the TSs #1 to #5 transmitted from the transmission node F to the backup path.

Accordingly, the terminal node H of the active path #2 may precisely transmit the client signals demapped from the TSs #1 to #5 to the reception destinations corresponding to the TSs #1 to #5.

Meanwhile, the backup path end node E may set a squelch S for each of the TSs #1 to #5 of an OTN frame to be transmitted to the terminal node C of the active path #1. Accordingly, the terminal node C of the active path #1 may recognize that it was not able to rescue the client signals of the active path #1 by the TSs #1 to #5, respectively.

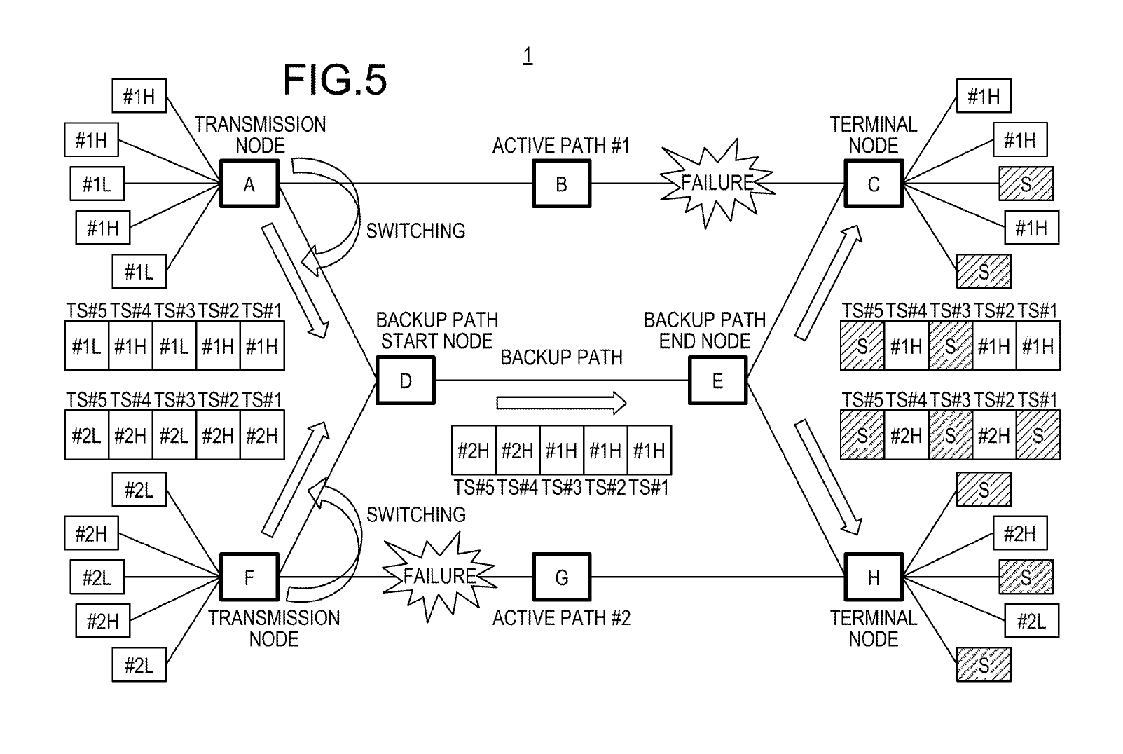

In the present example, since the active path #1 is not failed, the terminal node C may continuously receive the OTN frame from the active path #1, demap the client signals mapped into the TSs #1 to #5, and transmit the demapped client signals to the reception destinations corresponding to the TSs #1 to #5.

[At the Time of Both System Failure Occurrence: FIG. 5]

Hereinafter, descriptions will be made on an operation example when both the active paths #1 and #2 are failed and become unavailable, with reference to FIG. 5.

When both the active paths #1 and #2 are failed, BDIs on both of the active paths #1 and #2 are received by the transmission nodes A and F.

According to the reception of the BDIs, each of the transmission nodes A and F of the active paths #1 and #2 switches the transmission destination of an OTN frame to the backup path. Each of the transmission nodes A and F may notify the backup path start node D that each of the active paths #1 and #2 is failed using, for example, the above-described decision bit.

When detecting that each of the active paths #1 and #2 is failed based on the decision bit, the backup path start node D maps the high priority client signals of each of the active paths #1 and #2, into TSs #1 to #5 of an OTN frame to be transmitted to the backup path.

In the example of FIG. 5, in the backup path start node D, the three high priority client signals “#1H” received by the TSs #1, #2 and #4 from the transmission node A of the active path #1 are mapped into the TSs #1 to #3 of the backup path, respectively.

Also, in the backup path start node D, the two high priority client signals “#2H” received by the TSs #2 and #4 from the transmission node F of the active path #2 are mapped into the TSs #4 and #5 of the backup path, respectively.

Meanwhile, as exemplified in FIG. 3, at the time of normal operation, when high priority client signals may be mapped into the TSs #1 to #5 of the backup path, respectively, the same signals are allocated to the TSs #1 to #5 of the backup path both at the time of normal operation and at the time of failure occurrence in both systems.

The backup path end node E may perform a rearrangement of the TSs #1 to #5 received by the backup path according to the TS conversion table CTe exemplified in FIG. 7.

For example, the backup path end node E may map the three client signals “#1H” received by the TSs #1 to #3 of the backup path, into TSs #1, #2, and #4 of an OTN frame to be transmitted to the terminal node C of the active path #1, respectively.

Also, the backup path end node E may map the two client signals “#2H” received by the TSs #4 and #5 of the backup path, into TSs #2 and #4 of an OTN frame to be transmitted to the terminal node H of the active path #2, respectively.

Accordingly, the terminal node C of the active path #1 may precisely receive the high priority client signals “#1H” of the active path #1 in the same arrangement as that of the TSs #1, #2 and #4 transmitted from the transmission node A to the backup path.

Accordingly, the terminal node C of the active path #1 may precisely transmit the client signals “#1H” demapped from the TSs #1, #2, and #4 to the reception destinations corresponding to the TSs #1, #2, and #4.

Also, the terminal node H of the active path #2 may precisely receive the high priority client signals “#2H” of the active path #2 in the same arrangement as that of the TSs #2 and #4 transmitted from the transmission node F to the backup path.

Accordingly, the terminal node H of the active path #2 may precisely transmit the client signals “#2H” demapped from the TSs #2 and #4 to the reception destinations corresponding to the TSs #2 and #4.

Meanwhile, the backup path end node E may set a squelch S for each of the TSs #3 and #5 of the OTN frame to be transmitted to the terminal node C of the active path #1, and for each of the TSs #1, #3, and #5 of the OTN frame to be transmitted to the terminal node H of the active path #2.

Accordingly, the terminal node C of the active path #1 may recognize that it was not able to rescue the low priority client signals “#1L” of the active path #1 by the TSs #3 and #5, respectively. Accordingly, the terminal node C of the active path #1 may transmit squelches S to the reception destinations corresponding to the TSs #3 and #5, respectively.

Likewise, the terminal node H of the active path #2 may recognize that it was not able to rescue the low priority client signals “#2L” of the active path #2 by the TSs #1, #3 and #5, respectively. Accordingly, the terminal node H of the active path #2 may transmit squelches S to the reception destinations corresponding to the TSs #1, #3 and #5, respectively.

Through the TS conversion as described above, even when both of the active paths #1 and #2 are failed, the rescue rate of high priority client signals in the paths #1 and #2, by the backup path, may be increased.

[Operation Example of OPS and Node]

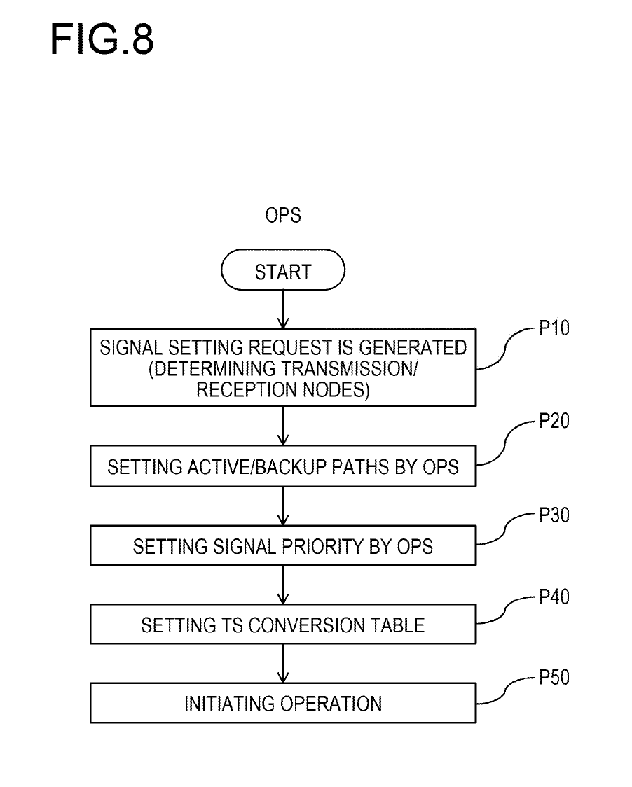

Hereinafter, descriptions will be made on operation examples of the OPS 12 and the node 11 which implement the operation example of the network 1 that includes the above-described TS conversion, with reference to FIGS. 8 to 12.

[Operation Example of OPS: FIG. 8]

FIG. 8 is a flow chart illustrating an operation example of the OPS 12. As exemplified in FIG. 8, in response to occurrence of a signal setting request, the OPS 12 determines a transmission node 11 and a reception node 11 in the network 1 (operation P10). In the examples of FIGS. 3 to 5, in the OPS 12, the nodes A and F are determined as the transmission nodes 11, and the nodes C and H are determined as the reception nodes 11.

The signal setting request for the OPS 12 may be given to the OPS 12 by, for example, the operator terminal operated by the network manager.

The network manager may determine any node as the transmission node 11 or the reception node 11 in the network 1 as a management target, using a graphical user interface (GUI) or a command line interface (CLI) of the operator terminal.

The OPS 12 may set an active path and a backup path between the determined transmission node 11 and reception node 11 according to the setting from the operator terminal (operation P20). In the examples of FIGS. 3 and 5, a first active path #1 is set for a route of nodes A-B-C, a second active path #2 is set for a route of nodes F-G-H.

Also, backup paths are set for a route of nodes A-D-E-C, and a route of nodes F-D-E-H. As described above, the backup path for a section of the nodes D-E is shared by the active paths #1 and #2.

According to the setting from the operator terminal, the OPS 12 sets priorities of client signals to be mapped into OTN frames of the active paths #1 and #2 (operation P30). The setting examples of priorities are the same as exemplified in FIGS. 3 to 5.

The OPS 12, based on the set priorities, may set the TS conversion table CTs as exemplified in FIG. 6, in the node (the backup path start node) 11 located at the start point of the backup path section shared by the plurality of active paths #1 and #2 (operation P40). In the examples of FIGS. 3 and 5, the TS conversion table CTs exemplified in FIG. 6 may be set in the node D.

Also, the OPS 12, based on the set priorities, may set the TS conversion table CTe as exemplified in FIG. 7, in the node (the backup path end node) 11 located at the end point of the backup path section (operation P40). In the examples of FIGS. 3 and 5, the TS conversion table CTe exemplified in FIG. 7 may be set in the node E.

By performing a rearrangement of TSs according to the TS conversion table CTe, the backup path end node E may rearrange the TSs rearranged according to the TS conversion table CTs set in the backup path start node D back to their original TS arrangement.

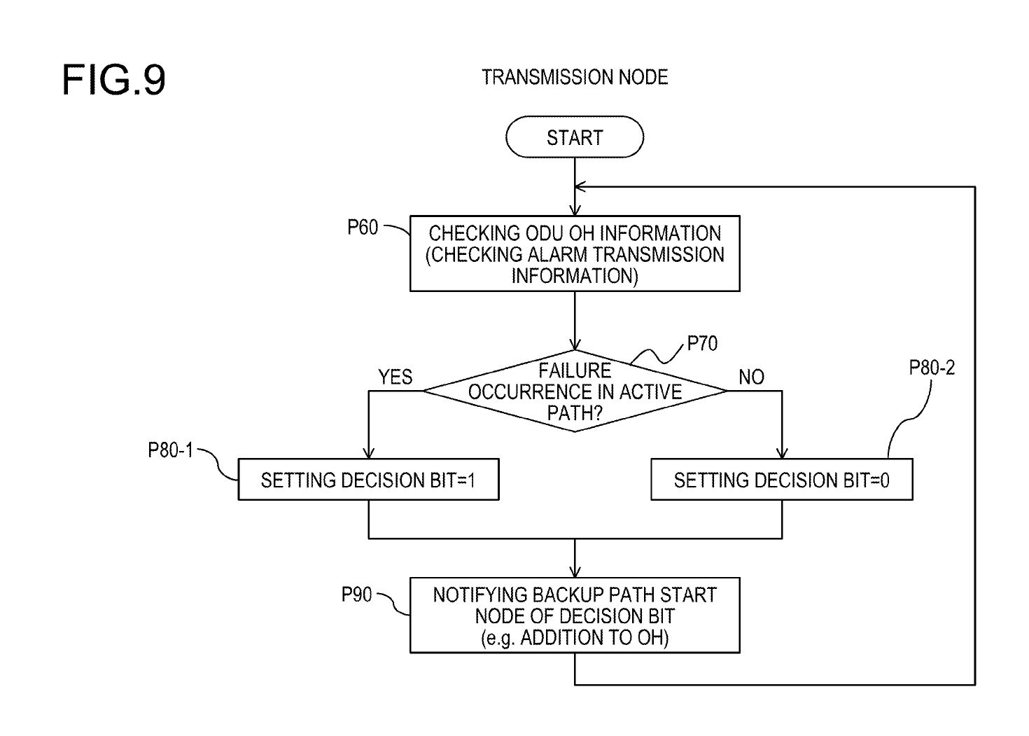

After the setting described above is completed by the OPS 12, the operation of the network 1 may be initiated (operation P50).

[Operation Example of Transmission Node: FIG. 9]

FIG. 9 is a flow chart illustrating an operation example of the transmission node 11 of the active path (#1 or #2).

As exemplified in FIG. 9, after the operation of the network 1 is initiated, the transmission node 11 of the active path checks the alarm transmission information set in the ODUk OH of the OTN frame received in the backward direction of the active path (operation P60).

By checking the alarm transmission information, the transmission node 11 may determine whether or not the active path is failed (operation P70). For example, when a BDI which is an example of the alarm transmission information is received, the transmission node 11 may determine that the active path is failed, and when the BDI is not received, the transmission node 11 may determine that the active path is not failed.

When the BDI is received and it is determined that the active path is failed (YES in operation P70), the transmission node 11 may set a decision bit of “1” to, for example, a reserve field of the ODUk OH of an OTN frame to be transmitted to the backup path (operation P80-1).

When the BDI is not received and it is determined that the active path is not failed (NO in operation P70), the transmission node 11 may set a decision bit of “0” to, for example, a reserve field of the ODUk OH of the OTN frame to be transmitted to the backup path (operation P80-2).

Accordingly, the decision bit indicating whether or not the active path is failed may be notified to the backup path start node 11 (e.g., the node D illustrated in FIGS. 3 to 5) (operation P90).

[Operation Example of Backup Path Start Node]

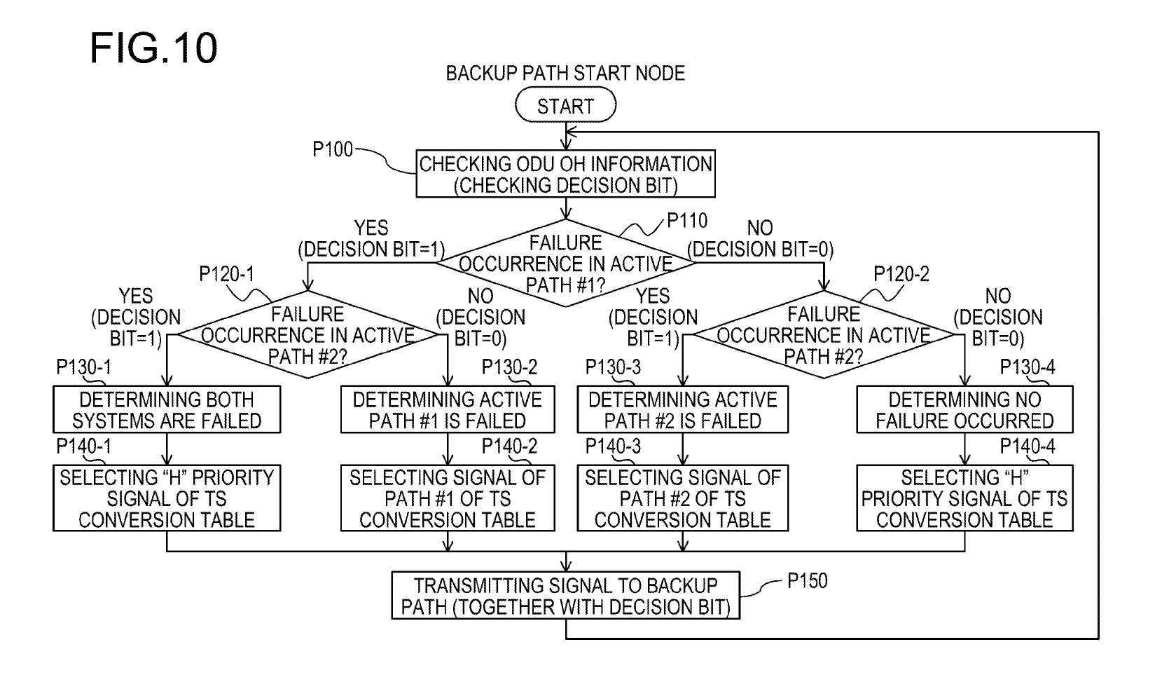

FIG. 10 is a flow chart illustrating an operation example of the backup path start node 11. As exemplified in FIG. 10, after the operation of the network 1 is initiated, the backup path start node 11 checks the ODUk OH of the OTN frame received by the backup path, and checks the decision bit set in the reserve field (operation P100). Meanwhile, the backup path start node 11 may receive each of OTN frames transmitted to the backup path from, for example, transmission nodes 11 of a plurality of active paths #1.

The backup path start node 11, based on, for example, the decision bit in the ODUk OH of the OTN frame received from the transmission node 11 of the first active path #1, determines whether or not the first active path #1 is failed (operation P110).

For example, when it is determined that decision bit=0 (NO in operation P110), the backup path start node 11 may determine that the active path #1 is not failed.

Thereafter, the backup path start node 11, based on the decision bit in the ODUk OH of the OTN frame received from the transmission node 11 of the second active path #2, may determine whether or not the second active path #2 is failed (operation P120-2).

When it is determined that decision bit=0 (NO in operation P120-2), the backup path start node 11 may determine that the active path #2 is also not failed (operation P130-4). According to the determination, the backup path start node 11, in preparation for a failure occurrence of the active path #1 or #2, may select client signals set with priorities “H” in a TS conversion table CTs, and rearrange TSs (operation P140-4).

For example, the backup path start node 11 may select client signals of the active paths #1 and #2, which are received by reception TSs set with priorities “H” in the TS conversion table CTs, as signals to be transmitted preferentially to the backup path.

The selected “H” priority client signals (“#1H” and “#2H” exemplified in FIGS. 3 to 5) are transmitted to the backup path by transmission TSs set in the TS conversion table CTs (operation P150).

Here, the backup path start node 11 may set information of the decision bit used for determination in operations P110 and P120-2 in the ODUk OH of an OTN frame to be transmitted to the backup path, and then transmit the information.

It may be considered that the operations P100, P110, P120-2, P130-4, P140-4 and P150 as described above correspond to the operation example of the backup path start node D at the time of normal operation as exemplified in FIG. 3.

Meanwhile, in operation P120-2, when it is determined that decision bit=1 (YES), the backup path start node 11 may determine that the active path #1 is not failed but the active path #2 is failed (operation P130-3).

According to the determination, the backup path start node 11 may select client signals of the active path #2, which are received by reception TSs set with priorities “H” in the TS conversion table CTs, as signals to be transmitted preferentially to the backup path, and rearrange the client signals (operation P140-3).

The selected “H” priority client signals of the active path #2 are transmitted to the backup path by transmission TSs set in the TS conversion table CTs (operation P150).

Here, the backup path start node 11 may set information of the decision bit used for determination in operations P110 and P120-2 in the ODUk OH of the OTN frame to be transmitted to the backup path, and then transmit the information.

It may be considered that the operations P100, P110, P120-2, P130-3, P140-3 and P150 as described above correspond to the operation example of the backup path start node D at the time of one system failure occurrence as exemplified in FIG. 4.

Also, in operation P110 of FIG. 10, when it is determined that the decision bit on the active path #1 is 1 (YES), the backup path start node 11 may determine whether or not the active path #2 is failed based on the decision bit on the active path #2 (operation P120-1).

When it is determined that decision bit=0 (NO in operation P120-1), the backup path start node 11 may determine that the active path #2 is not failed but the active path #1 is failed (operation P130-2).

According to the determination, the backup path start node 11 may select client signals of the active path #1, which are received by reception TSs set with priorities “H” in the TS conversion table CTs, as signals to be transmitted preferentially to the backup path (operation P140-2).

The selected “H” priority client signals of the active path #1 are transmitted to the backup path by transmission TSs set in the TS conversion table CTs (operation P150).

Here, the backup path start node 11 may set information of the decision bit used for determination in operations P110 and P120-1 in the ODUk OH of the OTN frame to be transmitted to the backup path, and then transmit the information.

Also, in operation P120-1 of FIG. 10, when it is determined that the decision bit on the active path #2 is 1 (YES), the backup path start node 11 may determine that both the active paths #1 and #2 are failed (operation P130-1).

According to the determination, the backup path start node 11 may select client signals of the active paths #1 and #2, which are received by reception TSs set with priorities “H” in the TS conversion table CTs, as signals to be transmitted preferentially to the backup path (operation P140-1).

The selected “H” priority client signals of the active paths #1 and #2 are transmitted to the backup path by transmission TSs set in the TS conversion table CTs (operation P150).

It may be considered that the operations P100, P110, P120-1, P130-1, P140-1 and P150 as described above correspond to the operation example of the backup path start node D at the time of both system failure occurrence as exemplified in FIG. 5.

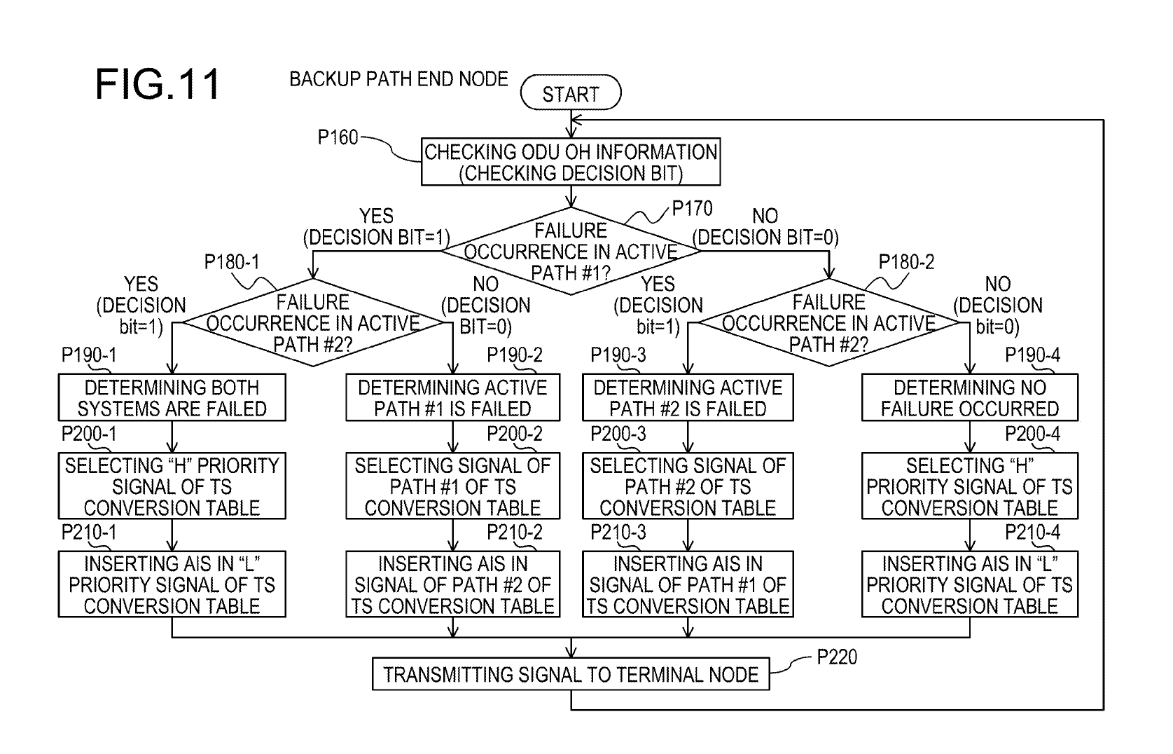

Meanwhile, in the above-described operation example in FIG. 10, a failure occurrence determination is performed on the active path #2 after the active path #1, but the failure occurrence determination based on the decision bit may be performed first on any of the active paths #1 and #2, and simultaneously on both the active paths #1 and #2.

[Operation Example of Backup Path End Node: FIG. 11]

FIG. 11 is a flow chart illustrating an operation example of the backup path end node 11. As exemplified in FIG. 11, after the operation of the network 1 is initiated, the backup path end node 11 checks the ODUk OH of the OTN frame received by the backup path, and checks the decision bit set in the reserve field (operation P160).

The backup path end node 11, based on the decision bit in the ODUk OH of the OTN frame received by the backup path, may determine whether or not the first active path #1 is failed (operation P170).

For example, when it is determined that decision bit=0 (NO in operation P170), the backup path end node 11 may determine that the active path #1 is not failed.

Thereafter, the backup path end node 11, based on the decision bit on the second active path #2, may determine whether or not the second active path #2 is failed (operation P180-2).

When it is determined that decision bit=0 (NO in operation P180-2), the backup path end node 11 may determine that the active path #2 is also not failed (operation P190-4). According to the determination, the backup path end node 11, in preparation for a failure occurrence of the active path #1 or #2, may select signals set with priorities “H” in a TS conversion table CTe, and rearrange TSs (operation P200-4).

For example, the backup path end node 11 may select client signals of the active paths #1 and #2, which are received by reception TSs set with priorities “H” in the TS conversion table CTe, as signals to be transmitted to the corresponding reception nodes 11.

The backup path end node 11 may set (also, referred to as “insert”) squelches S (e.g., AISs) in transmission TSs set with priorities “L” in the TS conversion table CTe (operation P210-4).

When it is determined that neither the active path #1 nor #2 is failed, “H” priority client signals flow through the backup path, and “L” priority client signals have not been rescued.

Therefore, by inserting AISs in the TSs of “L” priorities, the backup path end node 11 notifies the downstream node 11 that it was not able to rescue the “L” priority client signals by the backup path.

The selected client signals and the inserted AISs are transmitted to the reception nodes 11 by the transmission TSs set in the TS conversion table CTe (operation P220).

It may be considered that the operations P160, P170, P180-2, P190-4, P200-4, P210-4 and P220 as described above correspond to the operation example of the backup path end node E at the time of normal operation as exemplified in FIG. 3.

Meanwhile, in operation P180-2, when it is determined that the decision bit on the active path #2 is 1 (YES), the backup path end node 11 may determine that the active path #1 is not failed but the active path #2 is failed (operation P190-3).

According to the determination, the backup path end node 11 may select client signals of the active path #2, which are received by reception TSs of “H” priorities in the TS conversion table CTe, as signals to be transmitted to the reception node 11 of the active path #2, and rearrange the client signals (operation P200-3).

Also, the backup path end node 11 may insert squelches S (e.g., AISs) in transmission TSs of the active path #1 set with priorities “L” in the TS conversion table CTe (operation P210-3).

The selected client signals of the active path #2, and the AISs inserted for the active path #1 are transmitted to the reception nodes 11 by the transmission TSs set in the TS conversion table CTe (operation P220).

It may be considered that the operations P160, P170, P180-2, P190-3, P200-3, P210-3 and P220 as described above correspond to the operation example of the backup path end node E at the time of one system failure occurrence as exemplified in FIG. 4.

Also, in operation P170 of FIG. 11, when it is determined that the decision bit on the active path #1 is 1 (YES), the backup path end node 11, based on the decision bit on the active path #2, may determine whether or not the active path #2 is failed (operation P180-1).

As a result of determination, when it is determined that decision bit=0 (NO in operation P180-1), the backup path end node 11 may determine that the active path #2 is not failed but the active path #1 is failed (operation P190-2).

According to the determination, the backup path end node 11 may select client signals of the active path #1, which are received by reception TSs set with priorities “H” in the TS conversion table CTe, as signals to be transmitted to the reception node 11 of the active path #1, (operation P200-2).

Also, the backup path end node 11 may insert squelches S (e.g., AISs) in transmission TSs of the active path #2 set with priorities “L” in the TS conversion table CTe (operation P210-2).

The selected client signals of the active path #1, and the AISs inserted for the active path #2 are transmitted to the reception nodes 11 by transmission TSs set in the TS conversion table CTe (operation P220).

Also, in operation P180-1 of FIG. 11, when it is determined that decision bit=1 (YES), the backup path end node 11 may determine that both the active paths #1 and #2 are failed (operation P190-1).

According to the determination, the backup path end node 11 may select client signals, which are received by reception TSs set with priorities “H” in the TS conversion table CTe, as signals to be transmitted to the reception nodes 11 of the active paths #1 and #2, (operation P200-1).

Also, the backup path end node 11 may insert squelches S (e.g., AISs) in transmission TSs set with priorities “L” in the TS conversion table CTe (operation P210-1).

The selected client signals and the inserted AISs are transmitted to the corresponding reception nodes 11 by transmission TSs set in the TS conversion table CTe (operation P220).

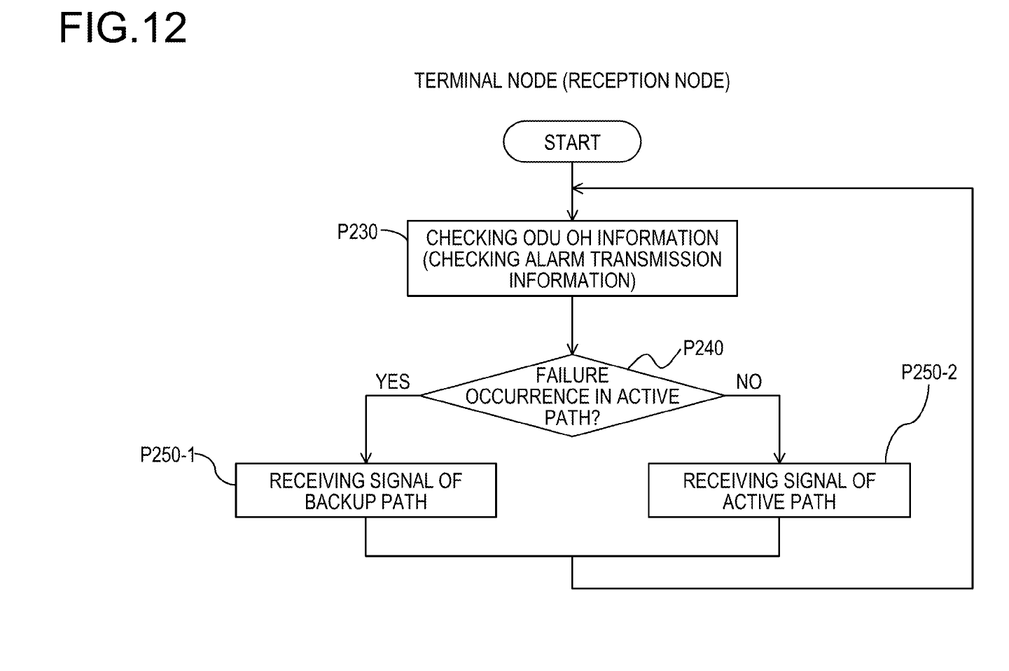

It may be considered that the operations P160, P170, P180-1, P190-1, P200-1, P210-1 and P220 as described above correspond to the operation example of the backup path end node E at the time of both system failure occurrence as exemplified in FIG. 5.

[Operation Example of Reception Node: FIG. 12]

FIG. 12 is a flow chart illustrating an operation example of the reception node 11 of the active path #1 (or #2).

As exemplified in FIG. 12, after the operation of the network 1 is initiated, the reception node 11 of the active path checks the alarm transmission information set in the ODUk OH of the OTN frame received from the active path (operation P230).

By checking the alarm transmission information of the ODUk OH, the reception node 11 may determine whether or not the active path is failed (operation P240). For example, when an AIS which is an example of alarm transmission information is received, the reception node 11 may determine that the active path is failed, and when the AIS is not received, the reception node 11 may determine that the active path is not failed.

According to the determination result, the reception node 11 may determine any one of the active path and the backup path from which an OTN frame is to be received.

For example, when it is determined that the active path is failed (YES in operation P240), the reception node 11 may receive the OTN frame from the backup path (operation P250-1).

Accordingly, at least “H” priority client signals of the failed active path may be rescued by the backup path. For example, even when a plurality of active paths are failed, “H” priority client signals may be securely rescued.

Whereas, when it is determined that the active path is not failed (NO in operation P240), the reception node 11 may receive the OTN frame from the active path (operation P250-2).

Meanwhile, the operations P230, P240, P250-1 and P250-2 may be repeatedly performed in the reception node 11.

As described above, the reception node 11 may switch a reception source of the OTN frame to either the active path or the backup path, and then receive the OTN frame. Then, the reception node 11 may not be aware of whether or not the rearrangement of TSs has been performed in the backup path start node 11 and the backup path end node 11.

As described above, according to the above-described embodiment, in the network 1 that supports the SMP of 1:N, even when multiple failures occur in the plurality of active paths, at least high priority client signals may be securely rescued by the backup path. Accordingly, the operation reliability of the network 1 may be improved.

As compared to the “1:1 protection” method, the SMP of 1:N may have a decreased number of backup paths set for active paths, and thus may reduce the cost for the transmission line, and achieve utilization efficiency of the band for the backup path.

[Configuration Example of Node]

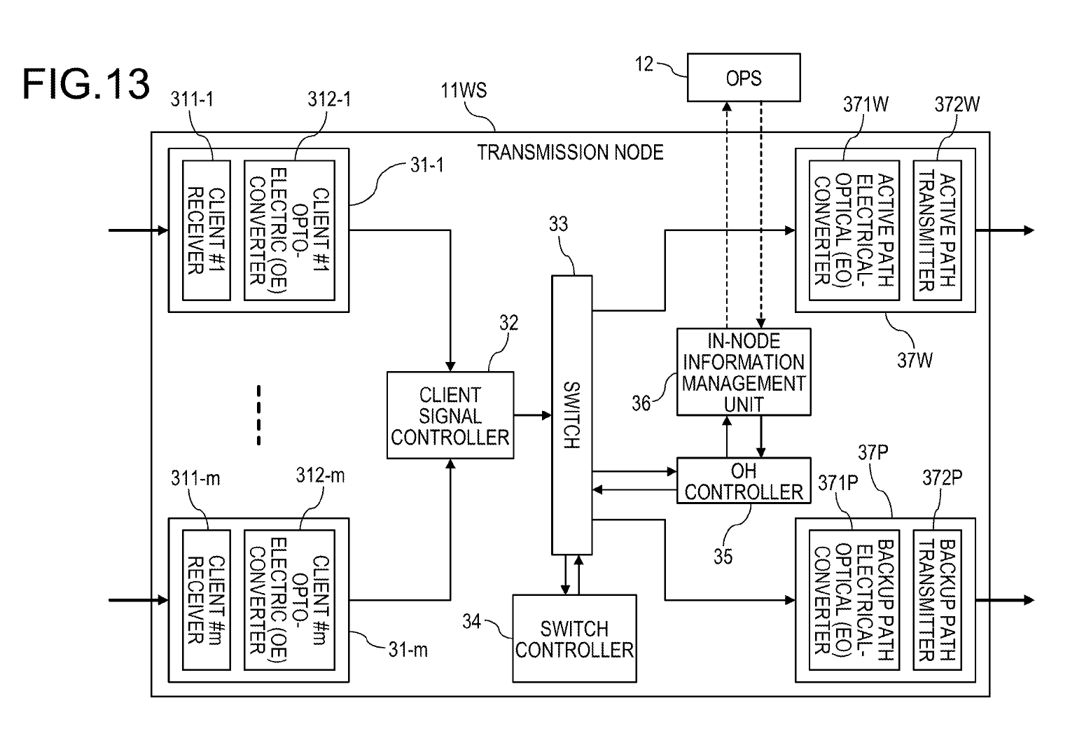

Hereinafter, descriptions will be made on functional configuration examples of a transmission node 11, a backup path start node 11, a backup path end node 11, and a reception node 11 that may implement the above-described operation examples, with reference to FIGS. 13 to 16.

Meanwhile, hereinafter, for convenience, the transmission node 11 and the reception node 11 may be denoted by a “transmission node 11WS,” and a “reception node 11WE,” respectively. Also, for convenience, the backup path start node 11 and the backup path end node 11 may be denoted by a “backup path start node 11PS,” and a “backup path end node 11PE,” respectively.

[Configuration Example of Transmission Node: FIG. 13]

FIG. 13 is a block diagram illustrating a functional configuration example of the transmission node 11WS of an active path. The transmission node 11WS exemplified in FIG. 13 may correspond to, for example, the transmission node A or F illustrated in FIGS. 3 to 5.

As illustrated in FIG. 13, the transmission node 11WS may include, for example, a plurality of client signal reception interfaces IFs 31-1 to 31-m (m is an integer of 2 or more), a client signal controller 32, a switch 33, and a switch controller 34. Also, the transmission node 11WS may include, for example, an overhead (OH) controller 35, an in-node information management unit 36, an active path transmission IF 37W, and a backup path transmission IF 37P.

Client signal reception IFs 31-j (j is any one of 1 to m) may be provided to correspond to the number (m) of client signals that the transmission node 11WS may receive from a client network.

Each of the client signal reception IFs 31-j may include a client #j receiver 311-j, and a client #j opto-electric (OE) converter 312-j.

For example, the client #j receiver 311-j receives a client signal from a client network corresponding to the client #j. The client signal may be, for example, an optical signal.

For example, the client #j opto-electric converter 312-j converts the client signal of the optical signal, which is received by the client #j receiver 311-j, into an electrical signal.

For example, the client signal controller 32 maps the client signal, which has been converted into the electrical signal by the opto-electric converter 312-j of each client signal reception IF 31-j, into an OTN frame. For example, the client signal may be mapped to an LO-ODU signal, and the LO-ODU signal may be mapped to a HO-ODU signal.

For example, according to a control by the switch controller 34, the switch 33 selectively outputs the OTN frame, in which client signals are mapped, to either the active path transmission IF 37W or the backup path transmission IF 37P in a time-division manner.

During the selective output of the OTN frame by the switch 33, insertion or extraction of ODUk OH information may be performed by the OH controller 35.

For example, the OH controller 35 may insert OH information received from the in-node information management unit 36 in the ODUk OH, and output the OH information extracted from the ODUk OH to the in-node information management unit 36.

The in-node information management unit 36 manages, for example, OH information inserted or extracted as described above, information defining priorities of client signals (also, referred to as “signal priority information”), and setting information of an active path and a backup path. These information may be collectively referred to as “node information,” for convenience. The node information may be set by, for example, the OPS 12.

When the active path is failed, for example, a BDI is received and detected by the OH controller 35. According to the detection of the BDI, the OH controller 35 may set the above-described decision bit of “1” in the ODUk OH (e.g., a reserve field). When the BDI is not detected, the decision bit of 0 may be set in the reserve field.

According to the setting of the decision bit by the OH controller 35, as described above, whether or not the active path is failed may be notified to the backup path start node 11PS.

Meanwhile, it may be considered that the client signal controller 32, the switch controller 34, the OH controller 35, and the in-node information management unit 36 constitute an example of a controller of the transmission node 11WS. For example, the controller of the transmission node 11WS may be realized using a computing device having an arithmetic capacity such as, for example, a central processing unit (CPU) or a digital signal processor (DSP), or a storage medium such as, for example, a flash memory.

For example, for the controller of the backup path start node 11PS, an integrated circuit (IC), a large-scale integration (LSI), an application specific integrated circuit (ASIC), or a field-programmable gate array (FPGA) may be used.

For example, the active path transmission IF 37W converts the OTN frame of the electrical signal received from the switch 33 into an optical signal, and transmits the converted optical signal to the active path.

Thus, the active path transmission IF 37W may include, for example, an active path electrical-optical (EO) converter 371W and an active path transmitter 372W.

For example, the active path electrical-optical converter 371W converts the OTN frame of the electrical signal received from the switch 33 into the optical signal.

The active path transmitter 372W transmits the OTN frame converted into the optical signal to an optical transmission line corresponding to the active path.

Whereas, for example, the backup path transmission IF 37P converts the OTN frame of the electrical signal received from the switch 33 into an optical signal, and transmits the converted optical signal to the backup path.

Thus, for example, the backup path transmission IF 37P may include a backup path electrical-optical (EO) converter 371P and a backup path transmitter 372P.

For example, the backup path electrical-optical converter 371P converts the OTN frame of the electrical signal received from the switch 33 into the optical signal.

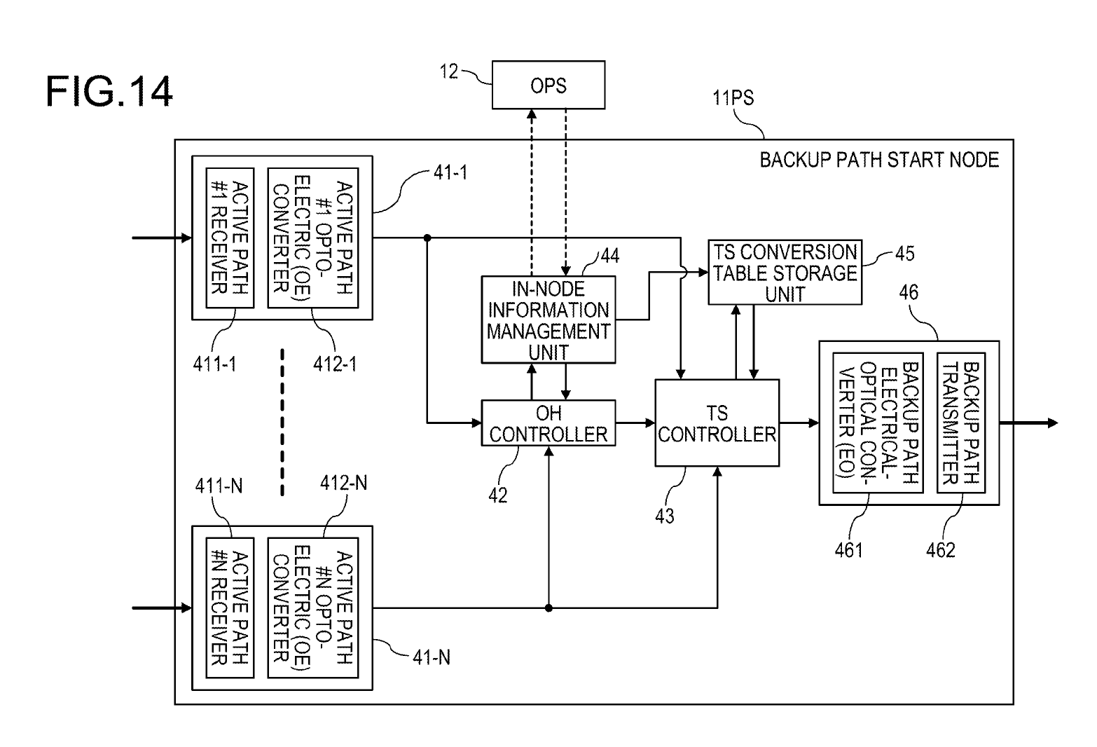

The backup path transmitter 372P transmits the OTN frame converted into the optical signal to an optical transmission line corresponding to the backup path.

[Configuration Example of Backup Path Start Node: FIG. 14]

FIG. 14 is a block diagram illustrating a functional configuration example of the backup path start node 11PS. For example, the backup path start node 11PS exemplified in FIG. 14 may correspond to the backup path start node D illustrated in FIGS. 3 to 5.

As illustrated in FIG. 14, the backup path start node 11PS may include, for example, a plurality of backup path reception IFs 41-1 to 41-N corresponding to the number N of active paths. The backup path start node 11PS may include, for example, an OH controller 42, a tributary slot TS controller 43, an in-node information management unit 44, and a TS conversion table storage unit 45. The backup path start node 11PS may include, for example, a backup path transmission IF 46.

For example, a backup path reception IF 41-x (x is any one of 1 to N) receives an OTN frame which the transmission node 11 of an active path #x has transmitted to the backup path set for the active path #x.

The backup path reception IF 41-x is an example of a receiving unit that receives a plurality of signals set with priorities, by a plurality of TSs, from any one of active paths #x.

For example, the backup path reception IF 41-x may include an active path #x receiver 411-x, and an active path #x opto-electric (OE) converter 412-x.

The active path #x receiver 411-x receives the OTN frame from the backup path set for the active path #x.

The active path #x opto-electric converter 412-x converts the OTN frame, which is an optical signal received by the active path #x receiver 411-x, into an electrical signal. The OTN frame converted into the electrical signal may be input to the OH controller 42 and the TS controller 43.

For example, the OH controller 42 may insert OH information received from the in-node information management unit 44 in the ODUk OH, and output the OH information extracted from the ODUk OH to the in-node information management unit 44.

Also, based on the decision bit set in the ODUk OH information, the OH controller 42 may determine whether or not the active path #x is failed. According to the determination result, as described above, TS conversion may be controlled by the TS controller 43, based on the TS conversion table CTs (see, e.g., FIG. 6).

The in-node information management unit 44 manages, for example, OH information inserted or extracted as described above, signal priority information defining priorities of client signals, and setting information of an active path and a backup path. These node information may be set by, for example, the OPS 12.

The TS conversion table storage unit 45 is an example of a first storage unit, and may store the TS conversion table CTs exemplified in FIG. 6. As for the TS conversion table storage unit 45, for example, a storage medium such as a flash memory may be employed. Before the operation of the network 1 is initiated, for example, according to the setting from the OPS 12, the TS conversion table CTs may be stored in the TS conversion table storage unit 45 by the in-node information management unit 44.

As exemplified in FIGS. 3 to 7, and FIG. 10, according to the determination result on failure occurrence or non-occurrence of the active path #x based on the decision bit in the OH controller 42, the TS controller 43 performs TS conversion in accordance with the TS conversion table CTs stored in the TS conversion table storage unit 45.

The TS controller 43 is an example of a first slot controller. The client signals of respective transmission TSs that have been subjected to the TS conversion may be mapped into the OTN frame, and output to the backup path transmission IF 46.

Here, the information on the decision bit for each active path #x, which is obtained from the OH controller 42, may be set in the ODUk OH of the OTN frame to be output to the backup path transmission IF 46. Accordingly, the downstream node 11 of the backup path may also recognize whether or not the active path #x is failed.

It may be considered that the OH controller 42, the TS controller 43, the in-node information management unit 44, and the TS conversion table storage unit 45 constitute an example of a controller that controls allocation of signals received by TSs from the active path #x, to TSs of the backup path, based on the priorities of the signals.

For example, the controller of the backup path start node 11PS may be realized using a computing device having an arithmetic capacity such as, for example, a CPU or a DSP, or a storage medium such as, for example, a flash memory. For example, for the controller of the backup path start node 11PS, an IC, an LSI, an ASIC, or a FPGA may be used.

For example, the backup path transmission IF 46 converts the OTN frame of the electrical signal input from the TS controller 43 into an optical signal, and transmits the converted optical signal to the backup path. The backup path transmission IF 46 is an example of a transmission unit that transmits the signal received by a TS of the active path #x through any of a plurality of TSs in the backup path.

For example, the backup path transmission IF 46 may include a backup path electrical-optical (EO) converter 461 and a backup path transmitter 462.

For example, the backup path electrical-optical converter 461 converts the OTN frame of the electrical signal input from the TS controller 43 into the optical signal.

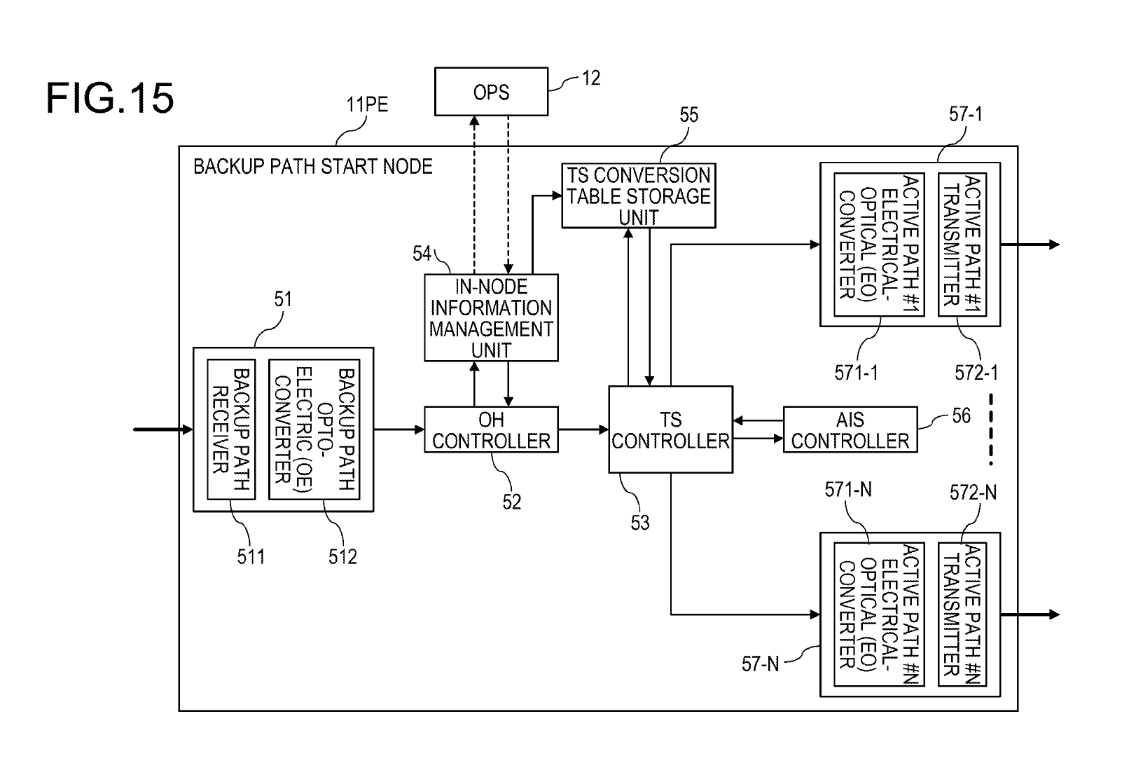

For example, the backup path transmitter 462 transmits the OTN frame converted into the optical signal by the backup path electrical-optical converter 461 to an optical transmission line set for the backup path.

[Configuration Example of Backup Path End Node: FIG. 15]

FIG. 15 is a block diagram illustrating a functional configuration example of the backup path end node 11PE. For example, the backup path end node 11PE exemplified in FIG. 15 may correspond to the backup path end node E illustrated in FIGS. 3 to 5.

As illustrated in FIG. 15, for example, the backup path end node 11PE may include a backup path reception IF 51, an OH controller 52, a TS controller 53, an in-node information management unit 54, and a TS conversion table storage unit 55, and an AIS controller 56. For example, the backup path end node 11PE may include a backup path transmission IF 57-x for each active path #x.

For example, the backup path reception IF 51 may receive the OTN frame transmitted by the upstream node of the backup path, and convert the OTN frame into an electrical signal. The backup path reception IF 51 is an example of a receiving unit that receives a plurality of signals set with priorities, by a plurality of TSs, from the backup path.

For example, the backup path reception IF 51 may include a backup path receiver 511, and a backup path opto-electric (OE) converter 512.

For example, the backup path receiver 511 receives the OTN frame from the backup path. For example, the backup path opto-electric converter 512 converts the OTN frame received by the backup path receiver 511, which is an optical signal, into an electrical signal.

For example, the OH controller 52 may insert OH information received from the in-node information management unit 54 in the ODUk OH, and output the OH information extracted from the ODUk OH to the in-node information management unit 54.

Also, based on the decision bit which is set in the ODUk OH information by the upstream node 11 of the backup path, the OH controller 52 may determine whether or not the active path #x is failed. According to the determination result, as described above, TS conversion may be controlled by the TS controller 53 based on the TS conversion table CTe (see, e.g., FIG. 7).

The in-node information management unit 54 manages, for example, OH information inserted or extracted as described above, signal priority information defining priorities of client signals, and setting information of an active path and a backup path. These node information may be set by, for example, the OPS 12.

The TS conversion table storage unit 55 is an example of a second storage unit, and may store the TS conversion table CTe exemplified in FIG. 7. As for the TS conversion table storage unit 55, for example, a storage medium such as a flash memory may be employed. Before the operation of the network 1 is initiated, for example, according to the setting from the OPS 12, the TS conversion table CTe may be stored in the TS conversion table storage unit 55 by the in-node information management unit 54.

As exemplified in FIGS. 3 to 7, and FIG. 11, according to the determination result on failure occurrence or non-occurrence of the active path #x based on the decision bit in the OH controller 52, the TS controller 53 performs TS conversion in accordance with the TS conversion table CTe stored in the TS conversion table storage unit 55.

Also, the TS controller 53 is an example of a second slot controller that controls allocation of signals allocated to the TSs of the backup path, to original TSs of the active path #x, in accordance with the TS conversion table CTe.

For example, the AIS controller 56 inserts an AIS into a TS corresponding to a client signal that is not to be rescued in the TS conversion by the TS controller 53.

For example, the OTN frame, for which the TS conversion and the AIS insertion have been performed, is output to the backup path transmission IF 57-x for each active path #x.

It may be considered that the OH controller 52, the TS controller 53, the in-node information management unit 54, the TS conversion table storage unit 55, and the AIS controller 56 constitute an example of a controller (or a control circuit) of the backup path end node 11PE.

For example, the controller of the backup path end node 11PE controls the allocation of signals received by the TSs from the backup path, to the TSs of the active path #x, based on the priorities of the signals.

In the same manner as in the controller of the backup path start node 11PS, the controller of the backup path end node 11PE may be realized using a computing device having an arithmetic capacity such as, for example, a CPU or a DSP, or a storage medium such as, for example, a flash memory.

For example, for the controller of the backup path end node 11PE, an IC, an LSI, an ASIC, or a FPGA may be used.

For example, the backup path transmission IF 57-x converts the OTN frame of the electrical signal including respective TSs, for which the TS conversion and the AIS insertion have been performed, into an optical signal, and transmits the OTN frame to the reception node 11 of the active path #x.

The backup path transmission IF 57-x is an example of a transmission unit that transmits a signal received by the TS from the backup path, to any reception node 11 of the active path #x through any one of a plurality of TSs of the active path #x.

For example, the backup path transmission IF 57-x may include an active path #x electrical-optical (EO) converter 571-x and an active path #x transmitter 572-x.

For example, the active path #x electrical-optical converter 571-x converts the OTN frame of the electrical signal received from the TS controller 53 into the optical signal.

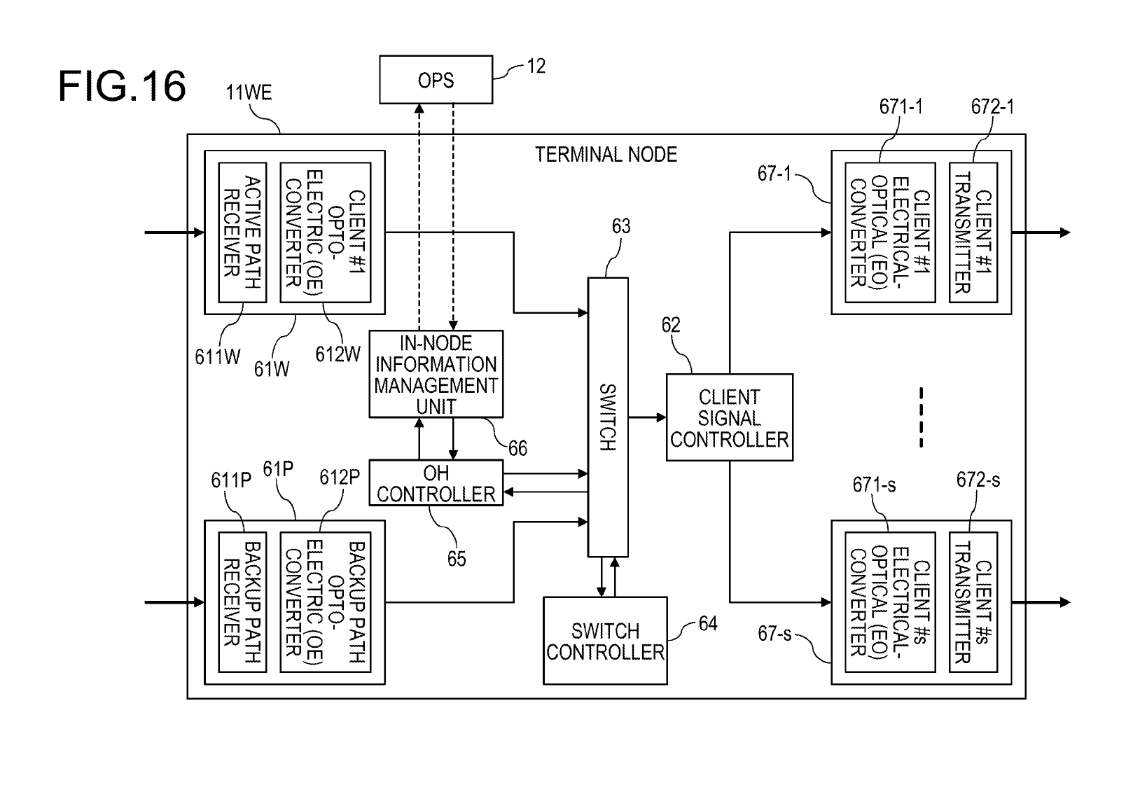

The active path #x transmitter 572-x transmits the OTN frame converted into the optical signal by the active path #x electrical-optical converter 571-x to an optical transmission line leading to the reception node 11 of the active path #x.

[Configuration Example of Reception Node: FIG. 16]

FIG. 16 is a block diagram illustrating a functional configuration example of the reception node 11WE of the active path #x. for example, the reception node 11WE exemplified in FIG. 16 may correspond to the reception node C or H of the active path #1 or #2 illustrated in FIGS. 3 to 5.

As illustrated in FIG. 16, for example, the reception node 11WE may include an active path reception IF 61W, and a backup path reception IF 61P. For example, the reception node 11WE may include a client signal controller 62, a switch 63, a switch controller 64, an OH controller 65, and an in-node information management unit 66.

The reception node 11WE may include a plurality of client signal transmission IFs 67-1 to 67-s. The symbol “s” is an integer of 2 or more, and represents the number of transmitted client signals. The number “s” of the transmitted client signals may be, for example, the same as the number “m” of received client signals (see, e.g., FIG. 13) (s=m).

For example, the active path reception IF 61W receives the OTN frame from the active path #x, and converts the OTN frame into an electrical signal.

Thus, the active path reception IF 61W may include, for example, an active path receiver 611W, and an active path opto-electric (OE) converter 612W.

The active path receiver 611W receives the OTN frame of the optical signal, from the active path #x. For example, the active path opto-electric converter 612W converts the OTN frame of the optical signal received by the active path receiver 611W, into the electrical signal. The OTN frame received from the active path #x, which is converted into the electrical signal, may be input to the switch 63.

For example, the backup path reception IF 61P may include a backup path receiver 611P, and a backup path opto-electric converter 612P.

For example, the backup path receiver 611P receives the OTN frame of the optical signal from the backup path. For example, the backup path opto-electric converter 612P converts the OTN frame of the optical signal received by the backup path receiver 611P, into an electrical signal. The OTN frame received from the backup path, which is converted into the electrical signal, may be input to the switch 63.

For example, according to the control by the switch controller 64, the switch 63 selectively outputs any one of the OTN frames received from the active path #x and the backup path to the client signal controller 62.

For example, when the active path #x is failed, an AIS is received and detected by the OH controller 65. According to the detection of the AIS, by the switch 63, the OTN frame received from the backup path may be selectively output to the client signal controller 62. While the AIS for the active path #x is not detected, by the switch 63, the OTN frame received from the active path #x may be selectively output to the client signal controller 62.

During the selective output by the switch 63, insertion or extraction of ODUk OH information may be performed by the OH controller 65.

For example, the OH controller 65 may insert OH information received from the in-node information management unit 66 in the ODUk OH, and output the OH information extracted from the ODUk OH to the in-node information management unit 66.

The in-node information management unit 66 manages, for example, OH information inserted or extracted as described above, signal priority information defining priorities of client signals, and setting information of an active path and a backup path. These node information may be set by, for example, the OPS 12.

For example, the client signal controller 62 demaps the client signal mapped into each TS of the OTN frame received from the switch 63, and outputs the demapped client signal to the corresponding client signal transmission IF 67-j.

Meanwhile, it may be considered that the client signal controller 62, the switch controller 64, the OH controller 65, and the in-node information management unit 66 constitute an example of a controller of the terminal node 11WE.

For example, the controller of the terminal node 11WE may be realized using a computing device having an arithmetic capacity such as, for example, a CPU or a DSP, or a storage medium such as, for example, a flash memory. For example, as for the controller of the terminal node 11WE, an IC, an LSI, an ASIC, or a FPGA may be used.

For example, the client signal transmission IF 67-j may convert the client signal of the electrical signal, which has been demapped by the client signal controller 62, into an optical signal, and transmit the converted optical signal to the client network.

Thus, the client signal transmission IF 67-j may include, for example, a client #j electrical-optical (EO) converter 671-j and a client #j transmitter 672-j.

For example, the client #j electrical-optical converter 671-j converts the client signal of the electrical signal received from the client signal controller 62 into the optical signal.

For example, the client #j transmitter 672-j transmits the client signal converted into the optical signal by the client #j electrical-optical converter 671-j, to the client network corresponding to the client #j.

### Second Embodiment

In the operation example of the first embodiment as described above, according to a failure occurrence or a non-occurrence in one or both of active paths #1 and #2, the client signals to be transmitted through a backup path are changed according to priorities (see, e.g., FIGS. 3 to 5). That is, in the first embodiment, low priority client signals may be transmitted through the backup path, for example, at the time of one system failure occurrence.

In the second embodiment, a policy of always transmitting high priority client signals through the backup path regardless of failure occurrence or non-occurrence of the active paths #1 and #2, without rescuing low priority client signals may be employed.

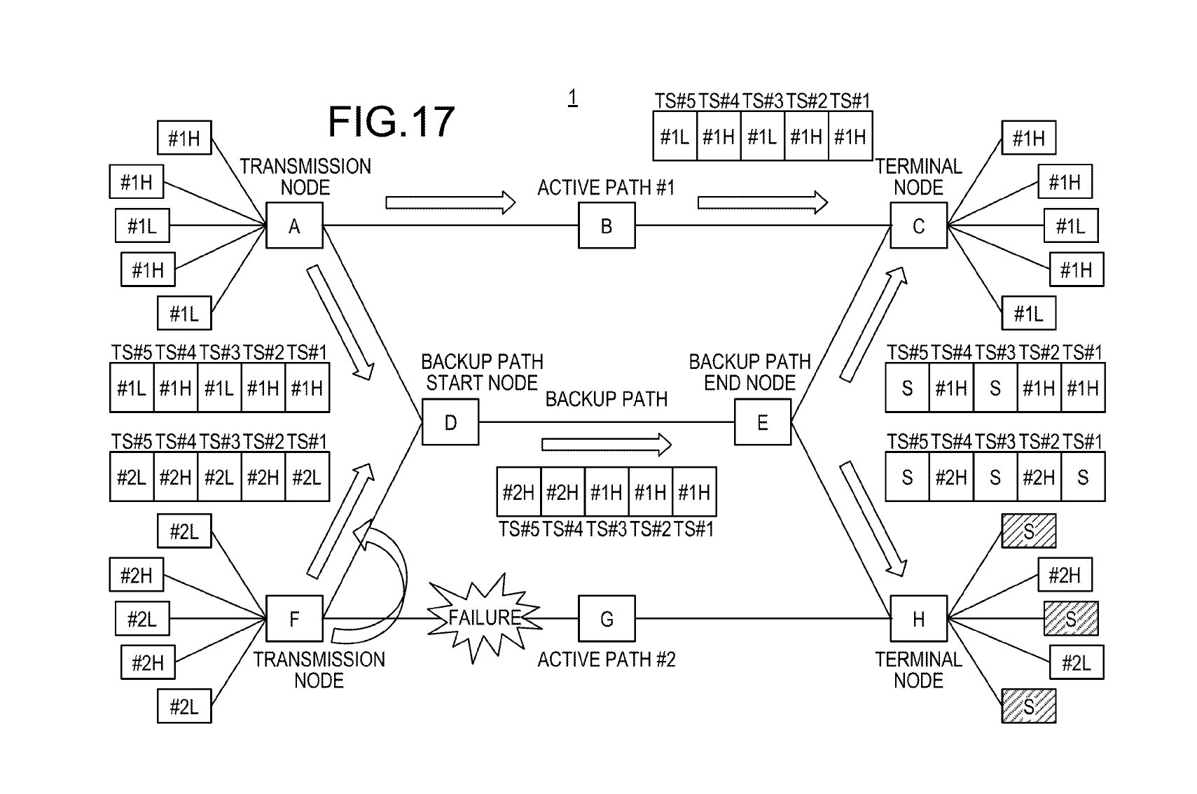

FIG. 17 illustrates an operation image of the second embodiment.

FIG. 17 is a drawing corresponding to FIG. 4 of the first embodiment. In the second embodiment, regardless of the failure occurrence or non-occurrence of the active paths #1 and #2, in the backup path end node E, high priority client signals “#1H” and “#2H” are received, and low priority client signals “#1L” and “#2L” are not received.

In such a situation, for example, as exemplified in FIG. 17, when the active path #2 is failed, the backup path end node E transmits high priority client signals “#1H” of the active path #1 to the reception node C of the active path #1, and transmits high priority client signals “#2H” of the active path #2 to the reception node H of the active path #2.

Here, the backup path end node E transmits squelches S indicating that it was not able to rescue low priority client signals to the respective reception nodes C and H of the active paths #1 and #2.

In the first embodiment, according to a failure occurrence of the active path #1 or #2, a processing of reallocating TSs allocated to low priority client signals, to high priority client signals is performed. In contrast, in the second embodiment, such a reallocation of TSs is not performed in the backup path end node E.

Therefore, the switching from the active path #1 or #2 to the backup path is completed by a processing of switching a path from which client signals are to be received by the reception node C or H, from the active path #1 or #2 to the backup path. Therefore, since reallocation of TSs is not necessary, a time for a processing of switching from the active path #1 or #2 to the backup path may be shortened.

Meanwhile, since it is set that the high priority client signals are always transmitted through the backup path, low priority client signals are not rescued even at the one system failure, unlike in the first embodiment.

The first embodiment in which TS allocation of the backup path is updated depending on signal priorities according to a failure occurrence situation, and the second embodiment in which TS allocation of high priority client signals is fixedly performed in the backup path regardless of a failure occurrence situation have merits and demerits. Any of policies of the first embodiment and the second embodiment may be properly selected and adopted by a network manager.

### Third Embodiment

In the first embodiment and the second embodiment as described above, descriptions have been made on the “1:2 protection” in which the number N of active paths is 2 (N=2), but the present embodiment may also be applied to “1:N protection” in which N is 3 or more. In the third embodiment, as a non-limiting example, an operation example of “1:4 protection” in which N is 4 in the network 1 will be described.

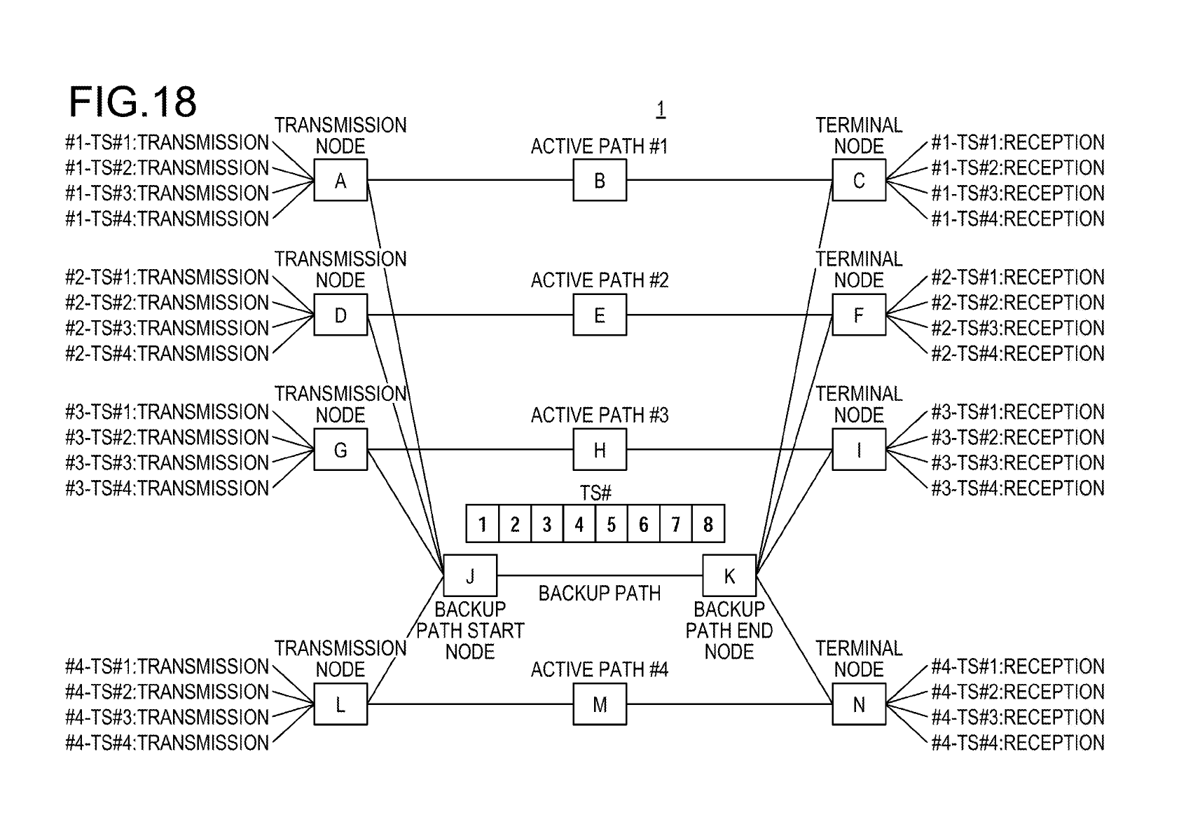

FIG. 18 is a block diagram illustrating an exemplary configuration of a network 1 according to a third embodiment, and corresponds to a drawing which simply illustrates the configuration of FIG. 1, for convenience of explanation. For example, in FIG. 18, a first active path #1 is set for a route of nodes A-B-C, and a second active path #2 is set for a route of nodes D-E-F. Also, a third active path #3 is set for a route of nodes G-H-I, and a fourth active path #4 is set for a route of nodes L-M-N.

Then, in FIG. 18, with respect to the active path #1, a backup path is set for a route of nodes A-J-K-C, and with respect to the active path #2, a backup path is set for a route of nodes D-J-K-F. With respect to the active path #3, a backup path is set for a route of nodes G-J-K-I, and with respect to the active path #4, a backup path is set for a route of nodes L-J-K-N.

Accordingly, the backup path between the nodes J and K is shared by the four active paths #1 to #4. Accordingly, the node J corresponds to a “backup path start node” and the node K corresponds to a “backup path end node.”

In FIG. 18, for convenience of explanation, it is assumed that in each of the active paths #1 to #4, four client signals are transmitted by TSs of an OTN frame. Also, it is assumed that, in the OTN frame transmitted through the backup path between the backup path start node J and the backup path end node K, eight empty TSs #1 to #8 are present.

According to an increase of the number of active paths, several aspects of TS conversion tables CTs and CTe provided in the backup path start node J and the backup path end node K, respectively, that is, several policies of client signals to be rescued by TS conversion rules, may be considered.

[First Aspect of TS Conversion Rule]

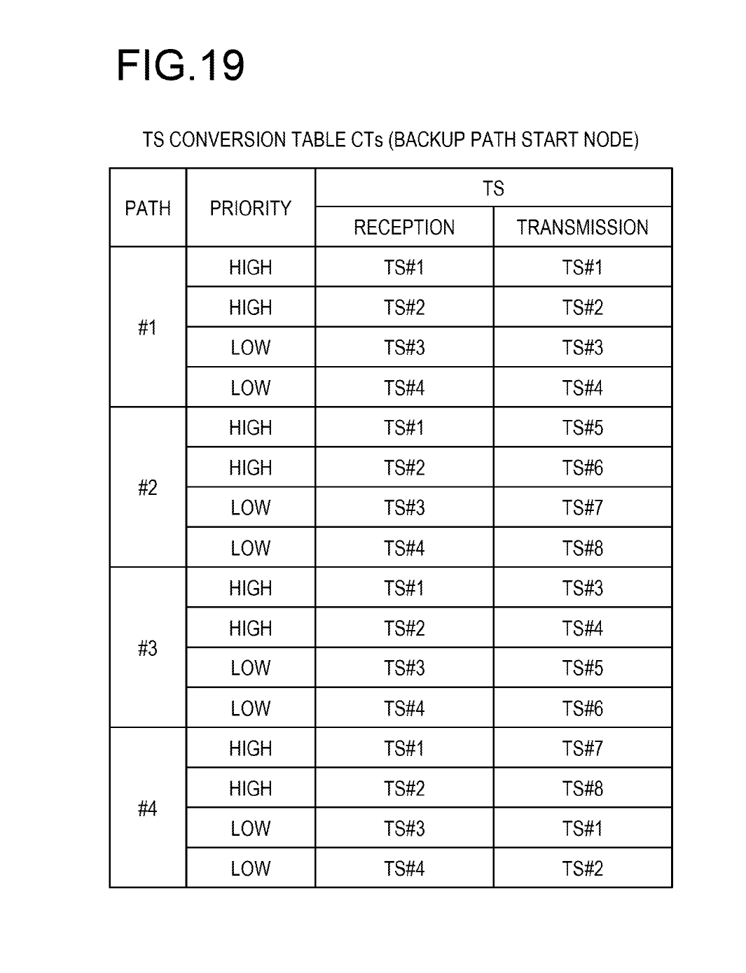

In the first aspect of a TS conversion rule, as in the first embodiment and the second embodiment, static TS conversion tables CTs and CTe are provided in the backup path start node J and the backup path end node K, respectively. FIG. 19 Illustrates an example of a TS conversion table CTs provided in the backup path start node J in the third embodiment.

In FIG. 19, in an OTN frame transmitted through each of the active paths #1 to #4, it is assumed that client signals are mapped into TSs #1 to #4 and transmitted. Also, it is assumed that in each of the active paths #1 to #4, “H” priority client signals are transmitted by TSs #1 and #2, and “L” priority client signals are transmitted by TSs #3 and #4

In the TS conversion table CTs exemplified in FIG. 19, the “H” priority client signal of the active path #1 received by a TS #1 is allocated to a transmission TS #1 among TSs #1 to #8 to be transmitted to the downstream node K of the backup path. The “H” priority client signal of the active path #1 received by a TS #2 is allocated to a TS #2 to be transmitted to the downstream node K of the backup path.

The “L” priority client signal of the active path #1 received by a TS #3 is allocated to a TS #3 to be transmitted to the downstream node K of the backup path. The “L” priority client signal of the active path #1 received by a TS #4 is allocated to a TS #4 to be transmitted to the downstream node K of the backup path.

Among client signals of the active path #2, for example, the “H” priority client signal received by a TS #1 is allocated to a TS #5 to be transmitted to the downstream node K of the backup path. The “H” priority client signal of the active path #2 received by a TS #2 is allocated to a TS #6 to be transmitted to the downstream node K of the backup path.

The “L” priority client signal of the active path #2 received by a TS #3 is allocated to a TS #7 to be transmitted to the downstream node K of the backup path. The “L” priority client signal of the active path #2 received by a TS #4 is allocated to a TS #8 to be transmitted to the downstream node K of the backup path.

Among client signals of the active path #3, for example, the “H” priority client signal received by a TS #1 is allocated to a TS #3 to be transmitted to the downstream node K of the backup path. The “H” priority client signal of the active path #3 received by a TS #2 is allocated to a TS #4 to be transmitted to the downstream node K of the backup path.

The “L” priority client signal of the active path #3 received by a TS #3 is allocated to a TS #5 to be transmitted to the downstream node K of the backup path. The “L” priority client signal of the active path #3 received by a TS #4 is allocated to a TS #6 to be transmitted to the downstream node K of the backup path.

Among client signals of the active path #4, for example, the “H” priority client signal received by a TS #1 is allocated to a TS #7 to be transmitted to the downstream node K of the backup path. The “H” priority client signal of the active path #4 received by a TS #2 is allocated to a TS #8 to be transmitted to the downstream node K of the backup path.

The “L” priority client signal of the active path #4 received by a TS #3 is allocated to a TS #1 to be transmitted to the downstream node K of the backup path. The “L” priority client signal of the active path #4 received by a TS #4 is allocated to a TS #2 to be transmitted to the downstream node K of the backup path.

Meanwhile, it may be considered that the TS conversion table CTe provided in the backup path end node K corresponds to a table in which “reception TS” and “transmission TS” of the TS conversion table CTs exemplified in FIG. 19 are exchanged with each other.

According to the TS conversion rule using the TS conversion tables CTs and CTe as described above, when any one of the active paths #1 to #4 is failed, all the client signals of a failed active path #x may be rescued regardless of signal priorities.

Also, even when two or more of the active paths #1 to #4 are failed, the transmission TSs allocated to “L” priority client signals are reallocated to “H” priority client signals, so as to securely rescue at least “H” priority client signals.

Meanwhile, when two or more active paths #x are failed, according to a combination of the failed active paths #x, “L” priority client signals that may be rescued are determined. For example, in the TS conversion table CTs of FIG. 19, when two active paths #1 and #2 are failed, the client signals of both “H” and “L” priorities may be rescued by eight TSs #1 to #8.

In contrast, for example, when three active paths #1 to #3 are failed, transmission TSs #5 and #6 are allocated to the “H” priority client signals of the active path #2. The transmission TSs #5 and #6 are also set to be allocated to the “L” priority client signals of the active path #3. However, since the rescue for the “H” priority client signals of the active path #2 is preferential, the “L” priority client signals of the active path #3 are not rescued.

Likewise, in other combinations, “L” priority client signals may be rescued by TSs that do not compete with transmission TSs to be allocated to “H” priority client signals, but are not be rescued by competing TSs.

[Second Aspect of TS Conversion Rule]

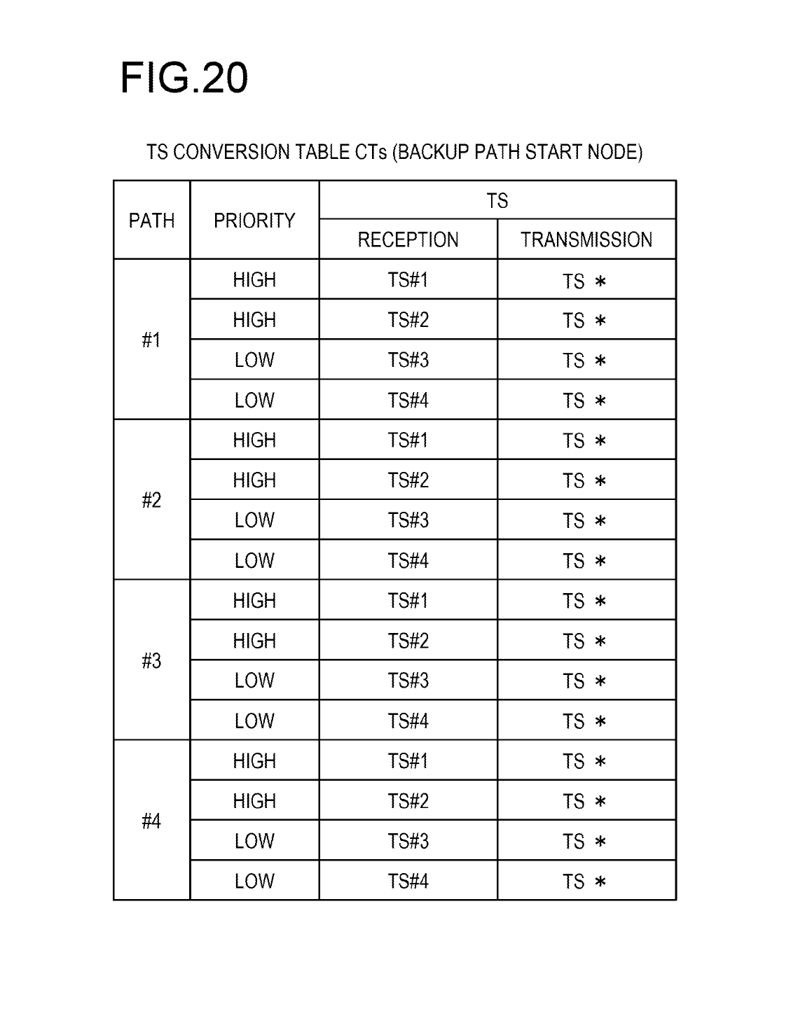

A second aspect of a TS conversion rule is an aspect in which a dynamic TS conversion rule is set for all client signals of active paths #1 to #4. For example, in the backup path start node J, a TS conversion table CTs as illustrated in FIG. 20 is provided.

Meanwhile, it may be considered that a TS conversion table CTe provided in the backup path end node K corresponds to a table in which “reception TS” and “transmission TS” of the TS conversion table CTs exemplified in FIG. 20 are exchanged with each other.

In FIG. 20, “TS*” indicates that a TS is unallocated because an active path #x is not failed. That is, just after the operation of the network 1 is initiated, client signals of any active path #x are not allocated to TSs #1 to #8 of a backup path.

When detecting a failure occurrence of any one active path #x, the backup path start node J searches for empty TSs of the backup path in the TS conversion table CTs, and allocates the empty TSs to signals sequentially starting from, for example, “H” priority client signals, thereby rescuing the signals.

When the empty TSs of the backup path are lost, the backup path start node J reallocates TSs so as to rescue high priority client signals. Accordingly, “L” priority client signals may not be rescued.

According to the dynamic TS conversion rule, regardless of a combination of the failed active paths #x, all client signals of a maximum of two failed active paths #x may be rescued. Also, the TSs to be allocated to the client signals may be flexibly changed depending on the failure occurrence situations of the active paths #x, and thus, the transmission band of the client signals may be efficiently utilized.

In the above-described dynamic TS conversion rule, entries of the TS conversion table CTs are not determined in advance. Thus, according to update of the TS conversion table CTs, the backup path start node J may notify the backup path end node K of information on the updated TS conversion table CTs.

For the notification of information on the TS conversion table CTs, an ODUk OH may be used. For example, the backup path start node J may set the information on the TS conversion table CTs in a reserve field of the ODUk OH.

When information on the TS conversion table CTs is not completely fit in a reserve field of an ODUk OH of one OTN frame, the information on the TS conversion table CTs may be set to be distributed to reserve fields of a plurality of OTN frames. That is, the notification of the information on the TS conversion table CTs may be performed using multi-frames of an OTN.

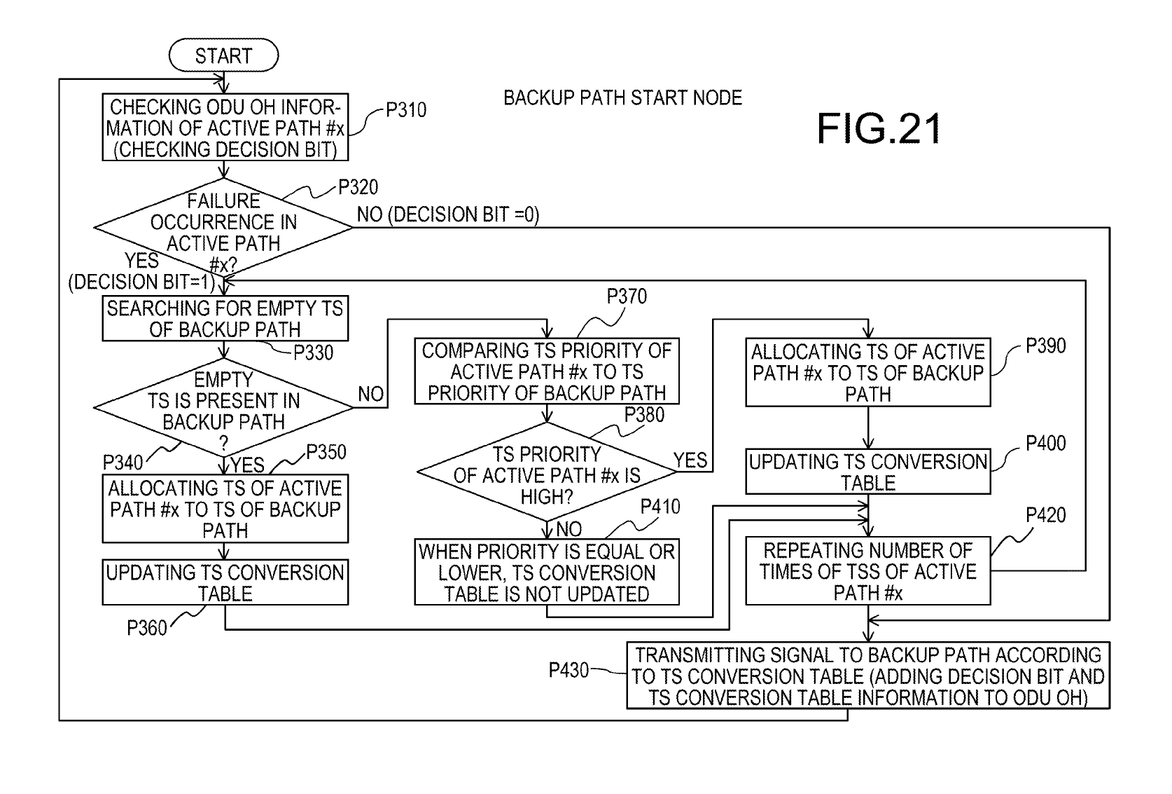

Hereinafter, descriptions will be made on an operation example of the network 1 based on the dynamic TS conversion rule with reference to FIGS. 21 to 32.

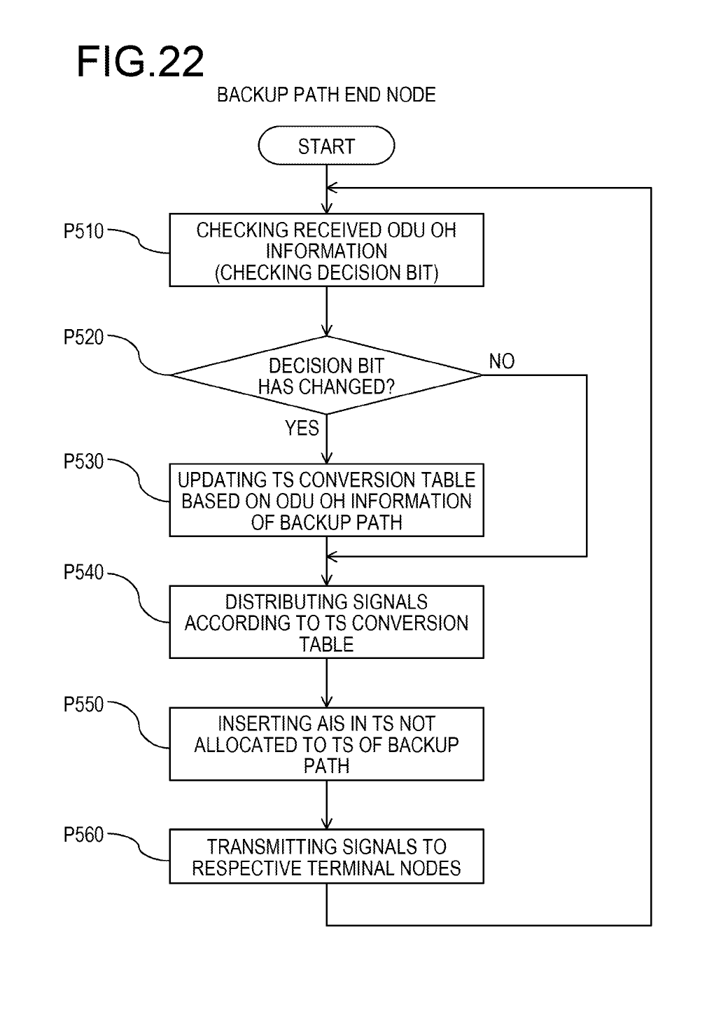

FIG. 21 is a flow chart illustrating an operation example of a backup path start node J that dynamically updates a TS conversion table, and FIG. 22 is a flow chart illustrating an operation example of a backup path end node K that dynamically updates a TS conversion table.

[Operation Example of Backup Path Start Node: FIG. 21]

As exemplified in FIG. 21, the backup path start node J checks a decision bit in an ODUk OH of an OTN frame transmitted by a transmission node A, D, G, or L of an active path #x, and determines whether or not the active path #x is failed (Operations P310 and 320).

When it is determined that the decision bit on the active path #x is 1 (YES in operation P320), the backup path start node J determines that the active path #x is failed, and searches for empty TSs of a backup path in the TS conversion table CTs exemplified in FIG. 20 (Operation P330).

When it is determined that empty TSs of the backup path are present (YES in Operation P340), the backup path start node J allocates the empty TSs to transmission TSs of client signals of the failed active path #x (operation P350), and updates the TS conversion table CTs (operation P360).

Meanwhile, when it is determined that the active path #x is failed but empty TSs are not present in the backup path (NO in Operation P340), the backup path start node J compares priorities of reception TSs of the active path #x, to priorities of allocated TSs to be transmitted to the backup path (operation P370).

As a result of comparison, when it is determined that there is a TS to be transmitted to the backup path which has a lower priority than a reception TS of the active path #x (YES in Operation P380), the transmission TS is reallocated to the transmission TS of the client signal received by the reception TS of the active path #x (operation P390). Accordingly, the TS conversion table CTs is updated (operation P400).

When it is determined that the priority of the reception TS of the active path #x is equal to or lower than the priority of the allocated TS to be transmitted to the backup path (NO in operation P380), the backup path start node J does not need to update the TS conversion table CTs (operation P410).

The operations P330 to 410 as described above are repeatedly performed in the backup path start node J the number of times corresponding to TSs for the active path #x (operation P420).

Then, according to the TS conversion table CTs, the backup path start node J transmits the client signals of the active path #x to the backup path (operation P430). Here, the backup path start node J may set a decision bit and information of the TS conversion table CTs in an ODUk OH to be transmitted to the backup path.

Meanwhile, in operation P320, when it is determined that the decision bit is 0 and the active path #x is not failed (NO), the backup path start node J may skip the above-described operations P330 to 420, and perform an operation P430.

As described above, according to the detection of a failure occurrence in any one active path #x, the backup path start node J may dynamically update the allocation of the transmission TSs of the backup path so as to preferentially rescue high priority client signals by the backup path.

[Operation Example of Backup Path End Node: FIG. 22]

Meanwhile, as exemplified in FIG. 22, the backup path end node K may check the decision bit in the ODUk OH information of the OTN frame received by the backup path, and determine whether or not the received decision bit has been changed (operations P510 and P520). For example, when the decision bit has been changed from 0 to 1, the backup path end node K may determine that the active path #x is failed.

When it is determined that the received decision bit has been changed (YES in operation P520), the backup path end node K may set and update a TS conversion table CTe based on the information of the TS conversion table CTs set in the ODUk OH information received by the backup path (operation P530).

Then, according to the TS conversion table CTe, the backup path end node K converts the respective reception TSs of the OTN frame received by the backup path, to the TSs to be transmitted to the reception node 11 (C, F, I, or N) of the active path #x, and rearranges the TSs (operation P540).

Meanwhile, in operation P520, when it is determined that the received decision bit has not been changed (NO), the backup path end node K does not update the TS conversion table CTe (skips operation P530), and may perform a rearrangement of the reception TSs (operation P540).

In the TSs to be transmitted to the reception node 11 of the active path #x, to which the client signals are not allocated through the rearrangement of the reception TSs, squelches (e.g., AISs) may be set and inserted in the backup path end node K (operation P550).

The backup path end node K transmits transmission TSs to which the client signals are allocated through TS conversion, and transmission TSs in which the squelches are inserted, to the reception node 11 of the corresponding active path #x (operation P560).

As described above, the backup path end node K may precisely convert arrangement of the client signals of the respective TSs rearranged according to the dynamic TS conversion rule in the backup path start node J, to original arrangement of the TSs, and transmit the client signals to the reception node 11 of the active path #x.

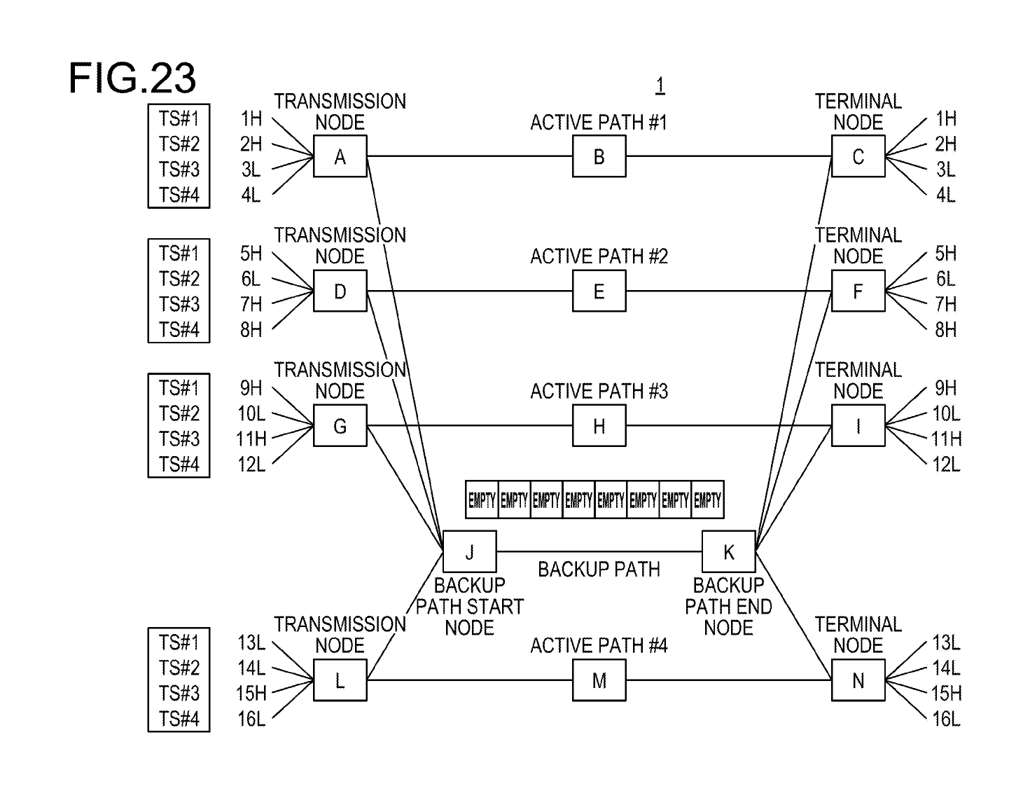

Also, through insertion of the squelches, the backup path end node K may notify the reception node 11 of the active path #x that it was not able to rescue the client signals of the active path #x by the backup path.

[Operation Example of Network Based on Dynamic TS Conversion Rule: FIGS. 23 to 32]

FIGS. 23 to 32 are views schematically illustrating operation examples of the network 1 focusing on dynamic TS allocation in a case of a normal operation at which no failure has occurred in any of four active paths #1 to #4, and in a case where the number of failed active paths #x is increased in a stepwise manner from 1 to 4.

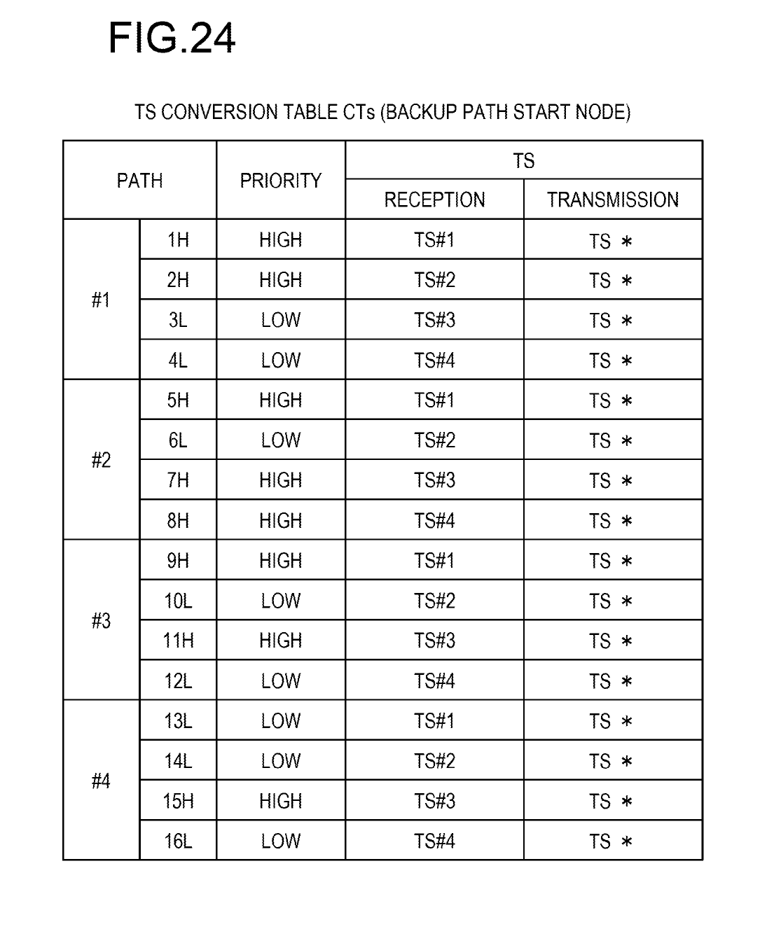

For example, FIG. 23 illustrates a state at the time of a normal operation at which no failure has occurred in any of four active paths #1 to #4, and FIG. 24 illustrates an example of an entry of a TS conversion table CTs in a backup path start node J at the time of normal operation.

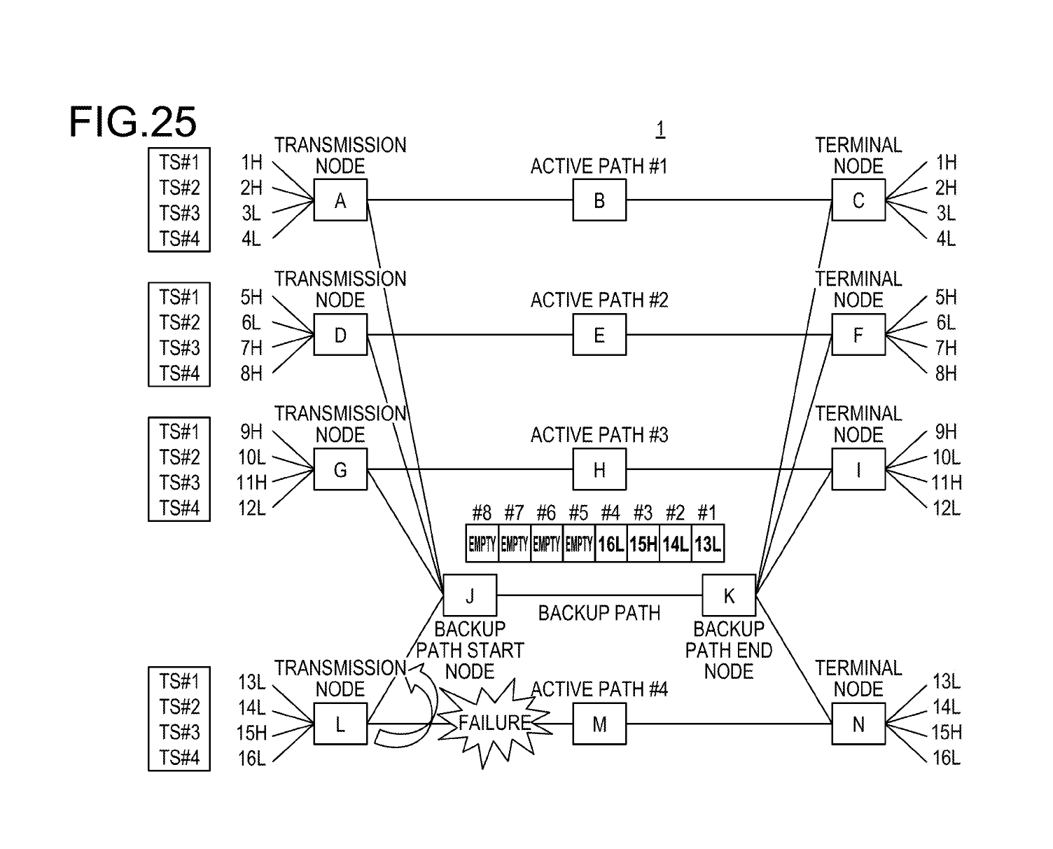

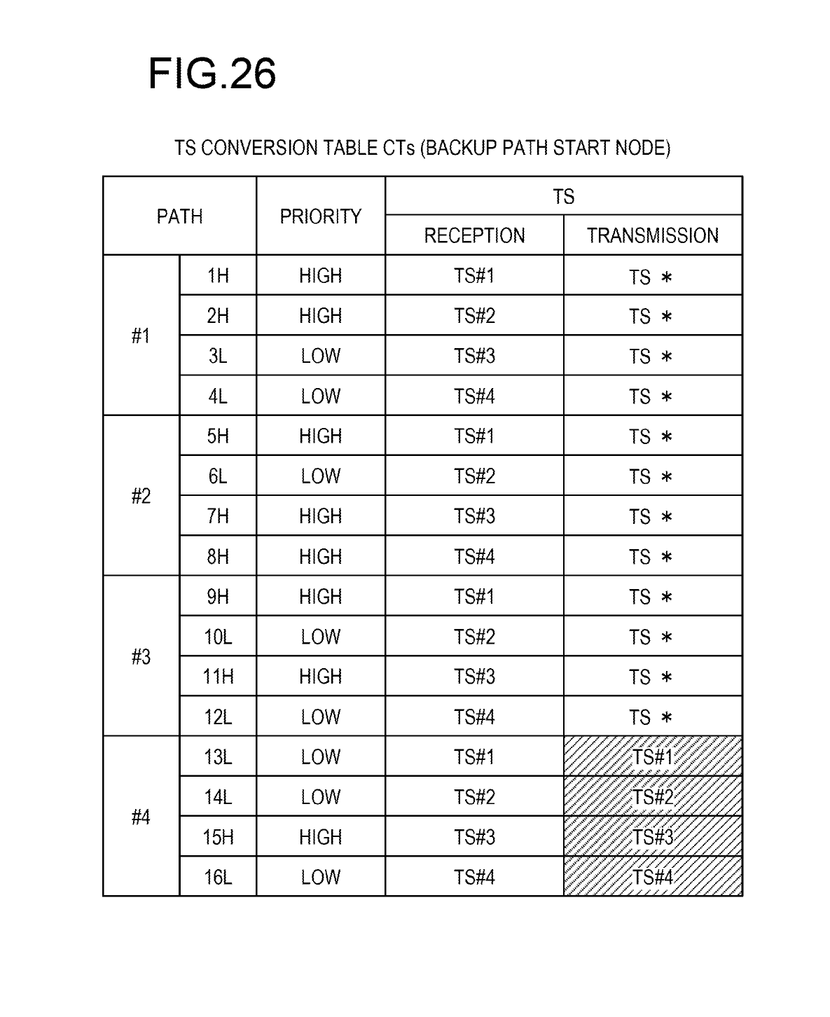

FIG. 25 illustrates a state at the time of a single failure at which one (active path #4) of four active paths #1 to #4 is failed, and FIG. 26 illustrates an example of an entry of a TS conversion table CTs in the backup path start node J at the time of single failure.

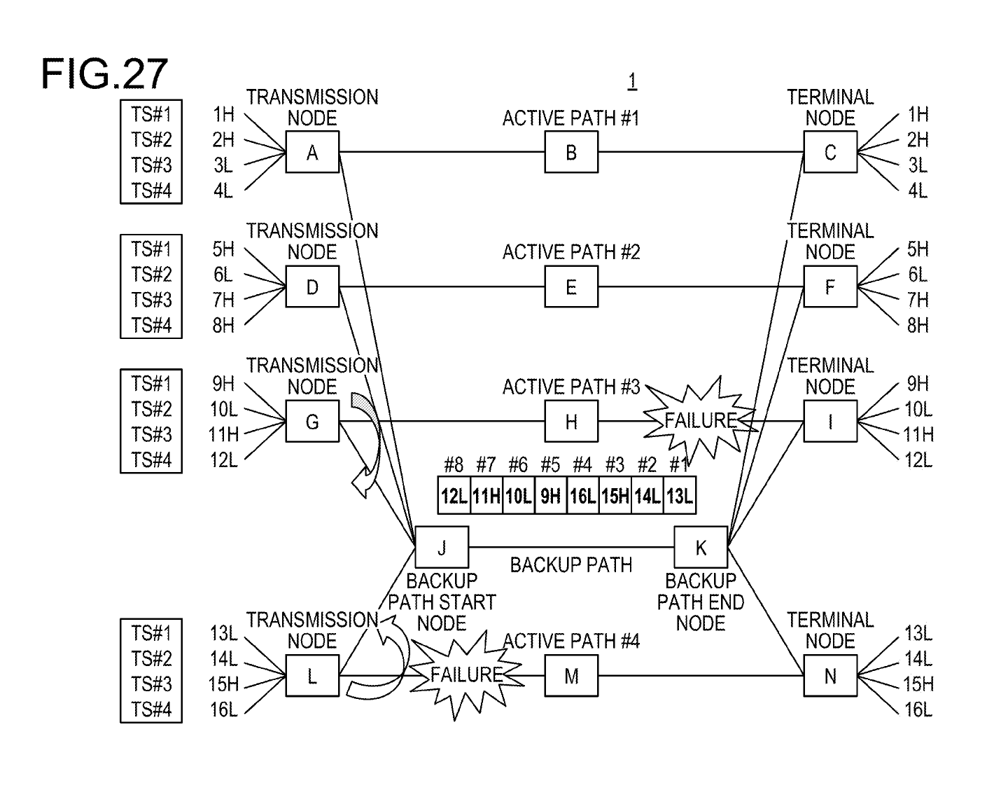

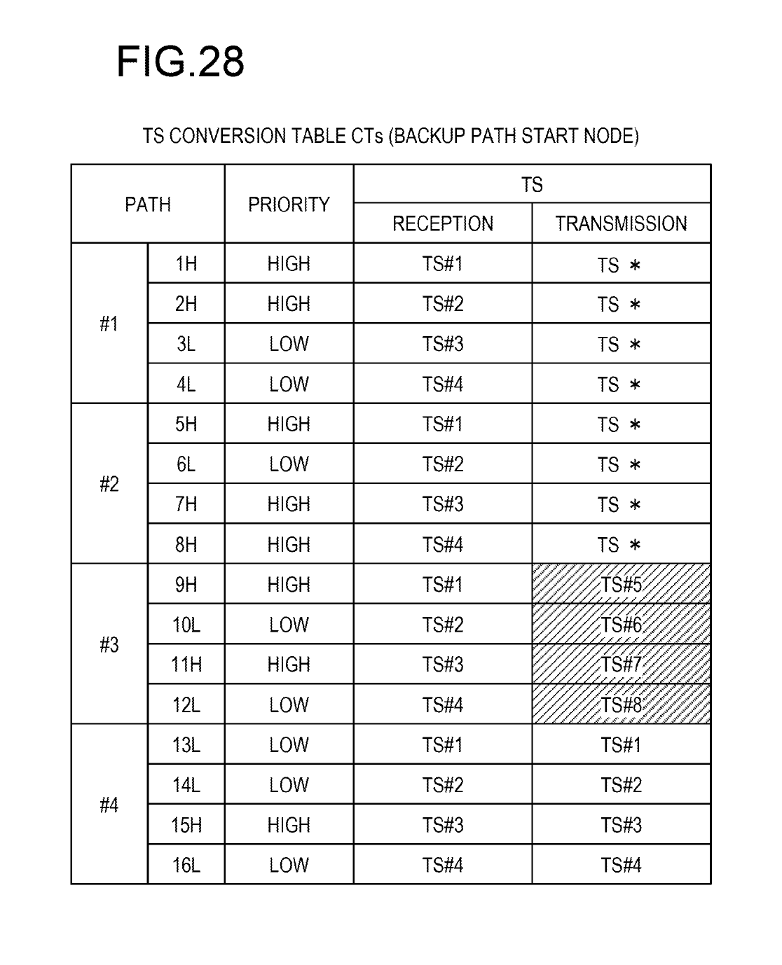

Further, FIG. 27 illustrates a state at the time of a double failure at which the active path #3 is also failed in addition to the state of the single failure of FIG. 25, and FIG. 28 illustrates an example of an entry of a TS conversion table CTs in the backup path start node J at the time of double failure.

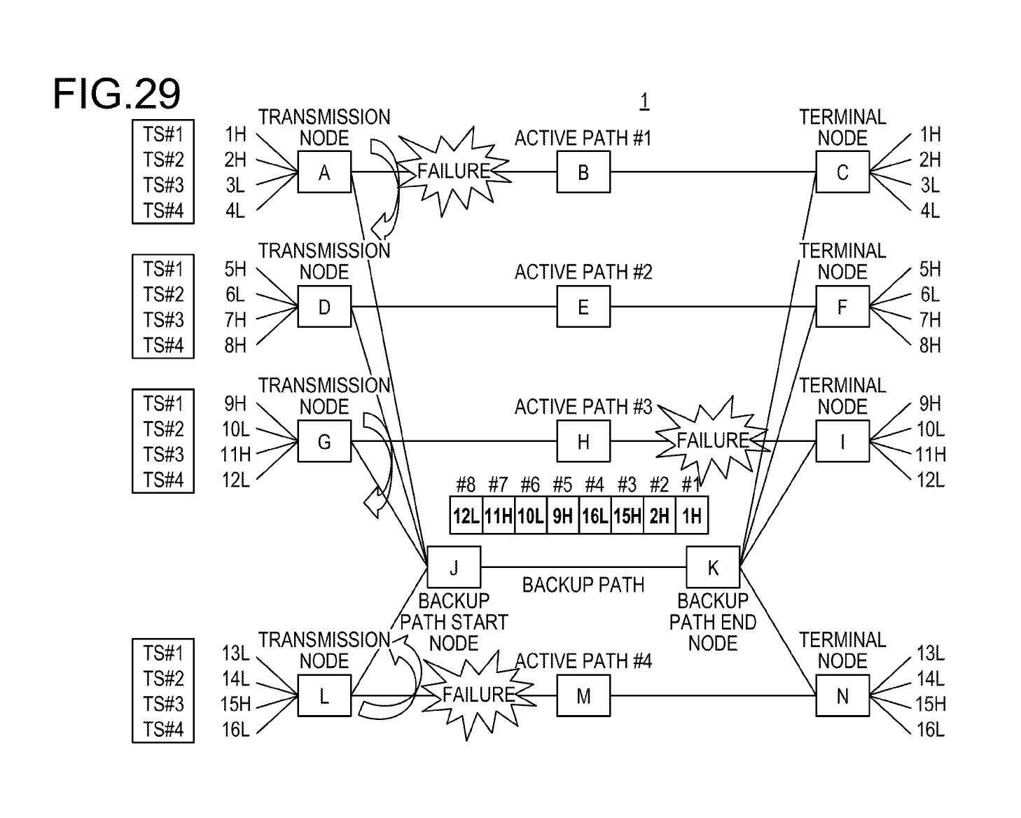

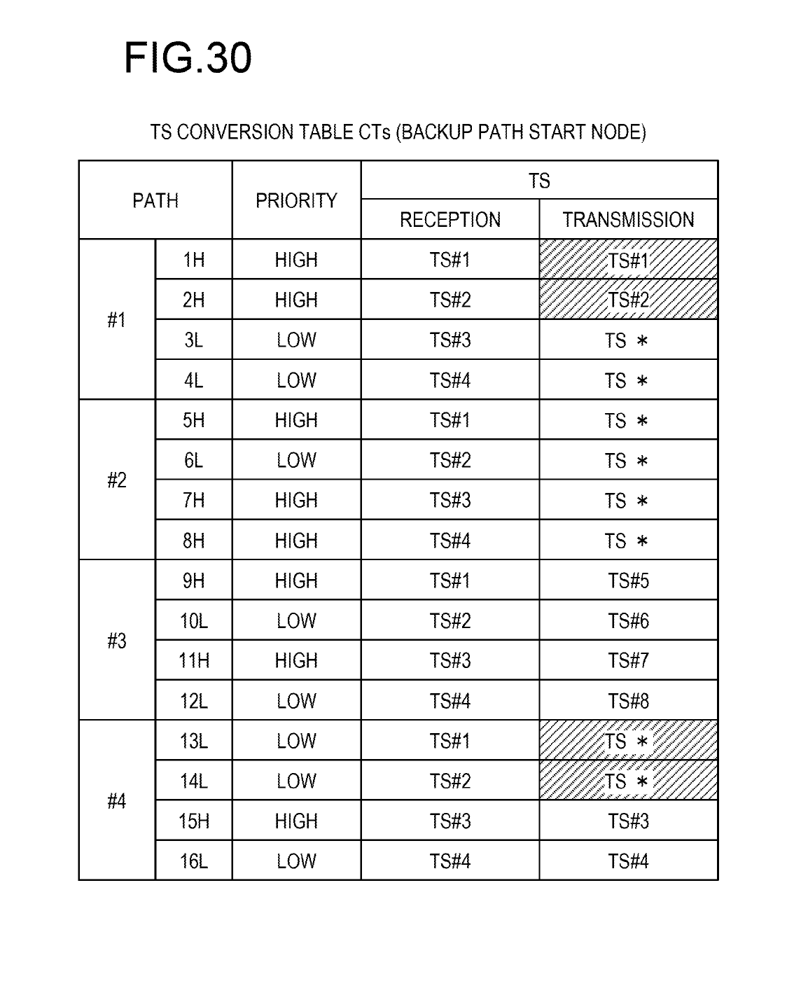

Also, FIG. 29 illustrates a state at the time of a triple failure at which the active path #1 is also failed in addition to the state of the double failure of FIG. 27, and FIG. 30 illustrates an example of an entry of a TS conversion table CTs in the backup path start node J at the time of triple failure.

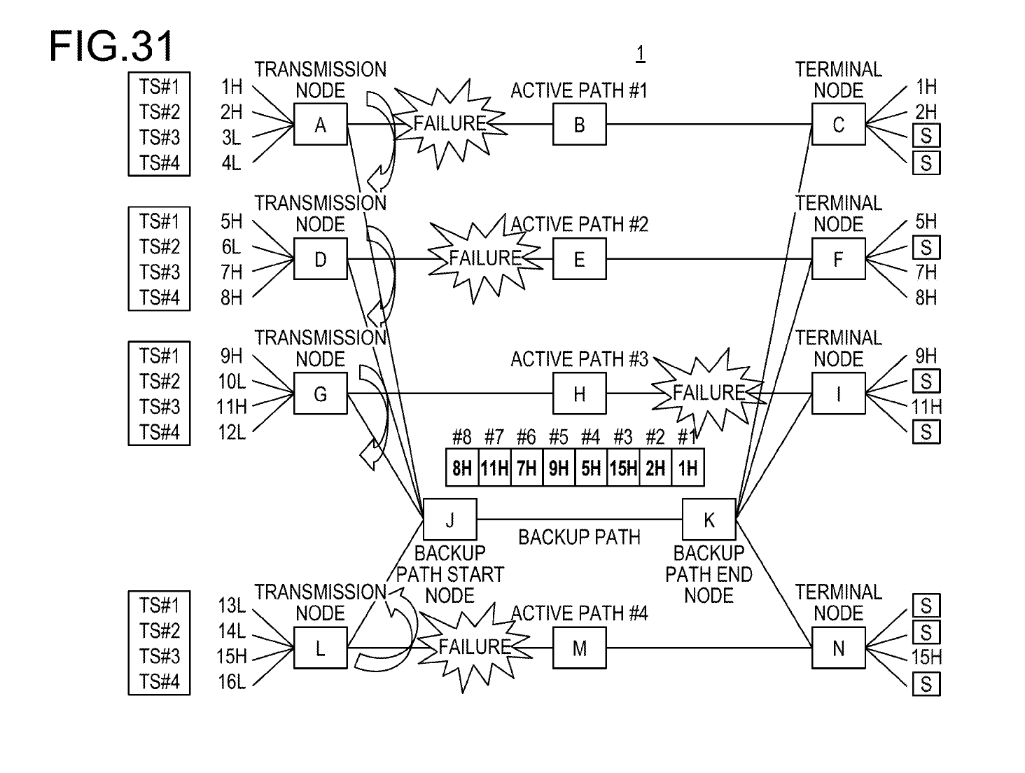

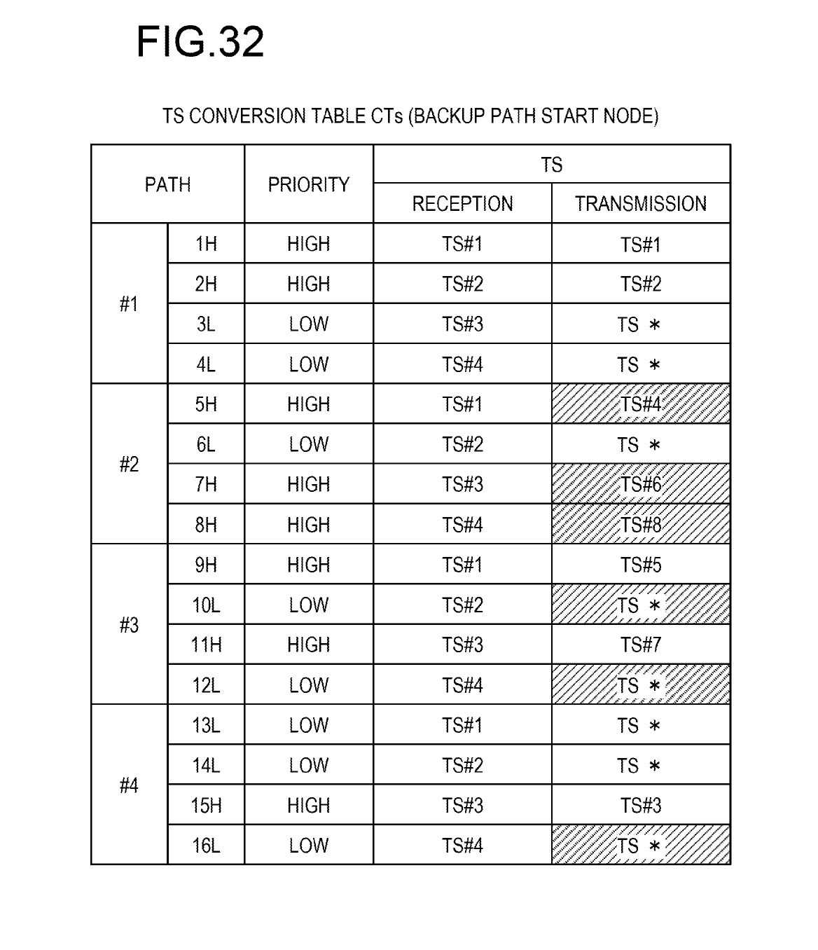

Also, FIG. 31 illustrates a state at the time of a quadruple failure at which the active path #2 is also failed in addition to the state of the triple failure of FIG. 29, that is, all the four active paths #1 to #4 are failed. FIG. 32 illustrates an example of an entry of a TS conversion table CTs in the backup path start node J at the time of quadruple failure.

Meanwhile, in FIGS. 23 to 32, it is assumed that in one active path #x, four client signals (a total of 16 client signals) are mapped into TSs #1 to #4 of an OTN frame, and transmitted. In FIGS. 23 to 32, sixteen client signals are assigned serial numbers “1 to 16” for convenience.

A label “H” is added to a serial number for a high priority client signal, and a label “L” is added to a serial number for a low priority client signal. For example, when attention is paid to the four client signals 1 to 4 transmitted through the active path #1, “1H” and “2H” represent high priority signals, and “3L” and “4L” represent low priority signals.

Likewise, when attention is paid to the four client signals 5 to 8 transmitted through the active path #2, “5H,” “7H,” and “8H” represent high priority signals, and “6L” represents a low priority signal.

When attention is paid to the four client signals 9 to 12 transmitted through the active path #3, “9H” and “11H” represent high priority signals, and “10L” and “12L” represent low priority signals.

When attention is paid to the four client signals 13 to 16 transmitted through the active path #4, “15H” represents a high priority signal, and “13L,” “14L,” and “16L” represent low priority signals.

Meanwhile, the number of client signals transmitted through the active path #x is not limited to the present example. In other active paths, an equal or different number of client signals may be transmitted.

[at the Time of Normal Operation: FIGS. 23 to 24]

As exemplified in FIG. 23, when no failure has occurred in any of the active paths #1 to #4, any of client signals of any active path #x does not need to be allocated to eight TSs in the backup path from the backup path start node J to the backup path end node K. That is, all transmission TSs of the backup path may be empty TSs.

Thus, as exemplified in FIG. 24, at the time of normal operation, all sixteen transmission TSs in the TS conversion table CTs of the backup path start node J may be placed in a state of unallocated “TS*.” In this case, through the backup path, no client signal has been transmitted.

[At the Time of Single Failure: FIGS. 25 and 26]

Then, as exemplified in FIG. 25, it is assumed that the active path #4 has been failed, and the backup path start node J has detected the failure occurrence of the active path #4 based on the decision bit of an ODUk OH received from the transmission node L of the active path #4.

In this case, the backup path start node J searches for empty TSs in the TS conversion table CTs exemplified in FIG. 24, and allocates the client signals “13L,” “14L,” “15H,” and “16L” of the active path #4 to four transmission TSs.

For example, as illustrated in FIG. 26, in the TS conversion table CTs, the four transmission TSs #1 to #4 of the backup path are allocated to the client signals “13L,” “14L,” “15H,” and “16L” of the active path #4, respectively.

In the present example, the client signals of the active path #4 are allocated to the four TSs #1 to #4 among the eight empty TSs #1 to #8, and thus, as exemplified in FIG. 25, in the backup path, all client signals of the active path #4 are transmitted. Accordingly, all client signals of the failed active path #4 may be rescued by the backup path.

[At the Time of Double Failure: FIGS. 27 and 28]

Then, as exemplified in FIG. 27, it is assumed that the active path #3 is also failed, in addition to the active path #4.

When detecting the failure occurrence of the active path #3 by the decision bit, the backup path start node J searches for empty TSs of the backup path in the TS conversion table CTs.

In the present example, since TSs #5 to #8 are empty TSs, for example, as illustrated in FIG. 28, the backup path start node J may allocate the empty TSs #5 to #8 to the client signals “9H,” “10L,” “11H,” and “12L” of the failed active path #3, respectively.

Accordingly, as exemplified in FIG. 27, in the backup path, all client signals of the active paths #4 and #3 are transmitted. Accordingly, all client signals of the failed active paths #4 and #3 may be rescued by the backup path.

[At the Time of Triple Failure: FIGS. 29 to 30]

Then, in the state of FIG. 27, as exemplified in FIG. 29, it is assumed that the active path #1 is also failed, in addition to the active paths #4 and #3.

When detecting the failure occurrence of the active path #1 by the decision bit, the backup path start node J searches for empty TSs of the backup path in the TS conversion table CTs.

In the present example, since no empty TS is present, priorities of the client signals allocated to the TSs #1 to #8 are compared to priorities of the client signals of the failed active path #1 in the backup path start node J.

As a result of comparison, when there is a TS allocated to a client signal having a lower priority than a high priority client signal of the failed active path #1, the backup path start node J may allocate the TS to the high priority client signal of the active path #1.

As a non-limiting example, as illustrated in FIG. 30, the TS #1 allocated to the low priority client signal “13L” of the active path #4 in FIG. 28 may be reallocated to the high priority client signal “1H” of the active path #1.

Also, the TS #2 allocated to the low priority client signal “14L” of the active path #4 in FIG. 28 may be reallocated to the high priority client signal “2H” of the active path #1.

By the reallocation of TSs, the TSs of the backup path may not be allocated to both the low priority client signals “13L,” and “14L” of the active path #4. Meanwhile, the example of FIG. 30 is an example in which TS reallocation is performed in an ascending order.

Meanwhile, the TS reallocation may be performed in a descending order. For example, the TSs #8 and #6 allocated to the low priority client signals “12L” and “10L” of the active path #3 may be reallocated to the high priority client signals “1H” and “2H” of the active path #1.

By the TS reallocation exemplified in FIG. 30, the client signals transmitted by the TSs #1 to #8 of the backup path as exemplified in FIG. 29 are as follows.

TS #1: The high priority client signal “1H” of the active path #1

TS #2: The high priority client signal “2H” of the active path #1

TS #3: The high priority client signal “15H” of the active path #4

TS #4: The low priority client signal “16L” of the active path #4

TS #5: The high priority client signal “9H” of the active path #3

TS #6: The low priority client signal “10L” of the active path #3

TS #7: The high priority client signal “11H” of the active path #3

TS #8: The low priority client signal “12L” of the active path #3

Accordingly, all high priority client signals of the failed active paths #1, #3, and #4 are rescued by the backup path.

Also, in the present example, the two low priority client signals “10L” and “12L” of the active path #3 are also rescued by the backup path. Accordingly, for the active path #3, all client signals may be rescued by the backup path. For the active path #4, one low priority client signal “16L” is rescued by the backup path.

In FIG. 30, TSs of the backup path are not allocated to the two low priority client signals “3L” and “4L” of the active path #1, and the two low priority client signals “13L” and “14L” of the active path #4.

Accordingly, these four client signals may not be rescued by the backup path. As exemplified in FIG. 29, the backup path start node J may set squelches S (e.g., AISs) in TSs to be transmitted to the reception nodes C and N of the active paths #1 and #4 corresponding to the client signals not rescued by the backup path.

Accordingly, each of the reception nodes C and N of the active paths #1 and #4 may notify the client network through the AISs that two client signals have not been rescued.

Meanwhile, when a priority of the client signal allocated to the backup path is equal to a priority of the client signal of the failed active path #1, the backup path start node J may transmit the signals previously allocated to the backup path without performing the TS reallocation.

[At the Time of Quadruple Failure: FIGS. 31 and 32]

Then, in the state of FIG. 29, as exemplified in FIG. 31, it is assumed that the active path #2 is also failed, in addition to the active paths #4, #3, and #1, and thus, all active paths #1 to #4 are failed.

When detecting the failure occurrence of the active path #2 by the decision bit, the backup path start node J searches for empty TSs of the backup path in the TS conversion table CTs.

In the present example, since no empty TS is present, priorities of the client signals allocated to the TSs #1 to #8 are compared to priorities of the client signals of the failed active path #2, in the backup path start node J.

As a result of comparison, when there is a TS allocated to a client signal having a lower priority than a high priority client signal of the failed active path #2, the backup path start node J may allocate the TS to the high priority client signal of the active path #2.

As a non-limiting example, as illustrated in FIG. 32, the TS #4 allocated to the low priority client signal “16L” of the active path #4 in FIG. 30 may be reallocated to a high priority client signal “5H” of the active path #2.

Also, the TSs #6 and #8 allocated to the low priority client signals “10L” and “12L” of the active path #3 in FIG. 30 may be reallocated to high priority client signals “7H” and “8H” of the active path #2.

By the reallocation of TSs, the TSs of the backup path may not be allocated to all of the low priority client signal “16L” of the active path #4, and the low priority client signals “10L” and “12L” of the active path #3.

By the TS reallocation exemplified in FIG. 32, the client signals transmitted by the TSs #1 to #8 of the backup path as exemplified in FIG. 31 are as follows.

TS #1: The high priority client signal “1H” of the active path #1

TS #2: The high priority client signal “2H” of the active path #1

TS #3: The high priority client signal “15H” of the active path #4

TS #4: The high priority client signal “5H” of the active path #2

TS #5: The high priority client signal “9H” of the active path #3

TS #6: The high priority client signal “7H” of the active path #2

TS #7: The high priority client signal “11H” of the active path #3

TS #8: The high priority client signal “8H” of the active path #2

Accordingly, all high priority client signals of all the failed active paths #1 to #4 are rescued by the backup path.

In the present example, TSs of the backup path are not allocated to all the eight low priority client signals of the active paths #1 to #4. Therefore, all the eight low priority client signals are not rescued by the backup path.

as exemplified in FIG. 31, the backup path start node J may set squelches S (e.g., AISs) in TSs to be transmitted to the reception nodes C, F, I, and N of the active paths #1 to #4 corresponding to the respective eight client signals not rescued by the backup path.

Accordingly, each of the reception nodes C, F, I, and N of the active paths #1 to #4 may notify a client network through the AISs that low priority client signals have not been rescued.

Meanwhile, a TS conversion table CTe of the backup path end node K, which corresponds to the TS conversion table CTs exemplified in each of FIGS. 24, 26, 28, 30, and 32, corresponds to a table in which “reception TS” and “transmission TS” of the TS conversion table CTs are exchanged with each other.

Whenever the TS conversion table CTs exemplified in FIGS. 24, 26, 28, 30, and 32 is updated, the information on the TS conversion table CTs may be notified by, for example, an ODUk OH of the backup path, to the backup path end node K from the backup path start node J.

[Third Aspect of TS Conversion Rule]

In the above-described second aspect, the backup path start node J searches for available TSs in the TS conversion table CTs, and thus, a path conversion time may be delayed according to an increase of the total number of TSs.

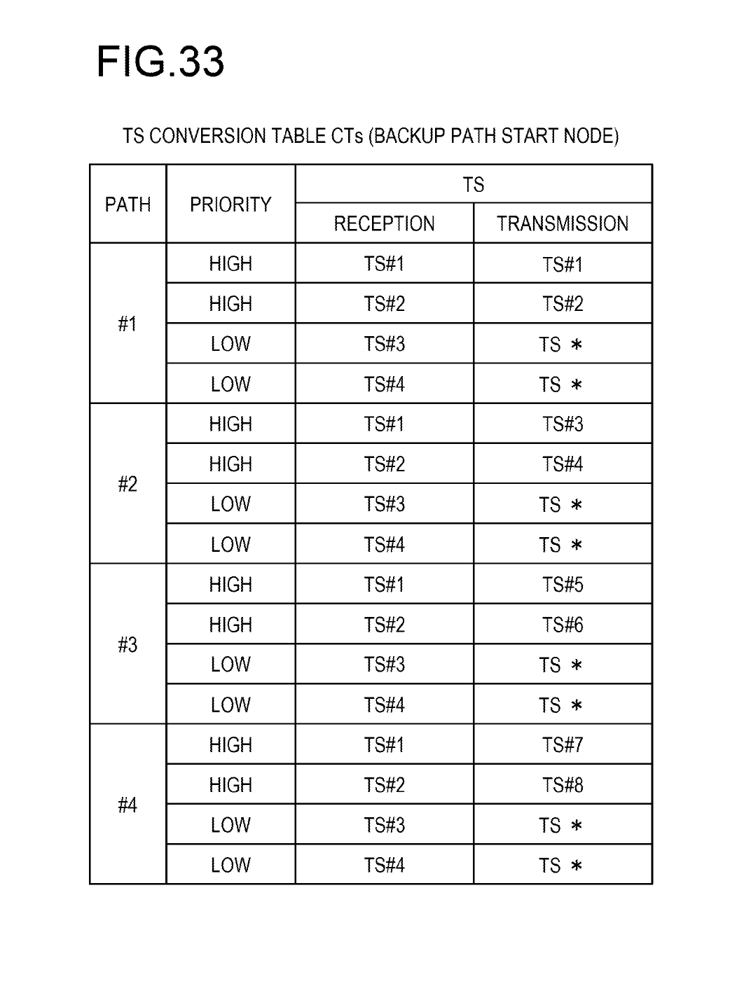

Therefore, for example, as illustrated in FIG. 33, the TS conversion table CTs may be set such that TSs of a backup path may be statically allocated to high priority client signals, and TSs may be dynamically allocated to low priority client signals, as in the second aspect. For example, in FIG. 33, “TS*” indicates that a TS of the backup path is not allocated to a low priority client signal.

The third aspect is placed at an intermediate position between the first aspect and the second aspect. In the third aspect, in the backup path start node J, for high priority client signals, it is no need to search for empty TSs of the backup path.

Thus, even when the total number of TSs of the backup path is increased, a TS search time is expected to be shortened, and further a path conversion time is expected to be shortened, as compared to the second aspect.

For low priority client signals, based on a failure occurrence situation of an active path #x, and a usage situation of TSs of the backup path, TSs to be allocated may be determined. Meanwhile, in the third aspect, as in the second aspect, according to the TS conversion table CTs exemplified in FIG. 33, all client signals of a maximum of two failed active paths #x may be rescued.

Also, in the third aspect, as in the second aspect, the information on the TS conversion table CTs may be notified by an ODUk OH of the backup path to the backup path end node K from the backup path start node J.

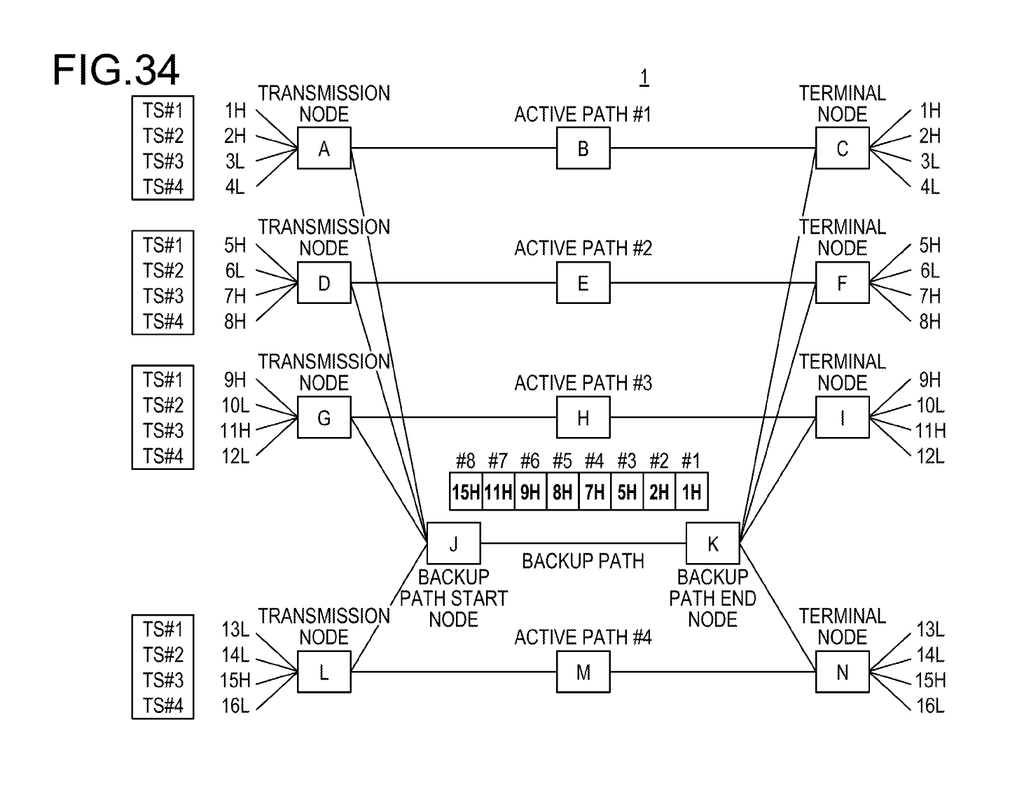

Based on the notified information on the TS conversion table CTs, the backup path end node K may set and update a TS conversion table CTe corresponding to the TS conversion table CTs. The TS conversion table CTe in the backup path end node K corresponds to a table in which “reception TS” and “transmission TS” of the TS conversion table CTs exemplified in FIG. 33 are exchanged with each other.

[Operation Example of Network Based on Partially Dynamic TS Conversion Rule: FIGS. 34 to 39]

Hereinafter, descriptions will be made on an operation example of a third aspect with reference to FIGS. 34 to 39. FIGS. 34 to 39 are views schematically illustrating operation examples of the network 1 focusing on TS allocation in a case of a normal operation at which no failure has occurred in any of four active paths #1 to #4, and in a case where the number of failed active paths #x is increased in a stepwise manner from 1 to 2.

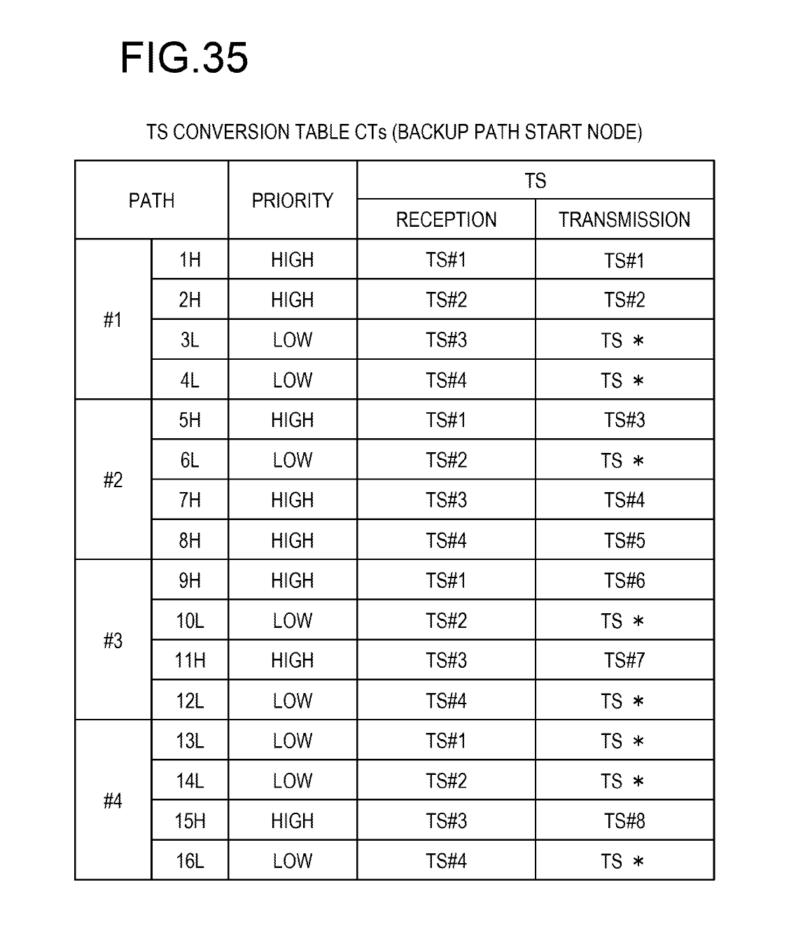

In FIGS. 34 to 39, the number of client signals transmitted through each of the active paths #1 to #4 is the same as that of the second aspect, and a notation for each client signal according to a priority is also the same as that of the second aspect.

[At the Time of Normal Operation: FIGS. 34 and 35]

As exemplified in FIG. 34, when no failure has occurred in any of the active paths #1 to #4, in a default setting, high priority client signals of the active paths #1 to #4 may be allocated to the TSs #1 to #8 of the backup path, respectively.

For example, in the TS conversion table CTs illustrated in FIG. 35, the client signals allocated to the transmission TSs #1 to #8 of the backup path are as follows.

TS #1: The high priority client signal “1H” of the active path #1

TS #2: The high priority client signal “2H” of the active path #1

TS #3: The high priority client signal “5H” of the active path #2

TS #4: The high priority client signal “7H” of the active path #2

TS #5: The high priority client signal “8H” of the active path #2

TS #6: The high priority client signal “9H” of the active path #3

TS #7: The high priority client signal “11H” of the active path #3

TS #8: The high priority client signal “15H” of the active path #4

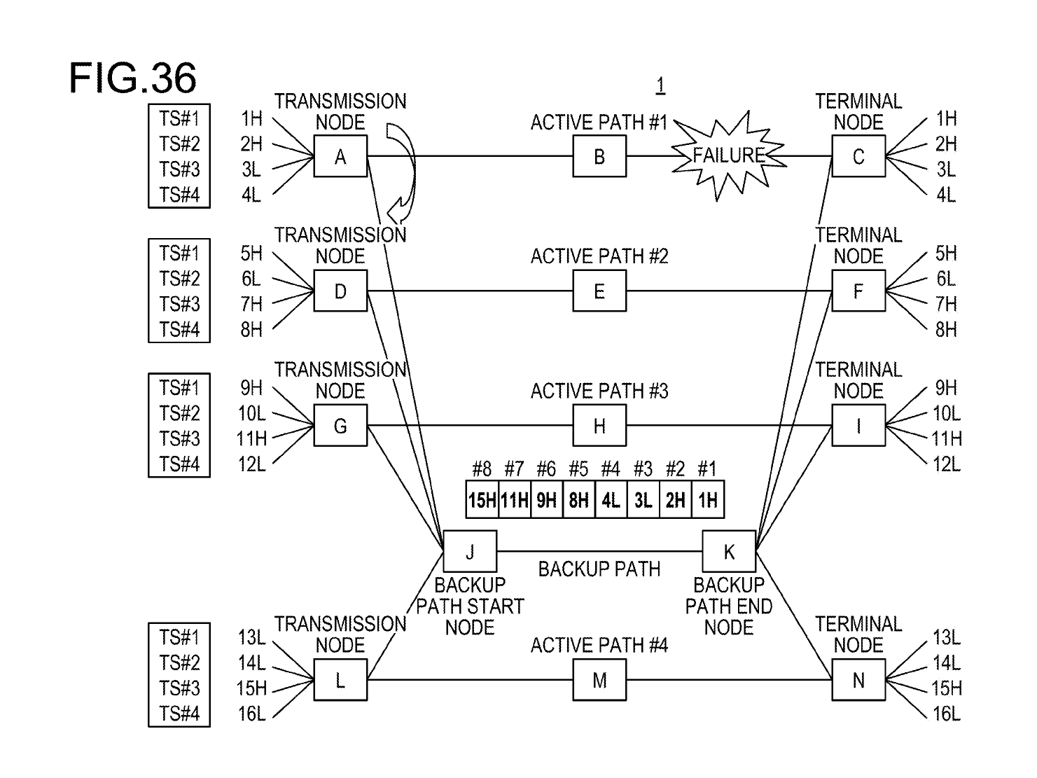

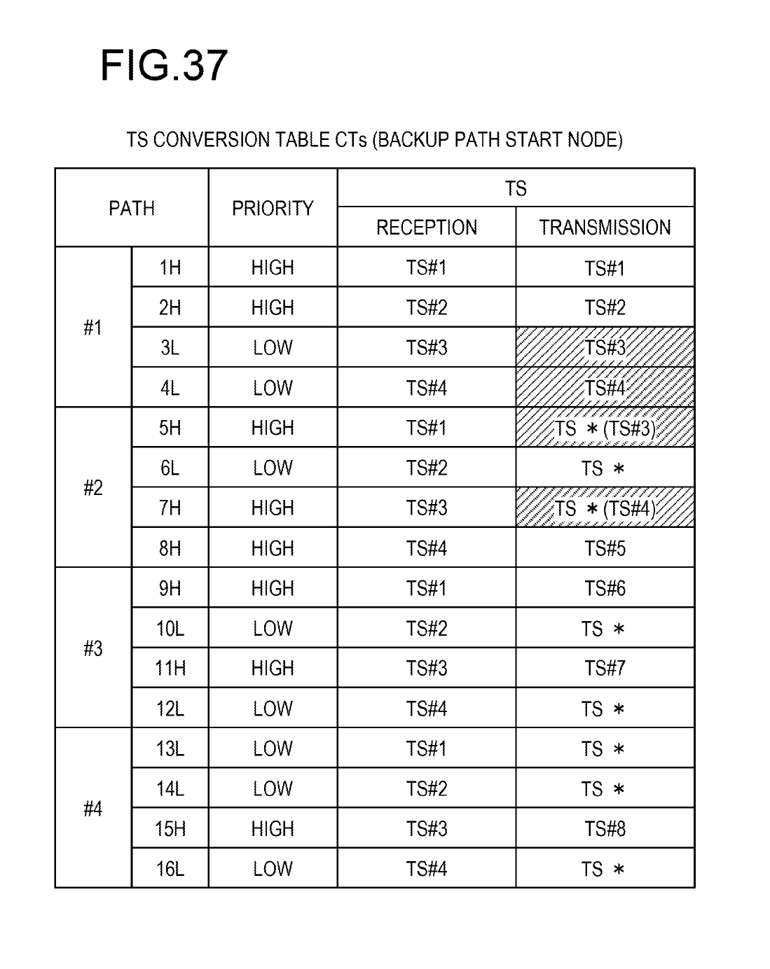

Then, as exemplified in FIG. 35, at the time of normal operation, all remaining eight transmission TSs in the TS conversion table CTs may be placed in a state of unallocated “TS*.”

[At the Time of Single Failure: FIGS. 36 and 37]

Then, as exemplified in FIG. 36, it is assumed that the active path #1 has been failed, and the backup path start node J has detected the failure occurrence of the active path #1 based on the decision bit of an ODUk OH received from the transmission node A of the active path #1.

Here, the high priority client signals of the active paths #1 to #4 are allocated by default to the TSs #1 to #8 of the backup path, respectively, and thus there is no empty TS in the backup path.

However, when another active path #x which is not failed is present, any one of TSs allocated by default to high priority client signals of the active path #x may be temporarily allocated to a low priority client signal of the failed active path #1.

For example, based on the decision bit, the backup path start node J detects the active path #x which is not failed, and specifies TSs of the backup path allocated by default to the high priority client signals of the active path #x, in the TS conversion table CTs.

The specified TSs are TS candidates that may be used to rescue low priority client signals “3L” and “4L” of the failed active path #1.

The backup path start node J may temporarily allocate any one TS among the TS candidates to the low priority client signal “3L” or “4L” of the failed active path #1.

That is, the TSs of the backup path to which the high priority client signals are allocated by default, may be temporarily reallocated to the low priority client signals of the failed active path #x. Since the allocation is “temporary,” the default setting of the TS allocation may be maintained in, for example, the TS conversion table CTs.

A selection of any TS to be temporarily allocated, among the TS candidates, may be determined in, for example, an ascending order. Also, the selection may be determined in a descending order.

As a non-limiting example of determination by the ascending order, as exemplified in FIG. 37, the TS #3 allocated to the high priority client signal “5H” of the active path #2 may be temporarily allocated to the low priority client signal “3L” of the active path #1.

The TS #4 allocated to the high priority client signal “7H” of the active path #2 may be temporarily allocated to the low priority client signal “4L” of the active path #1.

Accordingly, as exemplified in FIG. 36, by the TSs #1 to #4 of the backup path, the high priority client signals “1H” and “2H” of the active path #1, and the low priority client signals “3L” and “4L” of the active path #1 are transmitted.

Accordingly, all (four) client signals of the failed active path #1 may be rescued by the backup path.

Meanwhile, according to a failure restoration of the active path #1, the backup path start node J may release the temporary allocation of the TSs #3 and #4 to the low priority client signals “3L” and “4L,” and return the TS allocation to the default setting.

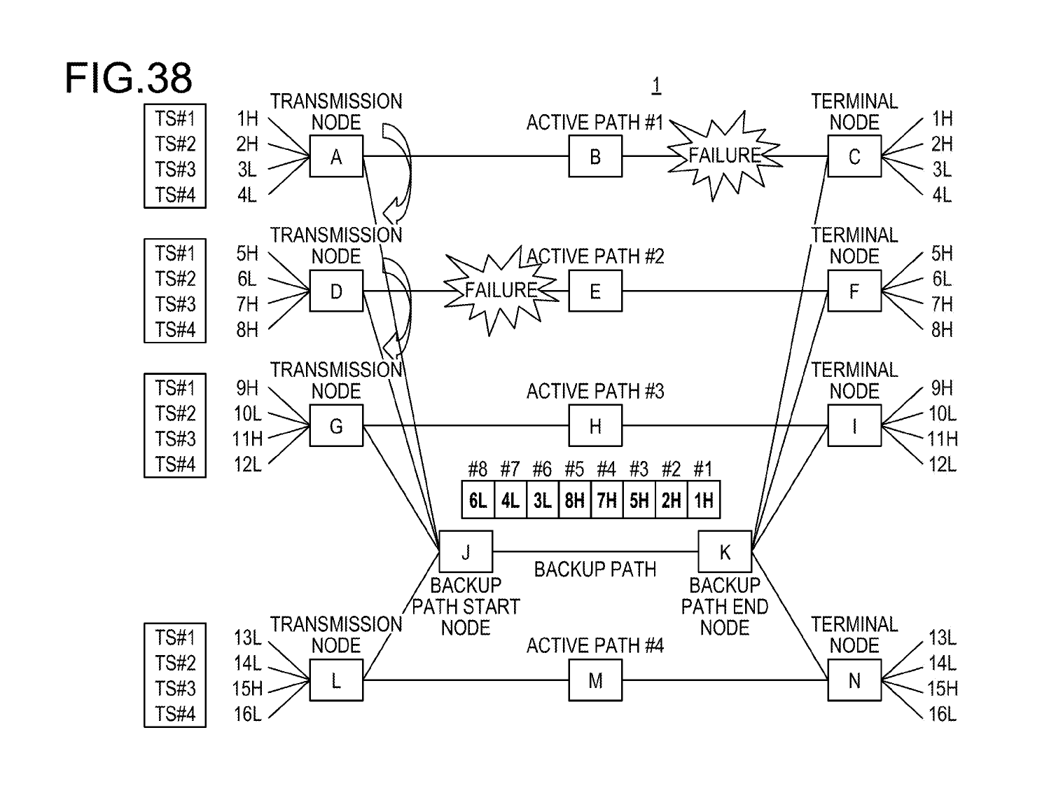

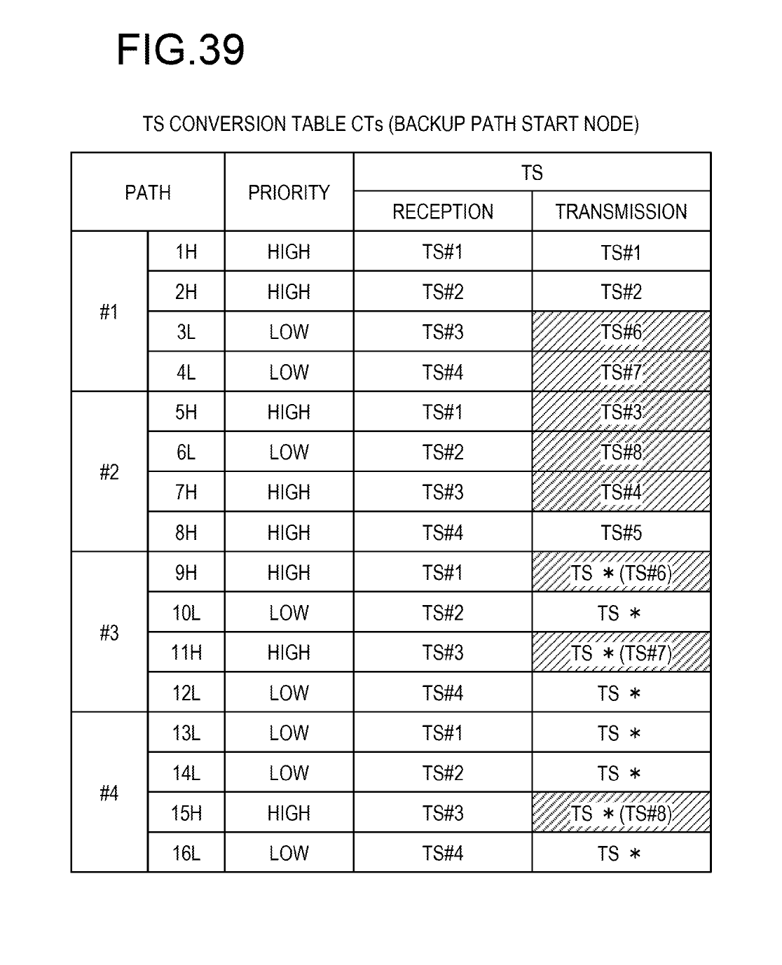

For example, according to the release of the TS allocation, the high priority client signals “5H” and “7H” of the active path #2 may be allocated again to the TSs #3 and #4 of the backup path.

[At the Time of Double Failure: FIGS. 38 and 39]

Then, as exemplified in FIG. 38, it is assumed that the active path #2 is also failed while the failure of the active path #1 is not restored.

According to detection of a failure occurrence in the active path #2 based on the decision bit, the backup path start node J may release the temporary allocation of the TSs #3 and #4 to the low priority client signals “3L” and “4L” of the active path #1.

According to the release, as exemplified in FIG. 39, the high priority client signals “5H” and “7H” of the active path #2 are allocated to the TSs #3 and #4, according to the default setting.

To the low priority client signals “3L” and “4L” of the active path #1 which have been released from TS allocation, any of TSs of the backup path allocated to the high priority client signals of the active paths #3 and #4 which are not failed may be temporarily allocated.

The TSs to be temporarily allocated may be determined in, for example, an ascending order. Also, the TSs may be determined in a descending order.

As a non-limiting example of determination by the ascending order, as exemplified in FIG. 39, the TS #6 allocated to the high priority client signal “9H” of the active path #3 may be temporarily allocated to the low priority client signal “3L” of the active path #1.

Also, the TS #7 allocated to the high priority client signal “11H” of the active path #3 that is not failed may be temporarily allocated to the low priority client signal “4L” of the active path #1.

Also, the TS #8 allocated to the high priority client signal “15H” of the active path #4 that is not failed may be temporarily allocated to the low priority client signal “6L” of the active path #2.

Accordingly, as exemplified in FIG. 38, by the TSs #1 to #5 of the backup path, the high priority client signals “1H,” “2H,” “5H,” “7H,” and “8H” of the active paths #1 and #2 are transmitted. By the TSs #6 and #7 of the backup path, the low priority client signals “3L” and “4L” of the active path #1 are transmitted. By the TS #8 of the backup path, the low priority client signal “6L” of the active path #2 is transmitted.

Accordingly, all the eight client signals “1H,” “2H,” “3L,” “4L,” “5H,” “6L,” “7H,” and “8H” of the active paths #1 and #2 may be rescued by the backup path.

As described above, based on a failure occurrence situation of an active path #x, and a usage situation of TSs of the backup path, the backup path start node J may determine TSs to be allocated to low priority client signals, thereby improving the rescue rate of client signals of the failed active path #x.

[Fourth Aspect of TS Conversion Rule]

In the first to third aspects of the TS conversion rule as described above, according to failure occurrence information of an active path #x, low priority client signals may be allocated to TSs of a backup path.

Also, in the fourth aspect, as in the second embodiment, in the TS conversion table CTs, high priority client signals may be statically allocated to the TSs of the backup path regardless of a failure occurrence situation. That is, it may be set that the high priority client signals are always transmitted through the backup path.

Also, in the fourth aspect, as in the second embodiment, since TS reallocation becomes unnecessary, a time for a processing of switching from the failed active path #x to the backup path may be shortened.

Meanwhile, since it is set that the high priority client signals are always transmitted through the backup path, even in a situation where only one active path #x is failed, low priority client signals are not rescued.

As described above, as methods of rescuing client signals using a TS conversion table CTs, several aspects or methods may be considered. Any of methods may be properly determined and adopted by a network manager.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A communication system comprising:
a plurality of active paths on which a plurality of signals set with priorities are transmitted by a plurality of time-division slots;
a backup path shared by the plurality of active paths; and
a controller configured to control, based on the priorities, allocation of any of the plurality of signals which are allocated to any of the plurality of time-division slots and transmitted on any of the plurality of active paths, to a plurality of time-division slots on the backup path.

2. The communication system according to claim 1, wherein the controller, according to detection of failure occurrence on any of the plurality of active paths, allocates preferentially high priority signals, among the plurality of signals allocated to the plurality of time-division slots on the failed active path, to the plurality of time-division slots on the backup path.

3. The communication system according to claim 2, wherein the controller sets alarm information in a time-division slot, to which a signal of the failed active path is not allocated on the backup path.

4. The communication system according to claim 1, wherein the controller allocates high priority signals transmitted through the plurality of active paths to the plurality of time-division slots on the backup path.

5. The communication system according to claim 1,
wherein the controller includes:
a backup path start node located at a start point of the backup path; and
a backup path end node located at an end point of the backup path,
wherein the backup path start node includes:
a first storage unit configured to store a first slot allocation table in which information of the plurality of time-division slots on the backup path allocated to the plurality of signals is set for each of the priorities of the plurality of signals allocated to the plurality of time-division slots on the plurality of active paths; and
a first slot controller configured to control an allocation of the plurality of time-division slots on the backup path according to the information set in the first slot allocation table, and
wherein the backup path end node includes:
a second storage unit configured to store a second slot allocation table in which information of the plurality of original time-division slots on the plurality of active paths is set for each of the priorities of the plurality of signals allocated to the plurality of time-division slots of the backup path by the first slot allocation table, the plurality of original time-division slots on the plurality of active paths corresponding to the plurality of time-division slots by which the plurality of signals set with the priorities are transmitted on the plurality of active paths; and
a second slot controller configured to control an allocation of the plurality of signals allocated to the plurality of time-division slots on the backup path, to the plurality of original time-division slots on the plurality of active paths, according to the information set in the second slot allocation table.

6. The communication system according to claim 5, wherein in the first slot allocation table, information of the plurality of time-division slots on the backup path is dynamically set, according to detection of failure occurrence on any of the plurality of active paths, so that high priority signals are preferentially allocated to the plurality of time-division slots on the backup path.

7. The communication system according to claim 5, wherein information of the plurality of time-division slots on the backup path for high priority signals is statically set in the first slot allocation table, and information of the plurality of time-division slots on the backup path for low priority signals is dynamically set in the first slot allocation table according to a failure occurrence situation of the plurality of active paths and an allocation situation of the plurality of time-division slots on the backup path.

8. The communication system according to claim 6, wherein, according to the information of the plurality of time-division slots on the backup path being dynamically set, the information set in the first slot allocation table is notified to the backup path end node, and the second slot allocation table is updated based on the notified information.

9. A node located on a backup path shared by a plurality of active paths, the node comprising:
a receiving unit configured to receive a plurality of signals set with priorities by a plurality of time-division slots;
a transmission unit configured to transmit the plurality of signals received by the plurality of time-division slots; and
a controller configured to control, based on the priorities, an allocation of the plurality of signals received by the plurality of time-division slots from the active path or the backup path, to the plurality of time-division slots of the backup path or the plurality of active paths.

10. The node according to claim 9,
wherein the node is located at a start point of the backup path,
wherein the receiving unit receives the plurality of signals set with the priorities by the plurality of time-division slots from any of the plurality of active paths,
wherein the transmission unit transmits the plurality of signals received by the plurality of time-division slots, by any of a plurality of time-division slots in the backup path, and
wherein the controller controls, based on the priorities, the allocation of the plurality of signals received by the plurality of time-division slots from the active path, to the plurality of time-division slots of the backup path.

11. The node located according to claim 9,
wherein the node is located at an end point of the backup path,
wherein the receiving unit receives the plurality of signals set with priorities by the plurality of time-division slots from the backup path,
wherein the transmission unit transmits the plurality of signals received by the plurality of time-division slots from the backup path, to a reception node on any of the plurality of active paths, by any of a plurality of time-division slots in the active path, and
wherein the controller controls, based on the priorities, the allocation of the plurality of signals received by the plurality of time-division slots from the backup path, to the plurality of time-division slots of the plurality of active paths.

12. A signal path control method in a communication system in which a plurality of active paths and a backup path shared by the plurality of active paths are set, the signal path control method comprising:
transmitting a plurality of signals set with priorities by a plurality of time-division slots on the plurality of active paths; and
controlling, based on the priorities, an allocation of the plurality of signals allocated to any of the plurality of time-division slots in any of the plurality of active paths, to a plurality of time-division slots on the backup path.
